(19) United States
(12) Patent Application Publication
(10) Pub. No.: US 2018/0240138 A1
(43) Pub. Date: Aug. 23, 2018

(54) GENERATING AND PRESENTING STATISTICAL RESULTS FOR ELECTRONIC SURVEY DATA

(71) Applicant: QUALTRICS, LLC, Provo, UT (US)

(72) Inventors: John Le, Seattle, WA (US); Greg Laughlin, Seattle, WA (US)

(21) Appl. No.: 15/472,893

(22) Filed: Mar. 29, 2017

Related U.S. Application Data
(60) Provisional application No. 62/462,191, filed on Feb. 22, 2017.

(51) Int. Cl. G06Q 30/02

(52) U.S. Cl. CPC G06Q 30/0203

(57) ABSTRACT

Embodiments of the present disclosure relate to collecting survey information, performing a statistical test on the collected survey information, and providing a presentation of a statistical result via a virtual workspace. In particular, systems and methods disclosed herein facilitate administering an electronic survey and collecting survey information based on responses to electronic survey questions. In addition, systems and methods disclosed herein facilitate preparing the survey information for analysis using one or more identified statistical tests. Moreover, systems and methods disclosed herein facilitate performing the statistical test(s) to determine a statistical result and providing a presentation of the statistical result including a plain text description of the statistical result within a virtual workspace.

### CROSS-REFERENCE TO RELATED APPLICATION(S)

This application claims priority to U.S. Provisional Patent Application No. 62/462,191 filed Feb. 22, 2017, the disclosure of which is incorporated in its entirety by reference herein.

### BACKGROUND

Companies and other organizations often rely on opinions and feedback from people. A common method of acquiring feedback is through electronic surveys, including ratings and reviews (e.g., ratings and reviews for products, services, businesses, schools, etc.) In addition, organizations often use electronic surveys to collect information about people having different characteristics or experiences. Indeed, an organization may use electronic surveys to collect feedback from a wide range of people to determine behavior, opinions, and/or preferences associated with various demographics of people.

In addition to collecting electronic survey information, organizations use the collected electronic survey information in an attempt to understand groups of people. For example, companies analyze electronic survey information to determine habits (e.g., purchasing habits) or overall trends among respondents of electronic surveys. In addition, companies often attempt to identify trends or habits among users of specific demographics to better communicate with past and potential future customers. Conventional systems for collecting and analyzing electronic survey information, however, suffers from a number of drawbacks.

For example, with the increased use of electronic surveys to collect survey information, conventional systems often produce massive quantities of disorganized electronic survey information. In particular, collected electronic survey information often includes large quantities of data that most users find difficult or impossible to understand. Nevertheless, while software programs exist that enable users to store and organize massive amounts of data using tables and spreadsheets, many users lack programming experience that enables effective organizing and manipulating survey information using these programs.

In addition, even for users who have programming experience with various data-organizing software, the vast majority of users experience difficulty understanding and drawing conclusions from electronic survey information. In particular, collected electronic survey information often includes raw data that provides very little guidance to most users attempting to analyze and draw conclusions from the survey information. Indeed, many users have no idea which statistical tests to perform or how to interpret the results of those tests. As a result, many companies spend large sums of money hiring statistical experts to analyze and draw conclusions from collected survey information.

Furthermore, due to the large quantity of data and different methods and devices for collecting the electronic survey information, collected electronic survey information often includes incompatible data that prevents various software programs from implementing one or more statistical tests. For example, many survey respondents use different computing devices when taking electronic surveys. In addition, many survey respondents provide incomplete information or survey responses having different formats. In many cases, informalities and/or errors introduced when administering electronic surveys prevent software programs from effectively analyzing the electronic survey information, thus causing users to draw incorrect or incomplete conclusions from the electronic survey information.

Moreover, conventional systems for collecting and analyzing electronic survey information often fail to provide a user-friendly interface that enables users having limited programming experience to analyze information and create presentations to present the results of the electronic surveys. Rather, most conventional systems require extensive programming experience to effectively navigate and perform statistical tests on the collected data. Furthermore, even where users have programming experience, only those users with extensive analytic experience can draw correct and meaningful conclusions from the collected survey information. As a result, conventional systems fail to enable most users to effectively analyze data and convey the results of the analyzed data to others.

Accordingly, these and other disadvantages exist with respect to conventional systems and methods for collecting and analyzing electronic survey information.

### SUMMARY

Embodiments presented in this disclosure provide benefits and/or solve one or more of the foregoing or other problems in the art with systems and methods for collecting and analyzing electronic survey information, and presenting meaningful and useful analysis results. In particular, systems and methods disclosed herein facilitate administration of an electronic survey to a plurality of respondents to collect electronic survey information from respondents of the electronic survey. In addition, the systems and methods disclosed herein involve preparing the collected electronic survey information to be analyzed and performing one or more statistical tests on the collected electronic survey information. Further, the systems and methods disclosed herein facilitate generating a plain text description of a statistical result and providing a presentation of the statistical result via a graphical user interface of a client device.

Additional features and advantages of the embodiments will be set forth in the description that follows, and in part will be obvious from the description, or may be learned by the practice of such exemplary embodiments. The features and advantages of such embodiments may be realized and obtained by means of the instruments and combinations particularly pointed out in the appended claims. These, and other features, will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments of the disclosure and are not therefore considered to be limiting of its scope, the disclosure will be described and explained with additional specificity and detail through the use of the accompanying drawings, in which:

FIG. 1 illustrates a block diagram of a survey analysis environment in accordance with one or more embodiments;

FIGS. 2A-2B illustrate example client devices providing a display of electronic survey questions in accordance with one or more embodiments;

FIG. 3 illustrates an example table showing collected survey information including responses to electronic surveys in accordance with one or more embodiments;

FIG. 4A illustrates an example graphical user interface including an empty workspace in accordance with one or more embodiments;

FIG. 4B illustrates an example graphical user interface including dropdown menus for a user account toolbar in accordance with one or more embodiments;

FIG. 5 illustrates an example graphical user interface including a presentation menu including selectable options to facilitate preparing and/or analyzing survey information in accordance with one or more embodiments;

FIG. 6A illustrates an example workspace including a generated description card in accordance with one or more embodiments;

FIG. 6B illustrates an example description card including a filter interface in accordance with one or more embodiments;

FIG. 6C illustrates an example description card including a note field in accordance with one or more embodiments;

FIG. 6D illustrates an example workspace including multiple cards therein in accordance with one or more embodiments;

FIG. 6E illustrates an example description card including a reorder field in accordance with one or more embodiments;

FIG. 7A illustrates a new variable interface including a formula menu in accordance with one or more embodiments;

FIG. 7B illustrates a workspace including a new variable tab for a new dataset in accordance with one or more embodiments;

FIG. 7C illustrates a new variable interface including a time functions menu in accordance with one or more embodiments;

FIG. 7D illustrates a new variable interface including a bucket variable menu in accordance with one or more embodiments;

FIG. 7E illustrates a variable grouping interface in accordance with one or more embodiments;

FIG. 7F illustrates a modified grouping of variables in accordance with the variable grouping interface of FIG. 7E;

FIG. 7G illustrates a new variable interface including a variable by filters menu in accordance with one or more embodiments;

FIG. 7H illustrates a description card for a new variable based on one or more filters in accordance with one or more embodiments;

FIG. 7I illustrates an example variable filter interface in accordance with one or more embodiments;

FIG. 7J illustrates a variable settings interface including options to modify multiple datasets from the survey information in accordance with one or more embodiments;

FIG. 7K illustrates a modified chart of survey information based on received user input and/or learned preferences in accordance with one or more embodiments;

FIG. 8A illustrates an example relationship card within a workspace in accordance with one or more embodiments;

FIG. 8B illustrates an expanded view of the example relationship card shown in FIG. 8A in accordance with one or more embodiments;

FIG. 8C illustrates another example relationship card within a workspace in accordance with one or more embodiments;

FIG. 8D illustrates an expanded view of the example relationship card shown in FIG. 8C in accordance with one or more embodiments;

FIG. 8E illustrates yet another example relationship card within a workspace in accordance with one or more embodiments;

FIG. 8F illustrates an expanded view of the example relationship card shown in FIG. 8E in accordance with one or more embodiments;

FIG. 8G illustrates another example relationship card within a workspace in accordance with one or more embodiments;

FIG. 8H illustrates multiple relationship graphs ordered within a workspace in accordance with one or more embodiments;

FIG. 9A illustrates an example regression card including a first plain text description of a statistical result in accordance with one or more embodiments;

FIG. 9B illustrates the example regression card of FIG. 9A including a second plain text description of a statistical result in accordance with one or more embodiments;

FIG. 9C illustrates an expanded view of the example regression card of FIG. 9A in accordance with one or more embodiments;

FIG. 9D illustrates the example regression card of FIG. 9A including a modified statistical result in accordance with one or more embodiments;

FIG. 10A illustrates an example graphical user interface including a workspace in accordance with one or more embodiments;

FIG. 10B illustrates an example regression card including a presentation of a first statistical result in accordance with one or more embodiments;

FIG. 10C illustrates the regression card of FIG. 10B including a presentation of a second statistical result in accordance with one or more embodiments;

FIG. 10D illustrates the regression card of FIG. 10B including a presentation of a third statistical result in accordance with one or more embodiments;

FIG. 11A illustrates an example pivot table card within a workspace in accordance with one or more embodiments;

FIG. 11B illustrates another example pivot table card within a workspace in accordance with one or more embodiments;

FIG. 12 illustrates a flowchart of a series of acts in a method for providing a presentation of a statistical result in accordance with one or more embodiments;

FIG. 13 illustrates a block diagram of a computing device in accordance with one or more embodiments; and

FIG. 14 illustrates a networking environment of a survey analysis system in accordance with one or more embodiments.

### DETAILED DESCRIPTION

One or more embodiments described herein provide a survey analysis system that collects survey information, analyzes the survey information, and provides a presentation of results of one or more statistical analyses performed on the collected survey information. In particular, one or more embodiments described herein provide a survey analysis system that administers an electronic survey and collects survey information from responses to electronic survey questions. Further, one or more embodiments described herein provide a survey analysis system that prepares the survey information for analysis and performs one or more statistical tests on the prepared survey information to determine a statistical result. Moreover, one or more embodiments describe herein provide a survey analysis system that provides a presentation of the statistical result(s) including a plain text description of the statistical result(s) generated by the system and based on the survey information.

For example, in one or more embodiments, the survey analysis system facilitates administration of an electronic survey. In particular, in one or more embodiments, the survey analysis system provides an electronic survey including electronic survey questions to a plurality of respondents. The survey analysis system collects survey information, including for example, answers to the electronic survey questions and information about the respondents providing answers to the electronic survey questions. For example, in one or more embodiments, the survey analysis system collects survey information including demographic information (e.g., age, gender, race, income, marital status, employments status, nationality, etc.) of respondents in addition to specific answers to the electronic survey questions. In one or more embodiments, the demographic information and other associated survey information is provided via responses to electronic survey questions.

Upon receiving the survey information, the survey analysis system stores or otherwise maintains the survey information. For example, in one or more embodiments, the survey analysis system stores the collected survey information in a table of rows and columns grouped by respondents and corresponding answers to the electronic survey questions. In addition, the survey analysis system can group different types of demographic information or other information associated with the respondents within a storage space. In one or more embodiments, the survey analysis system provides a display of the stored data via a graphical user interface of an administrator client device.

In addition to collecting survey information, in one or more embodiments, the survey analysis system prepares the collected survey information for analysis. For example, in one or more embodiments, the survey analysis system adds metadata to the survey information that enables the survey analysis system to identify a relevant statistical test and perform the statistical test with respect to the survey information. In one or more embodiments, the survey analysis system prepares the survey information for analysis by identifying and/or designating portions of the collected survey information as a particular type of data. For example, the survey analysis system can tag portions (e.g., categories) of the survey information, add metadata to the survey information, or otherwise designate different portions of the survey information as categorical, numeric, binary, a net promoter score (NPS) or other data type.

As another example, in one or more embodiments, the survey analysis system groups different types and/or portions of the collected survey information in preparation for analysis. For instance, as will be described in further detail below, the survey analysis system can modify different portions of the survey information to have a common data-type and/or remove specific responses to the electronic survey questions that may prevent the survey analysis system from correctly analyzing the survey information. In one or more embodiments, the survey analysis system modifies discrete portions (e.g., datasets, data cells) of the survey information to have a format that enables the survey analysis system to perform one or more statistical tests.

With respect to preparing the survey information for analysis, and as will be described in further detail below, the survey analysis system can prepare the survey information using one of various algorithms based on or independent from received user input. For example, the survey analysis system can automatically (e.g., without receiving user input) extract data from different portions (e.g., respective datasets) of the survey information and/or modify the survey information to have a particular format. In addition, or as an alternative, the survey analysis system provides a presentation of the survey information and enables the administrative user to provide various user inputs to further clean and prepare the survey information for analysis. For example, as will be described in further detail below in connection with the Figures, one or more embodiments of the survey analysis system provides a graphical user interface that enables an administrative user to provide user inputs that cause the survey analysis system to modify, tag, or otherwise prepare the survey information for analysis.

In addition to preparing the survey information for analysis, the survey analysis system can analyze the survey information. In particular, in one or more embodiments, the survey analysis system performs one or more statistical tests on one or multiple discrete portions (e.g., datasets) of the survey information to generate a statistical result (e.g., observation or conclusion) for one or more portions of the survey information. For example, in response to detecting a user selection of one or more categories (e.g., variables) of the survey information, the survey analysis system can select one of a number of statistical tests to run on the selected survey information. In addition, the survey analysis system can compare the selected information by running one or more of the selected statistical tests to generate a statistical result for the selected test(s).

Based on performing a statistical test and generating a statistical result, the survey analysis system can further generate a presentation that includes the statistical result. For example, the survey analysis system can generate a visualization (e.g., a graph, chart, table) of the statistical test(s) that illustrates a comparison between one or more selected portions of the survey information. As will be described in further detail below, the survey analysis system can provide the visualization of the statistical test(s) within a workspace (e.g., a virtual workspace) provided via a graphical user interface of a client device. In one or more embodiments, the survey analysis system provides multiple presentations of statistical results including visualizations of the results within the workspace.

As part of presenting a statistical result, the survey analysis system generates a plain text description of the statistical result. For example, as will be described in further detail below, the survey analysis system can generate a plain text description for presentation to an administrative user by filling in a template with words that describe the statistical results. In one or more embodiments, the survey analysis system selects one or more templates based on identified statistical tests and/or data-types of selected survey information used to perform the statistical test(s). Further, as will be described in further detail below, the survey analysis system provides the plain text description in conjunction with the visualization of the statistical result.

Thus, one or more embodiments facilitate organization, analysis, and understanding of massive amounts of raw data. In particular, the survey analysis system facilitates storing, grouping, and/or modifying survey information while enabling an administrative user to view the survey information. In addition, as will be described in further detail below, the survey analysis system stores and organizes the survey information without requiring extensive programming experience by one or more administrative users.

In addition, the survey analysis system overcomes flaws and/or non-uniformities that are common in collected survey information by preparing the survey information for analysis in various ways. For example, the survey analysis system can tag, group, add metadata, or otherwise designate discrete portions of the survey information as a particular data-type. In addition, in one or more embodiments, the survey analysis system modifies the survey information to correct flaws, typos, or otherwise correct features of the survey information that may prevent the survey analysis system from performing one or more statistical tests or otherwise obtaining a reliable statistical result. In this way, the survey analysis system prepares (e.g., cleans) the survey information to enable performing one or more statistical tests on the survey information to obtain reliable statistical results.

Further, the survey analysis system identifies and performs relevant tests on the survey information based on identified types of survey information. For example, in one or more embodiments, the survey analysis system identifies one or more statistical tests to perform based on one or more selected groupings of survey information. In this way, the survey analysis system provides guidance to those users lacking experience in performing statistical tests to identify and perform on different variables of the survey information that will provide relevant and useful insight based on the survey information.

Moreover, the survey analysis system provides an easy-to-understand presentation of the statistical result(s). For example, in one or more embodiments, the survey analysis system generates a visualization of the statistical results and provides the visualization within a workspace. In addition, in one or more embodiments, the survey analysis system generates a plain text description of the statistical result to provide within the workspace in conjunction with the visualization of the statistical result. As will be described in further detail below, the survey analysis system can perform one or multiple statistical tests to obtain multiple statistical results and enable an administrative user to scroll through presentations of multiple statistical results and conveniently review multiple comparisons of the survey information.

In addition, in one or more embodiments, the survey analysis system provides features and functionality related to preparing survey information for analysis. For example, in one or more embodiments, the survey analysis system groups, modifies, or selectively removes data from various datasets in preparation for performing one or more statistical tests on the survey information. By preparing the survey information in accordance with one or more embodiments described herein, the survey analysis system enables a computing device (e.g., server device(s)) to more efficiently analyze survey information. In particular, by removing unnecessary data and/or re-ordering or grouping data in preparation for performing one or more statistical tests, the survey analysis system avoids performing unnecessary calculations, thus reducing operations and facilitating selective analysis of survey information without expending unnecessary resources of one or more computing systems (e.g., server device(s), client device(s)).

In addition, in one or more embodiments, the survey analysis system automates selection of one or more statistical tests to perform on survey information. For example, as will be described in further detail below, in one or more embodiments, the survey analysis system automatically (or in response to receiving user input) categorizes survey information in accordance with a data-type of discrete datasets of the survey information. In one or more embodiments, the survey analysis system considers specific data-types of selected datasets and determines one or more statistical tests to perform based on the data-types of selected datasets and one or more measurements with respect to selected datasets. In this way, the survey analysis system identifies one or more statistical tests to perform from a limited number of statistical tests, thus avoiding unnecessarily performing various tests that yield no useful results. In addition, by automating selection of one or more statistical tests based on data-types of selected datasets (in addition to enabling an administrative user to specifically designate a particular data-type), the survey analysis system avoids performing computationally expensive calculations to determine which statistical test(s) to perform with respect to subsets of the survey information. In this way, the survey analysis system additionally avoids performing unnecessary calculations, thus reducing operations and expending unnecessary resources of one or more computing systems.

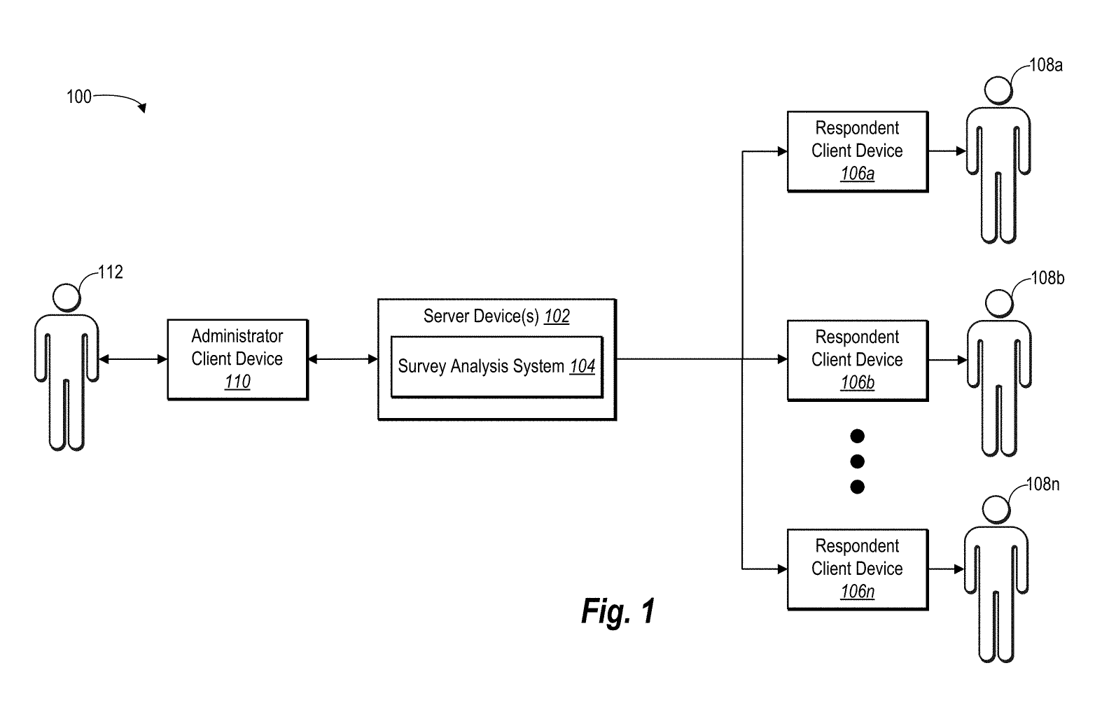

Additional features and characteristics of one or more embodiments of the survey analysis system are described below with respect to the Figures. For example, FIG. 1 illustrates an example embodiment of a survey analysis environment 100. In general, and as illustrated in FIG. 1, the survey analysis environment 100 includes one or more server device(s) 102 including a survey analysis system 104 thereon. As further shown, the survey analysis environment 100 includes a plurality of respondent client devices 106a-n associated with a number of respondents 108a-n. As shown in FIG. 1, the survey analysis environment 100 can include any number of respondent client devices 106a-n associated with respective respondents 108a-n. As further shown, the survey analysis environment 100 includes an administrator client device 110 and associated administrative user 112 (or simply “user 112”).

As will be described in greater detail below, the server device 102 can perform or provide the various functions, features, processes, methods, and systems as describe herein. Additionally, or alternatively, the respondent client devices 106a-n and administrator client device 110 can perform or provide one or more of the functions, features, processes, methods, and systems described herein. In one or more embodiments, the server device 102, respondent client devices 106a-n, and administrator client device 110 coordinate to perform or provide the various features, processes, methods, and systems, as described in more detail below.

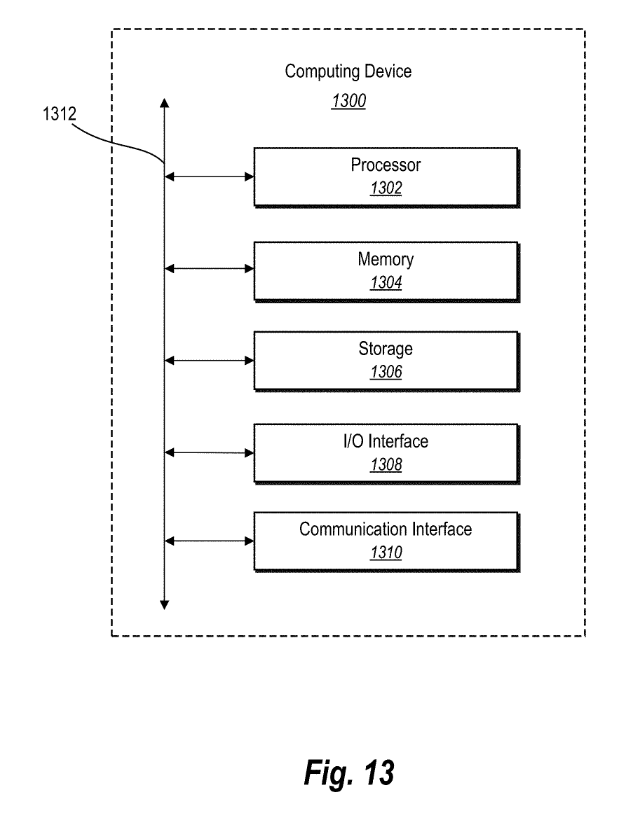

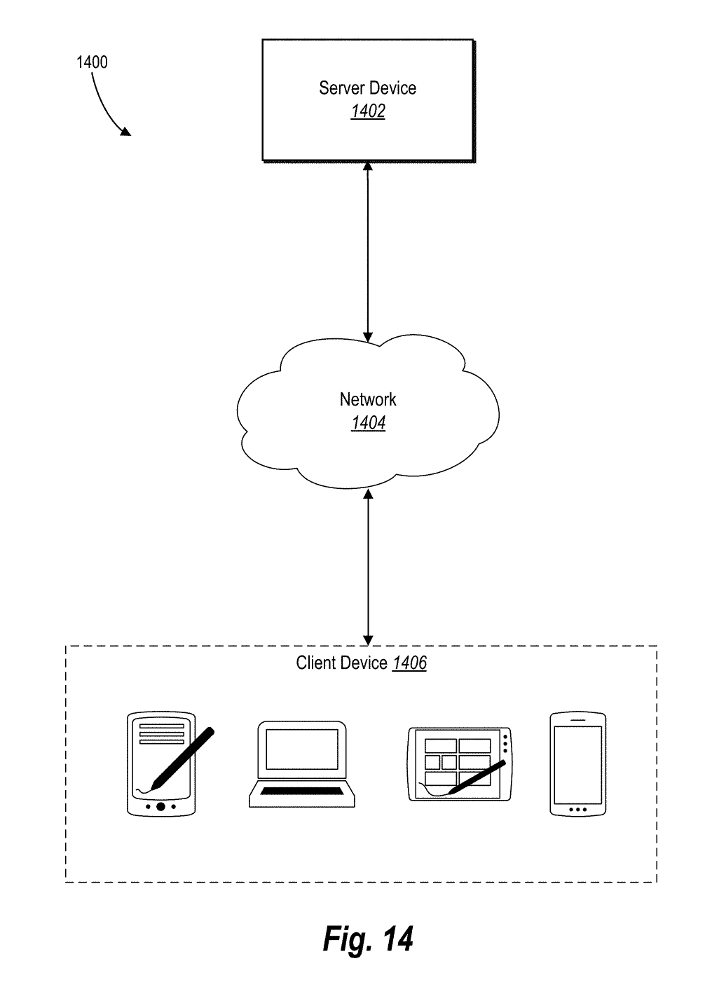

Generally, the server device 102 can include one of various types of computing devices as further explained below in connection with FIG. 13. Additionally, one or more of the respondent client devices 106a-n and administrator client device 110 can be a mobile device (e.g., a smart phone), tablet, laptop computer, desktop computer, or any other type of client device or general computing device described in further detail below with reference to FIG. 13. Moreover, the server device(s) 102, respondent client devices 106a-n, and administrator client device 110 may communicate using any communication platforms and technologies suitable for transporting data and/or communication signals, including any known communication technologies, devices, media, and protocols supportive of data communications, examples of which are described with reference to FIG. 14. In addition, in one or more embodiments, the server device 102 communicates with respondent client devices 106a-n over a first communication network while communicating with the administrator client device 110 over a second (e.g., separate) communication network of a similar or different type.

As mentioned above, the survey analysis system 104 administers an electronic survey to a plurality of respondents 108a-n. In particular, in one or more embodiments, the survey analysis system 104 administers an electronic survey by causing the server device 102 to provide one or more electronic survey questions to respondent client devices 106a-n corresponding to the plurality of respondents 108a-n. In one or more embodiments, the survey analysis system 104 causes the server device 102 to transmit electronic survey questions to the respondent client devices 106a-n to be stored and provided to the respondents 108a-n. Alternatively, in one or more embodiments, the survey analysis system 104 causes the server device 102 to provide the electronic survey questions as web content (e.g., via web browsers on the respondent client devices 106a-n).

As used herein, an “electronic survey” or “survey” refers to one or more electronic communications or an electronic document used to collect quantitative electronic information or electronic data. For example, an electronic survey can include a poll, questionnaire, census, or other type of sampling. In one or more embodiments, the term electronic survey refers to a method of collecting information from respondents including personal information (e.g., demographic information) about the respondents in addition to opinions, preferences, or other information associated with the respondents. As used herein a “respondent” refers to a person who participates in, and responds to, an electronic survey. Alternatively, a “customer,” “client,” or “user” of a client device may refer to a respondent.

In addition, as respondents 108a-n answer electronic survey questions (or upon completion of an electronic survey), the respondent client devices 106a-n provide survey information including responses to the electronic survey questions to the server device 102. In one or more embodiments, the respondent client devices 106a-n further provide survey information including information about the respondents 108a-n (e.g., demographic information) Upon receiving the responses, the survey analysis system 104 stores or otherwise maintains the survey information on the server device 102. For example, in one or more embodiments, the survey analysis system 104 stores the electronic survey information on a storage space (e.g., server database) of the server device 102.

As used herein “survey information” refers to data obtained in association with administering an electronic survey. For example, in one or more embodiments, survey information includes data contained within responses to electronic survey questions. In addition, survey information can include data associated with respondents 108a-n (e.g., demographic information) who provide the responses to the electronic survey questions. In one or more embodiments, respondents 108a-n provide personal information within responses to the electronic survey questions. In addition, in one or more embodiments, the survey information includes both the raw data provided by the respondents 108a-n including one or more modifications/additions to the survey information made by the survey analysis system 104 (e.g., in conjunction with preparing the survey information and/or performing statistical tests).

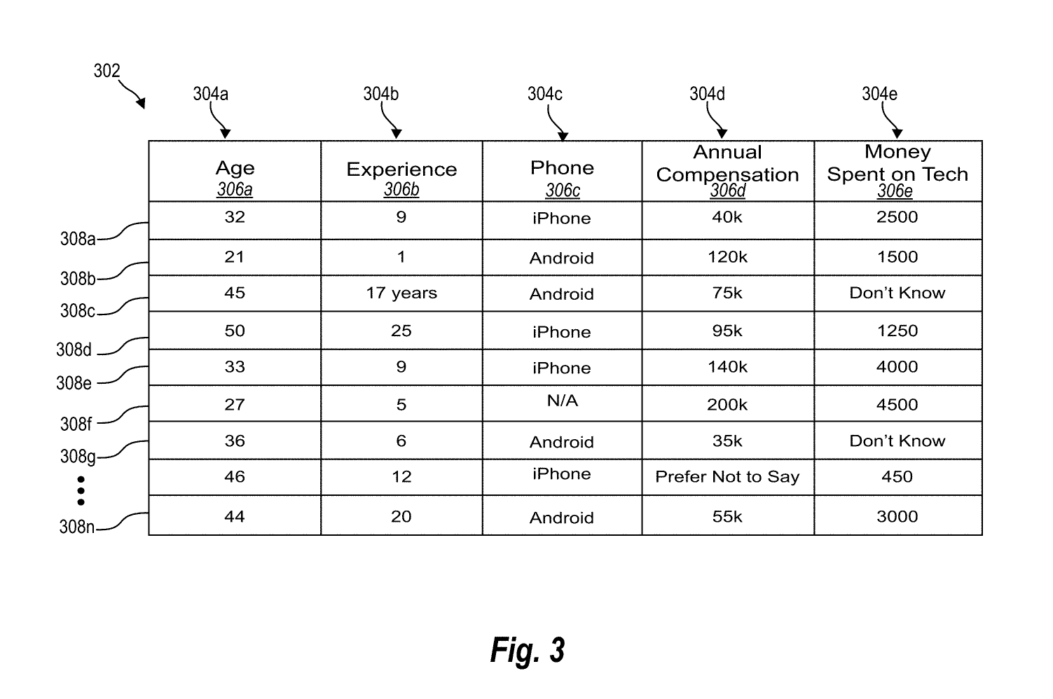

In addition, as will be described in further detail below, the survey information includes respective portions or subsets of the survey information. For example, as will be described further in connection with FIG. 3, survey information may include sets of data (e.g., datasets) grouped by variables or categories stored or otherwise maintained in columns and/or rows, thus enabling the survey analysis system 104 and/or administrative client device 110 to access and/or modify discrete portions (e.g., respective datasets) of the survey information. For example, a dataset or variable associated with a dataset may refer to all responses to a particular survey question.

In one or more embodiments, the survey analysis system 104 administers the electronic survey to the respondents 108a-n on behalf of the administrative user 112. For example, in one or more embodiments, the administrative user 112 composes the electronic survey questions and provides instructions to the survey analysis system 104 to administer the survey to the respondents 108a-n. Alternatively, in one or more embodiments, the survey analysis system 104 administers the electronic survey including survey questions provided by a marketer or other entity (e.g., associated with the administrative user 112) and subsequently provides access to the received survey information to the administrative user 112 via the administrative client device 110.

As used herein, an “administrative user” or “administrator” refers to one or more users of an administrator client device and having access to the survey information provided by respondents of the electronic survey. For example, in one or more embodiments, an administrative user refers to a user or other entity that provides (directly or indirectly) the electronic survey to the respondents. In addition, the administrative user may refer to a user of the administrative client device that interacts with one or more graphical user interfaces provided by the survey analysis system 104 independent of whether the administrative user conducted or otherwise administered the electronic survey. For example, as will be described in further detail below, the administrative user may refer to a user that interacts with a graphical user interface to cause the survey analysis system 104 to prepare survey information, generate descriptions of the survey information, perform statistical tests on the survey information, and present statistical results of the various tests performed on the survey information by the survey analysis system 104.

In addition, in one or more embodiments, the survey analysis system 104 causes the server device 102 to provide some or all of the survey information to the administrator client device 110. For example, in one or more embodiments, the survey analysis system 104 provides access to the survey information including any responses and associated demographic information of the respondents 108a-n. In one or more embodiments, the survey analysis system 104 provides (e.g., transmits) the survey information to be stored on the administrative client device 110. Alternatively, in one or more embodiments, the survey analysis system 104 simply provides access to a storage space containing the survey information on the server device 102.

As mentioned above, and as will be described in further detail below, one or more embodiments of the survey analysis system 104 prepares the survey information for analysis. For example, in one or more embodiments, the survey analysis system 104 prepares the survey information for analysis by tagging, adding metadata, or otherwise designating certain portions of the survey information as a particular type of data. In addition, in one or more embodiments, the survey analysis system 104 prepares the survey information for analysis by cleaning or otherwise modifying portions of the survey information to have a format that enables the survey analysis system 104 to run certain statistical tests on the survey information. In one or more embodiments, the survey analysis system 104 prepares the survey information automatically (e.g., without receiving user input from the administrative user 112). Alternatively, in one or more embodiments, the survey analysis system 104 prepares the survey information based on user input received from the administrative user 112.

For example, as will be described in further detail below, in one or more embodiments, the survey analysis system 104 causes the server device 102 to provide a graphical user interface to the administrator client device 110 including features that enable the administrative user 112 to interact with the graphical user interface. In particular, the administrative user 112 can interact with the graphical user interface to select variables or datasets (e.g., subsets of the survey information) and instruct the survey analysis system 104 to tag, add metadata, and/or modify selected datasets to prepare the survey information for various types of tests.

In addition, as mentioned above, one or more embodiments of the survey analysis system 104 causes the server device 102 to perform a statistical test of the administrative client device 110 to determine a statistical result. In particular, the survey analysis system 104 identifies one or more tests to perform on the survey information and provides the results of the tests (e.g., statistical result(s)) to the administrative client device 110. For example, in one or more embodiments, the survey analysis system 104 causes the server device 102 to provide a visualization of the statistical result to the administrative client device 110. In addition, in one or more embodiments, the survey analysis system 104 causes the server device 102 to provide a plain text description of the statistical result to the administrator client device 110.

As used herein, a “statistical test” or “statistical analysis” refer interchangeably to an operation of analyzing one or more datasets (e.g., discrete portions of survey information) to draw a conclusion about the dataset. For example, as will be described in further detail below, the survey analysis system 104 can analyze a dataset of the survey information to calculate or otherwise generate a statistical result (e.g., a conclusion) about the dataset of the survey information. In one or more embodiments, a statistical test refers to a comparison between two or more variables (or datasets representative of respective variables) to generate a quantifiable result. In particular, in one or more embodiments, a statistical test refers to one or a combination of a variety of statistical tests including, for example, an analysis of variance (ANOVA) test, Chi-squared test, T-test, correlation test, factor analysis test, Mann-Whitney U test, mean squared test, mean square weighted deviation test, Pearson product-moment correlation coefficient test, regression analysis, comparing means, mass appraisal, curve fitting, clustering, distribution fitting, multivariate analysis, reliability, time series, or other type of statistical test.

In addition, a “statistical result” refers to one or multiple conclusions drawn from results of performing one or multiple statistical tests. For example, a statistical result can refer to a general conclusion (e.g., a plain text description or summary) that describes the result(s) of a statistical test. In addition, a statistical result can refer to calculated values associated with the conclusion(s) drawn from performing one or more statistical tests. Further, in one or more embodiments, a statistical result includes a visualization of results (e.g., a graph, plot, table) of performing one or more statistical tests on survey information.

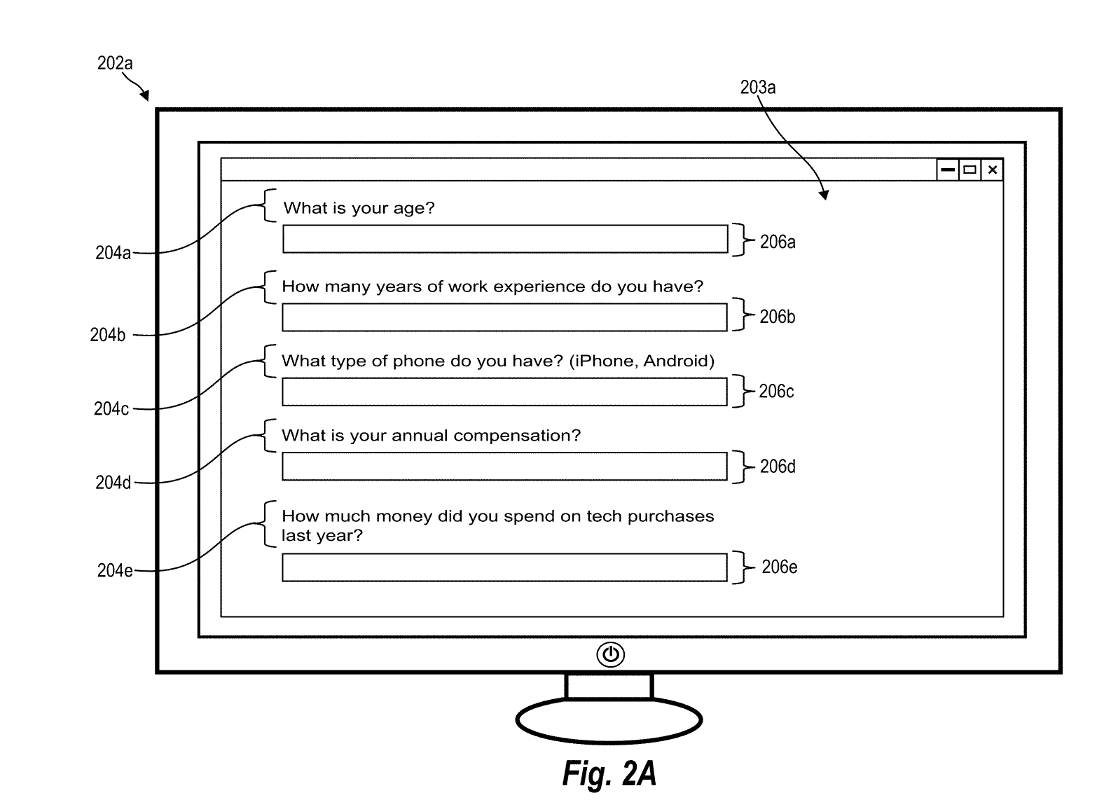

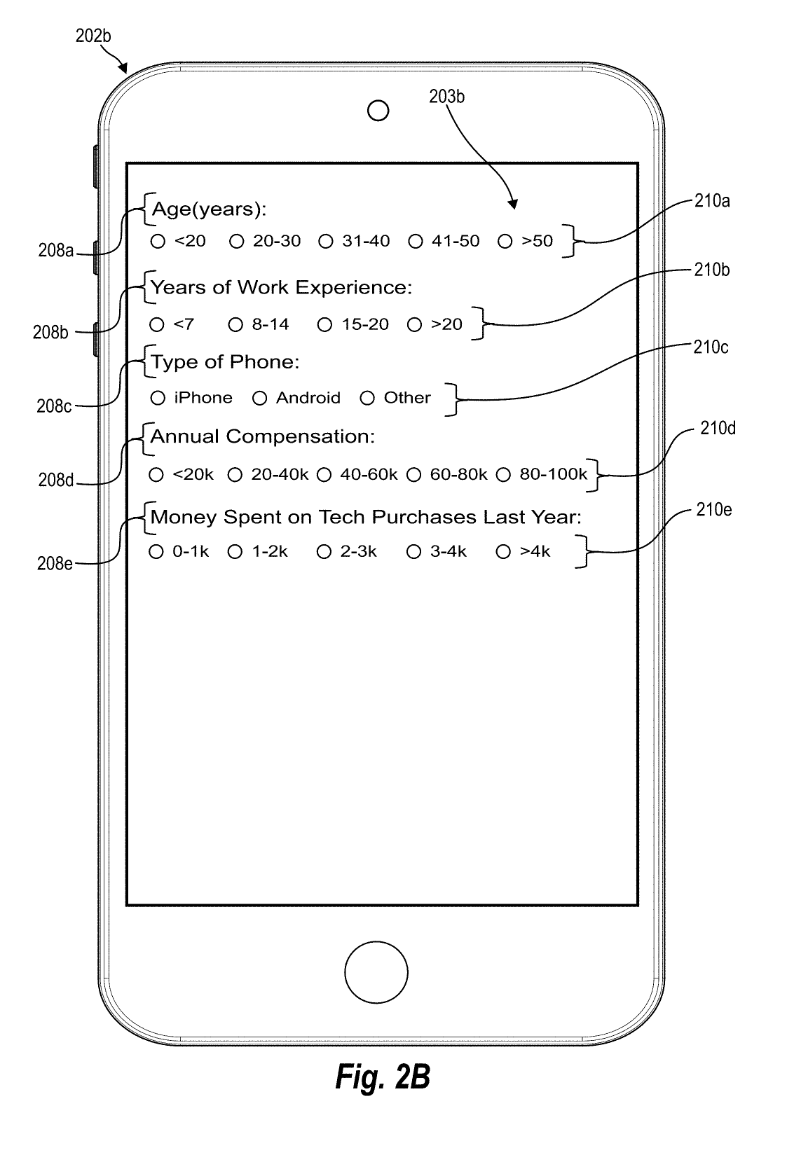

As mentioned above, in one or more embodiments, the survey analysis system 104 collects survey information associated with a plurality of respondents. For example, FIGS. 2A-2B illustrate example client devices 202a-b (e.g., respondent client devices) including graphical user interfaces 203a-b for displaying electronic survey questions 204a-e, 208a-e to users (e.g., survey respondents) of the client devices 202a-b. As shown in FIGS. 2A-2B, the client devices 202a-b include different types of computing devices. For example, FIG. 2A illustrates a first client device 202a including a desktop computer while FIG. 2B illustrates a second client device 202b including a mobile device (e.g., a smart phone).

As further shown, each of the client devices 202a-b include graphical user interfaces 203a-b including a display of electronic survey questions thereon. For example, as shown in FIG. 2A, the first client device 202a includes electronic survey questions 204a-e. In particular, a first electronic survey question 204a reads “What is your age?” A second electronic survey question 204b reads “How many years of work experience do you have?” A third electronic survey question 204c reads “What type of phone do you have (iPhone, Android)?” A fourth electronic survey question 204d reads “What is your annual compensation?” A fifth electronic survey question 204e reads “How much money did you spend on tech purchases last year?”

As shown in FIG. 2B, the second client device 202b similarly includes electronic survey questions 208a-e corresponding to the electronic survey questions 204a-e shown in FIG. 2A. In particular, a first electronic survey question 208a reads “Age (years):.” A second electronic survey question 208b reads “Years of Working Experience:.” A third electronic survey question 208c reads “Type of Phone:.” A fourth electronic survey question 208d reads “Annual Compensation:.” A fifth electronic survey question 208e reads “Money Spent on Tech Purchases Last Year:.”

As shown in FIGS. 2A-2B, in one or more embodiments, the survey analysis system 104 provides slightly different survey questions on the different client devices 202a-b. In one or more embodiments, the survey analysis system 104 provides different survey questions (or different formats of the same survey questions) based on the type of client device. For example, the survey analysis system 104 can provide the survey questions 204a-e shown in FIG. 2A based on a determination that the first client device 202a is a desktop. Alternatively, the survey analysis system 104 provides the survey questions 208a-e shown in FIG. 2B based on a determination that the second client device 202b is a mobile device. Thus, in one or more embodiments, the survey analysis system 104 modifies the appearance of the survey questions (or the survey questions themselves) based on a type of device used by respective respondents of the electronic survey.

In addition, as shown in FIGS. 2A-2B, the graphical user interfaces 203a-b further include answer fields or options that enable respondents respond to the electronic survey questions. For example, as shown in FIG. 2A, the first client device 202a includes answer options 206a-e including text boxes that enable a user of the first client device 202a to type responses to the electronic survey questions 204a-e. As shown in FIG. 2B, the second client device 202b includes answer options 210a-e including selectable options that enable a user of the second client device 202b to provide responses to the electronic survey questions 208a-e.

As shown in FIGS. 2A-2B, the answer options similarly differ between the different graphical user interfaces 203a-b on the respective client devices 202a-b (e.g., based on the determined types of client devices). For example, the first graphical user interface 203a includes text boxes to enable a user to type an answer for each of the survey question 204a-e. In contrast, the second graphical user interface 203b includes selectable options to enable the user to select answers for each of the survey questions 208a-e. While FIG. 2B shows selectable options corresponding to ranges of answers, in one or more embodiments, the selectable options enable the user of the second client device to select specific answers (e.g., specific numbers). For example, one or more of the selectable options may include a scroll-bar, sliding icon, or other input method that enables a user to select a specific value from a large range of values (e.g., rather than selecting an option from a limited number of options as shown in FIG. 2B).

In one or more embodiments, as a result of different respondent client devices 106a-n having different input methods (e.g., text boxes v. selectable options), responses to the survey questions may include different forms of answers including, for example, numeric values, text strings, binary values, selected categories, or other types of answers. For example, in one or more embodiments, the survey analysis system 104 may tag, label, or otherwise designate an answer received via text entered on the first client device 202a as numeric or textual. In contrast, the survey analysis system 104 may designate an answer to a corresponding question received from the second client device 202b as categorical or binary. Notwithstanding potential differences in data received in response to common survey questions, the survey analysis system 104 may store or otherwise maintain the received responses and group the responses in accordance with particular survey questions. Additional detail with regard to resolving potential differences in data-types will be described in further detail below.

As mentioned above, in one or more embodiments, the survey analysis system 104 stores or otherwise maintains the received survey information. For example, FIG. 3 illustrates an example embodiment in which the survey analysis system 104 stores the survey information in a survey information table 302 (or simply “table 302”). In particular, as shown in FIG. 3, the table 302 includes datasets grouped in columns 304a-e corresponding to variables 306a-e and rows 308a-n corresponding to respondents (e.g., respondents 108a-n). For example, as shown in FIG. 3, the table 302 includes a first column 304a including a dataset of values corresponding to an age variable 306a for the respondents. As further shown in FIG. 3, the table 302 includes a second column 304b including a dataset of values corresponding to an experience (e.g., years of work experience) variable 306b for the respondents. The table 302 further includes a third column 304c including a dataset of values corresponding to a phone owned variable 306c for the respondents. The table 302 further includes a fourth column 304d including a dataset of values corresponding to a compensation (e.g., annual compensation) variable 306d for the respondents. As further shown, the table 302 includes a fifth column 304e including a dataset of values corresponding to a money spent variable 306e representative of money spent on tech purchases by the respondents.

In one or more embodiments, the table 302 includes additional rows or columns. In addition, the survey analysis system 104 can collect additional survey information from further respondents of the electronic survey and simply append new rows and/or columns to the table 302 upon receiving additional survey information. In one or more embodiments, the survey analysis system 104 stores the survey information in different formats. For example, in one or more embodiments, the survey analysis system 104 stores each dataset as a separate file including one or more identifiers or tags that relate discrete portions of the dataset to respective respondents.

In addition, as shown in FIG. 3, the values contained within the table 302 include various data-types. For example, the values within respective cells may include numeric values, textual values, categorical values, binary values, or other types of data. In one or more embodiments, the survey analysis system 104 receives responses in the form of text (e.g., textual responses typed by respondents) and identifies a type of data for each dataset based on the received responses. For example, where all of the received values for an electronic survey question include numbers, the survey analysis system 104 identifies a corresponding dataset of the received values as a numeric dataset. In addition, where received responses to another question include only two different answers (e.g., iPhone, Android), the survey analysis system 104 can designate a corresponding dataset as binary and assign a 0 or 1 to respective survey responses.

In one or more embodiments, a dataset of survey information can include inconsistencies in data-type. For example, as shown in FIG. 3, the second column 304b corresponding to the experience dataset includes a combination of numeric values and text values. As a result, the survey analysis system 104 may designate the experience dataset as textual, categorical, or other data-type rather than numeric. Similarly, as shown in FIG. 3, the third column 304c including the phone-owned dataset includes one or more “N/A” answers. As a result, the survey analysis system 104 may designate the phone-owned dataset as a categorical (e.g., including three different answers) rather than binary. In instances where various data-type designations can exist for the same dataset, the actual data-type designation for a particular dataset can depend on preferences of an administrative user 112. In other embodiments, the survey analysis system can perform one or more modifications on the survey information in order to assign a data-type designation that will allow for a correct tagging and analysis of the survey information, as will be described below.

In addition, in one or more embodiments, the survey analysis system 104 creates columns or fields within the table 302 based on free-form text provided by respondents in response to one or more questions of the electronic survey. For example, one or more electronic survey questions may include a field that enables the user to provide more general feedback that does not have a limited number of responses. As such, the survey analysis system 104 can receive responses to the electronic survey including free-form text.

As an alternative to simply inserting text within the fields of the table 302, in one or more embodiments, the survey analysis system 104 tags terms of the text to identify specific topics of interest to the respondents. For example, an electronic survey may relate to tech purchases, cell phones, and other tech-related topics, and the survey analysis system 104 may tag terms including brand names, models, or other terms associated with a topic of the electronic survey. In addition, in one or more embodiments, the survey analysis system 104 generates a column including a dataset that identifies those respondents that use specific terms and/or use a specific term a number of times. In this way, the survey analysis system 104 generates datasets including data associated with instances of tagged text based on free-form responses provided by the respondents in response to the electronic survey. As an example, the table 302 may include a first additional column indicating that a specific term has been tagged. In addition, the table 302 may include a second additional column indicating a number of times the specific term was tagged for a respective respondent.

In addition, as will be described in further detail below, the survey analysis system 104 may compare the cited instances of tagged text with other responses to determine regressions, relationships, and other characteristics of respondents that use particular terms. In particular, the survey analysis system 104 may treat the tagged text data similar to other datasets described herein. For example, similar to one or more examples described below, the survey analysis system 104 may determine that a user who is interested in a particular brand (e.g., based on tagged text) is more likely to own a specific phone or spend a certain amount on tech purchases. Thus, in one or more embodiments, the survey analysis system 104 identifies correlations between tagged terms that the respondents use and other data gathered from the electronic survey.

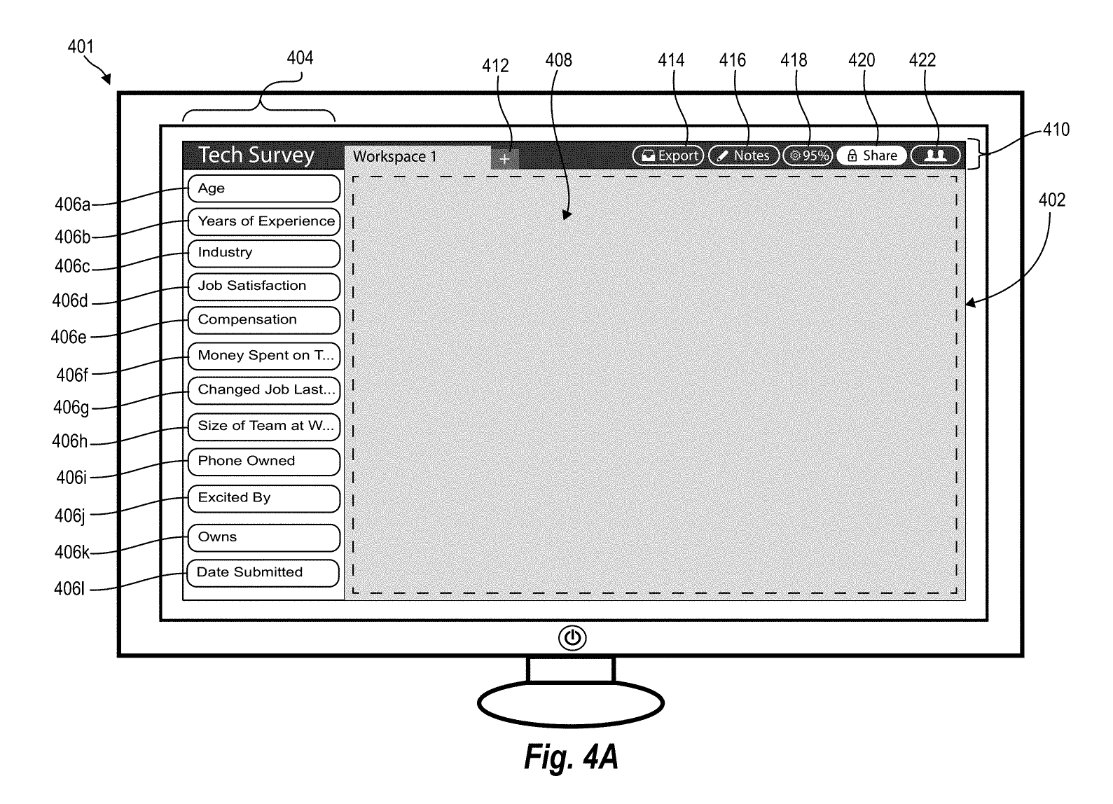

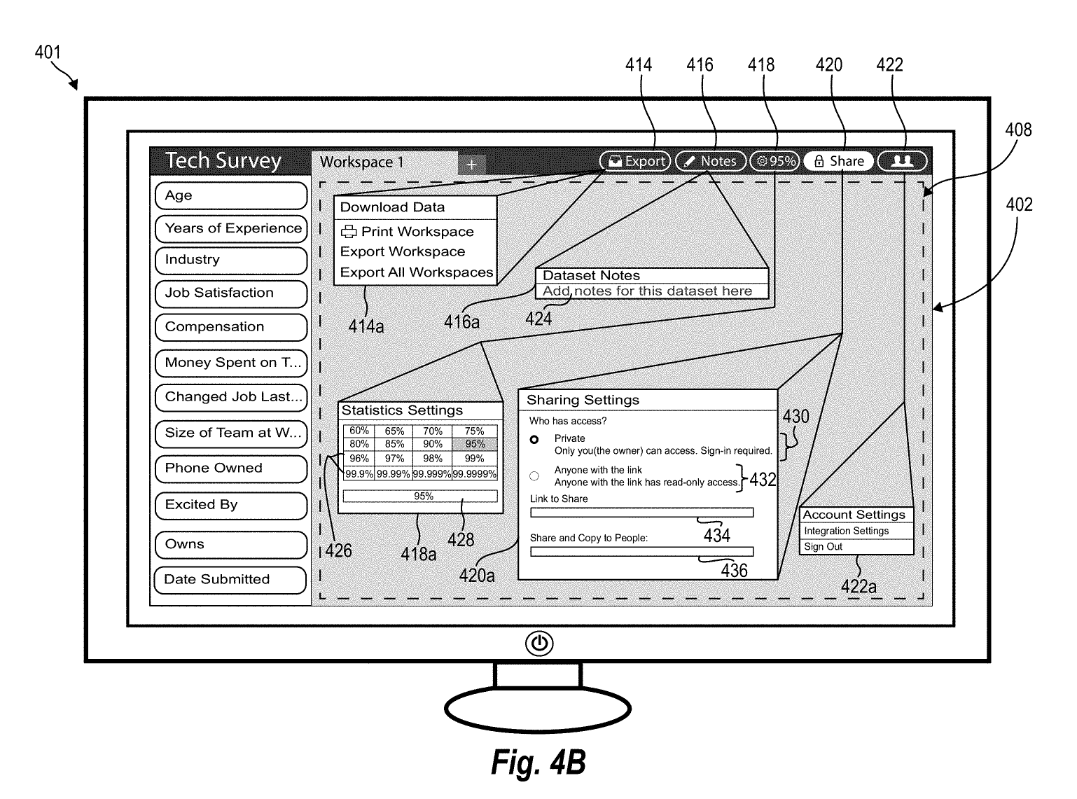

As will be described in further detail below, the survey analysis system 104 may prepare the survey information for analysis by cleaning, correcting, or otherwise modifying the data contained within the survey information. For example, the survey analysis system 104 can determine that a dataset should include only numeric values and either disregard non-numeric values or extract numeric information from each of the non-numeric responses. In one or more embodiments, the survey analysis system 104 extracts data and determines data-types upon receiving the survey information (and without receiving additional user input). In addition, as will be described in further detail below, the survey analysis system 104 can determine data-types and/or extract data in accordance with one or more user inputs received in conjunction with a graphical user interface provided to the administrative user 112. In particular, as will be described in further detail below in connection with FIGS. 4-7K, the survey analysis system 104 can clean, add metadata, or otherwise prepare the survey information for analysis in a variety of ways.

Additional detail will now be described in connection with example graphical user interfaces provided to the administrative user 112. For example, as mentioned above, in one or more embodiments, the survey analysis system 104 provides a graphical user interface including a presentation of the survey information (e.g., a display of the table 302) as well as a presentation of selectable options that enable the administrative user 112 to interact with and view discrete portions of the survey information. It will be understood that each of the graphical user interfaces described herein illustrate example features and functionality of the survey analysis system 104 with regard to example datasets of survey information. As such, it will be understood that none of the illustrated examples are intended to be limiting to the features and functionality of the survey analysis system 104.

FIG. 4A illustrates an example client device 401 including a graphical user interface 402. In particular, FIG. 4A illustrates an example client device 401 for presenting data received from the survey analysis system 104 via the graphical user interface 402. In one or more embodiments, the survey analysis system 104 provides the graphical user interface 402 via a web browser on the client device 401. Alternatively, in one or more embodiments, the survey analysis system 104 provides the graphical user interface 402 via an application (e.g., software application, mobile application) installed on the client device 401. As described herein, the client device 401 includes similar features and functionality as the administrator client device 110 described above in connection with FIG. 1. In addition, the client device 401 can refer to any type of client device including, for example, a desktop computer, a tablet, or mobile client device (e.g., a smart phone).

As shown in FIG. 4A the graphical user interface 402 includes a variable menu 404 including variable tabs 406a-n associated with discrete datasets of the survey information (e.g., datasets 304a-e shown in FIG. 3). For example, as shown in FIG. 4A, the variable menu 404 includes an age tab 406a corresponding to an age dataset. In addition, the variable menu 404 includes a years of experience tab 406b, an industry tab 406c, a job satisfaction tab 406d, a compensation tab 406e, a money spent on tech purchases tab 406f, a changed job last year tab 406g, a size of team at work tab 406h, a phone owned tab 406i, an excited by tab 406j, an owns tab 406j, an owns tab 406k, and a date submitted tab 406l. Each of the tabs 406a-l correspond to a respective dataset including a discrete subset of values (e.g., datapoints) and other data from the survey information. For instance, the age tab 406a refers to a dataset including all survey responses to a survey question “What is your age?” As will be further described below, in response to detecting a selection of one or more tabs 406a-l, the survey analysis system 104 provides corresponding survey information and/or selectable options that enable an administrative user 112 to interact with the graphical user interface 402.

As further shown in FIG. 4A, the graphical user interface 402 includes a workspace 408 (shown as “Workspace 1”). As shown in FIG. 4A, the workspace 408 includes a blank space on the graphical user interface 402 prior to the survey analysis system 104 detecting a selection of one or more of the tabs 406a-l. As will be described in further detail below, the survey analysis system 104 can provide descriptions of survey information within the workspace 408. In addition, the survey analysis system 104 can provide a presentation of one or more statistical results based on tests performed on the survey information.

As further shown in FIG. 4A, the graphical user interface 402 includes a user account toolbar 410. As shown, the user account toolbar 410 includes a tab for the presently displayed workspace 408 (“Workspace 1” tab) in addition to a create new workspace tab 412. In response to detecting a user selection of the create new workspace tab 412, the survey analysis system 104 can create a new workspace associated with the same or different survey information. For example, in response to detecting a user selection of the create new workspace tab 412, the survey analysis system 104 can create a new workspace including variable tabs 406a-1 corresponding to the same datasets of the first workspace 408. Alternatively, in one or more embodiments, the survey analysis system 104 creates a new workspace associated with a different set of data (e.g., survey information from responses to a different electronic survey) including different variable tabs.

As further shown, the user account toolbar 410 includes selectable elements 414-422. For example, the user account toolbar 410 includes an export element 414, a notes element 416, a statistical setting element 418, a share element 420, and a user account element 422. In one or more embodiments, the survey analysis system 104 provides menus including further selectable options associated with each element 414-422 in response to detecting a user selection of one of the elements 414-422. For example, in response to detecting a user selection of one of the elements 414-422, the survey analysis system 104 provides a menu (e.g., dropdown menu) corresponding to the selected element. In one or more embodiments, the selectable elements 414-422 provide options applicable to any workspaces accessible to the administrative user 112. Alternatively, in one or more embodiments, the selectable elements 414-422 provide options application to the selected workspace 408.

FIG. 4B shows example dropdown menus 414a-422a corresponding to each of the selectable elements 414-422 on the user account toolbar 410. In particular, the survey analysis system 104 provides the dropdown menus 414a-422a in response to detecting a user selection of respective elements 414-422. In one or more embodiments, the survey analysis system 104 provides only the dropdown menu 414a-422a corresponding to the selected element 414-422. Nonetheless, for the sake of explanation, FIG. 4B shows the dropdown menus 414a-422a displayed together.

For example, as shown in FIG. 4B, in response to detecting a user selection of the export element 414, the survey analysis system 104 provides an export dropdown menu 414a. As shown in FIG. 4B, the export dropdown menu 414a includes options for downloading data, printing a workspace, exporting a workspace, and exporting all workspaces. The survey analysis system 104 performs (or causes the client device 401 to perform) a corresponding function of export dropdown menu 414a based on a user selection of one of the selectable options provided within the export dropdown menu 414a.

As further shown in FIG. 4B, in response to detecting a user selection of the notes element 416, the survey analysis system 104 provides a notes dropdown menu 416a. As shown in FIG. 4B, the notes dropdown menu 416a includes text field 424 for entering text. In one or more embodiments, the survey analysis system 104 enables an administrative user 112 to enter text within the text field 424 for one or more multiple workspaces. Alternatively, in one or more embodiments, the survey analysis system 104 enables the administrative user 112 to enter text within the text field 424 for a particular dataset or collection of survey information (e.g., including multiple datasets) corresponding to responses for an electronic survey.

As further shown in FIG. 4B, in response to detecting a user selection of the statistics setting element 418, the survey analysis system 104 provides a settings dropdown menu 418a. As shown in FIG. 4B, the settings dropdown menu 418a includes selectable icons 426 for different confidence levels ranging between 60% and 99.9999%. In particular, the settings dropdown menu 418a enables a user to select an icon 426 corresponding to a percentage of all possible samples (e.g., respondents) expected to fall within a specified range of values. For example, a 95% confidence level would imply that 95% of the confidence intervals would include a true population parameter. In addition, as shown in FIG. 4B, the settings dropdown menu 418a includes a settings field 428 that enables a user of the client device 401 to enter a specific confidence level (as opposed to selecting one of the icons 426). In response to a user selection of a particular icon 426 or upon the user entering a specific percentage in the settings field 428, the survey analysis system 104 can apply the indicated confidence level to any number of statistical tests performed on the survey information (or on any combination of selected datasets).

As further shown in FIG. 4B, in response to detecting a user selection of the share element 420, the survey analysis system 104 provides a share dropdown menu 420a. As shown in FIG. 4B, the share dropdown menu 420a includes selectable options that enable the user of the client device 401 to identify access settings to modify or otherwise apply to the workspace 408. For example, as shown in FIG. 4B, the share dropdown menu 420a includes a first shared access option 430 associated with a private setting where only the owner or creator (e.g., administrative user 112) of the workspace 408 has access. For example, in one or more embodiments, the survey analysis system 104 only provides access to the user of the client device 401 upon signing into a user account. In addition, the share dropdown menu 420a includes a second shared access option 432 associated with providing read-only access to the workspace 408 to anyone having a link to the workspace 408. In one or more embodiments, the survey analysis system 104 expands or restricts access to the workspace 408 in accordance with an associated setting.

As shown in FIG. 4B, the share dropdown menu 420a further includes options associated with directly sharing the workspace 408 with other users. For example, where the user has selected the second shared access option 432 to provide read-only access to the workspace 408 to anyone having a link, the survey analysis system 104 provides a link field 434 including a link within the share dropdown menu 420a. The user of the client device 401 can copy and paste or otherwise share the link with other users. Alternatively, where the user of the client device 401 has selected the first shared access option 430, the survey analysis system 104 may hide or otherwise not include the link within the link field 434 of the dropdown menu 420a (as shown in FIG. 4B). In addition, as shown in FIG. 4B, the share dropdown menu 420a includes a share field 436 within which a user of the client device 401 can enter one or more emails, phone numbers, instant message (IM) addresses, or other user identifier. In one or more embodiments, the survey analysis system 104 can provide access to any user identified within the share field 436. For example, in one or more embodiments, the survey analysis system 104 provides a communication (e.g., email, IM, text message) including the link therein to any user identified within the share field.

As further shown in FIG. 4B, in response to detecting a user selection of the user account element 422, the survey analysis system 104 provides a user account dropdown menu 422a. As shown in FIG. 4B, the user account dropdown menu 422a includes selectable options that enable the user of the client device 401 to perform one or more actions. For example, as shown in FIG. 4B, the user account dropdown menu 422a includes an account settings option that enables the user to modify a profile and/or change a password. In addition, the user account dropdown menu 422a includes an integration settings option to enable a user to add a new application (e.g., a new application program interface (API)) from which the survey analysis system 104 can import data. Further, the user account dropdown menu 422a includes a sign out option that enables the user to sign out of a session or application associated with the survey analysis system 104.

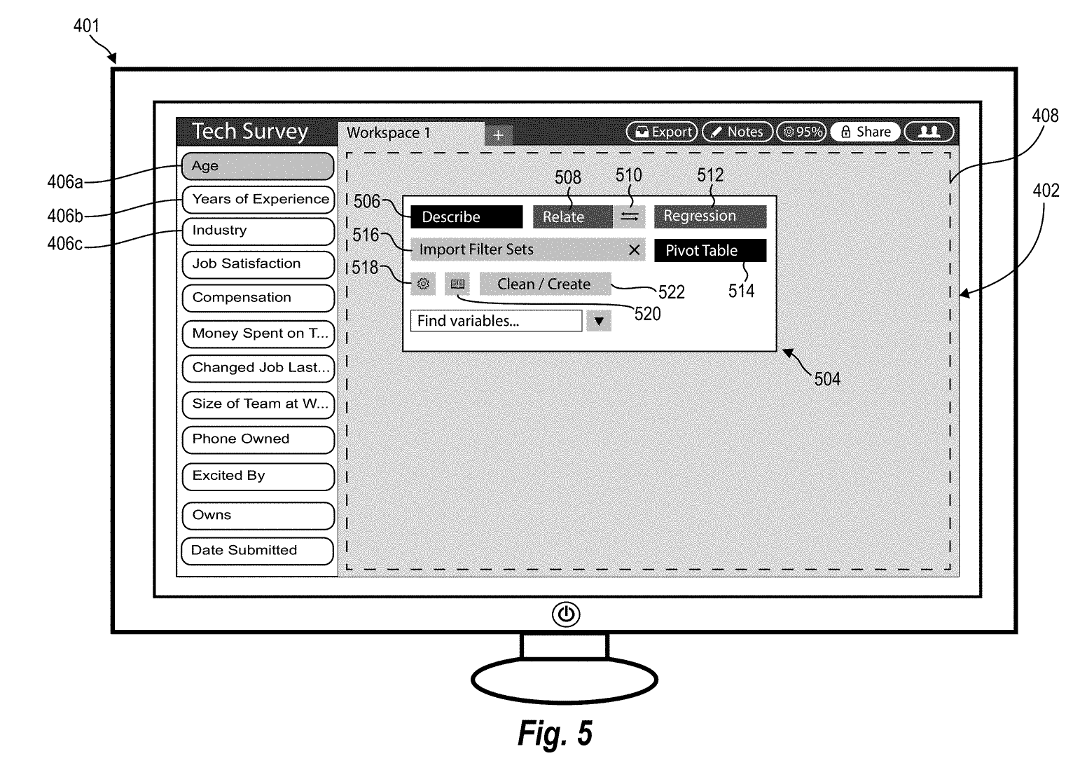

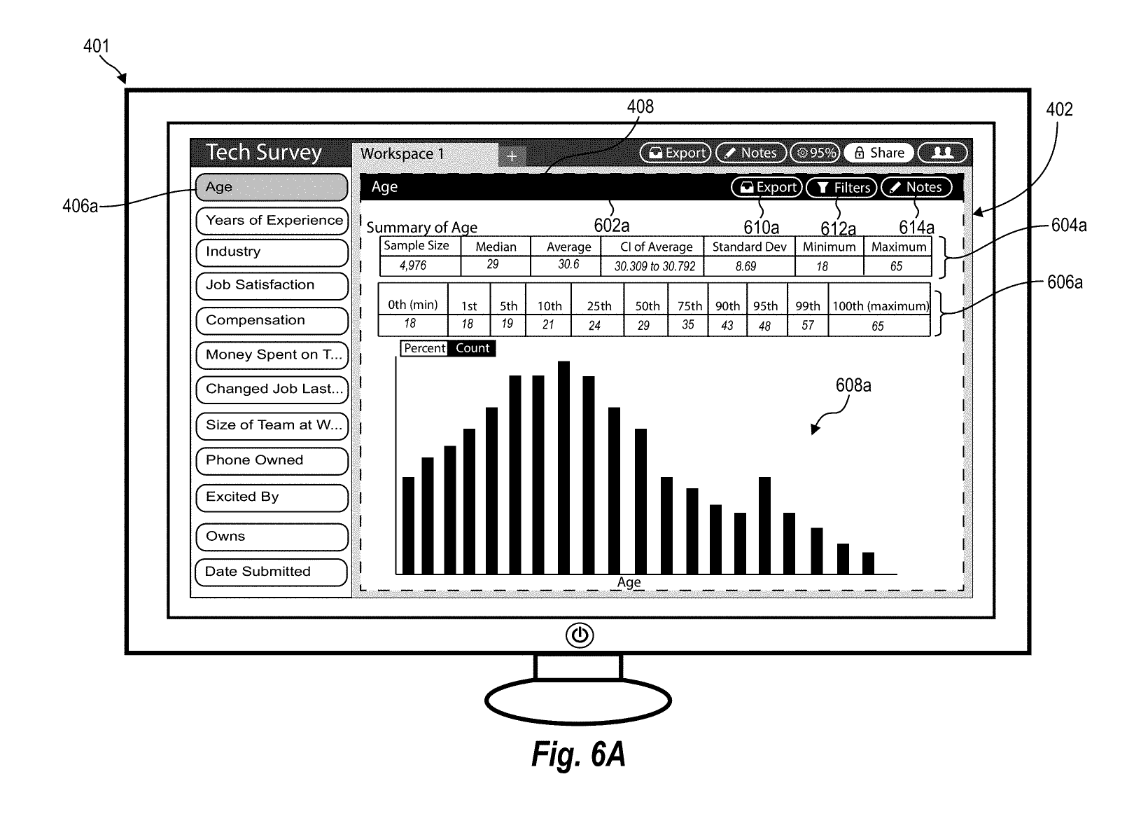

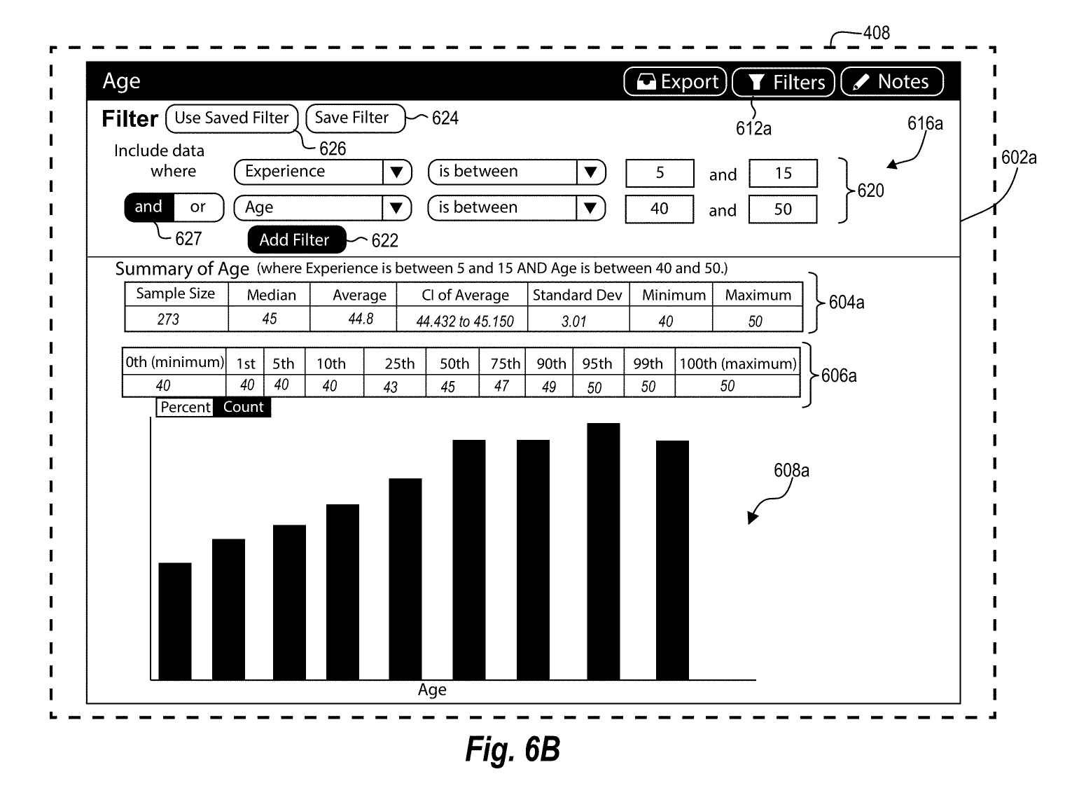

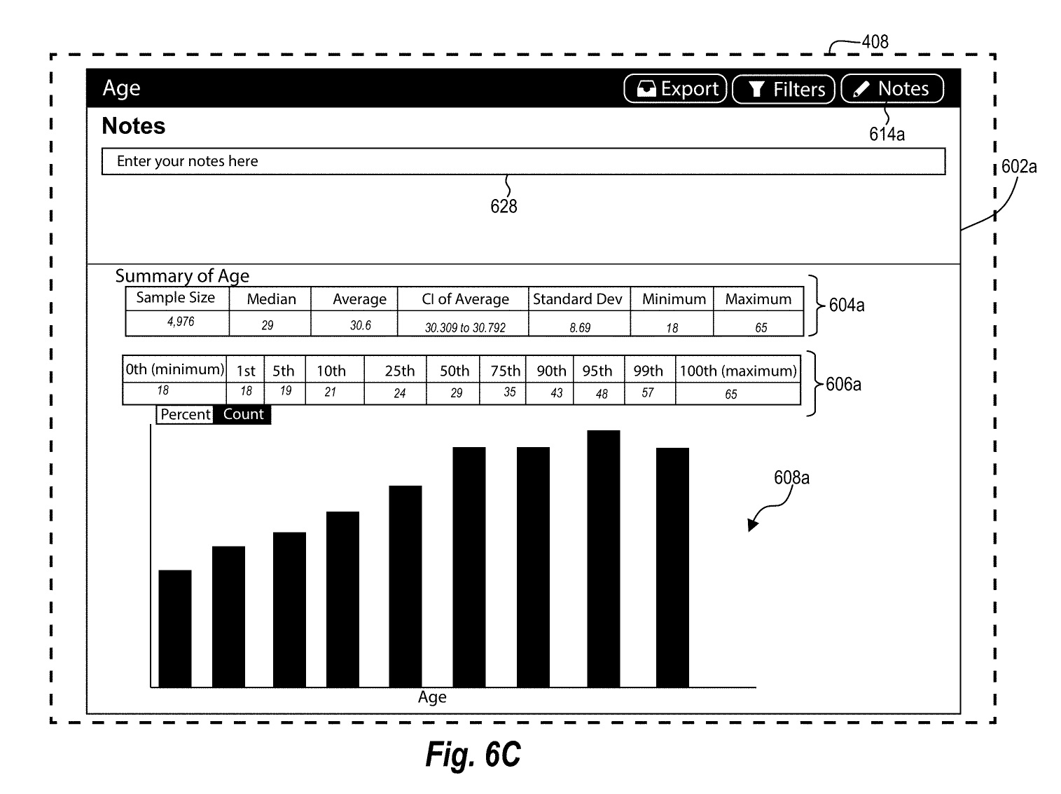

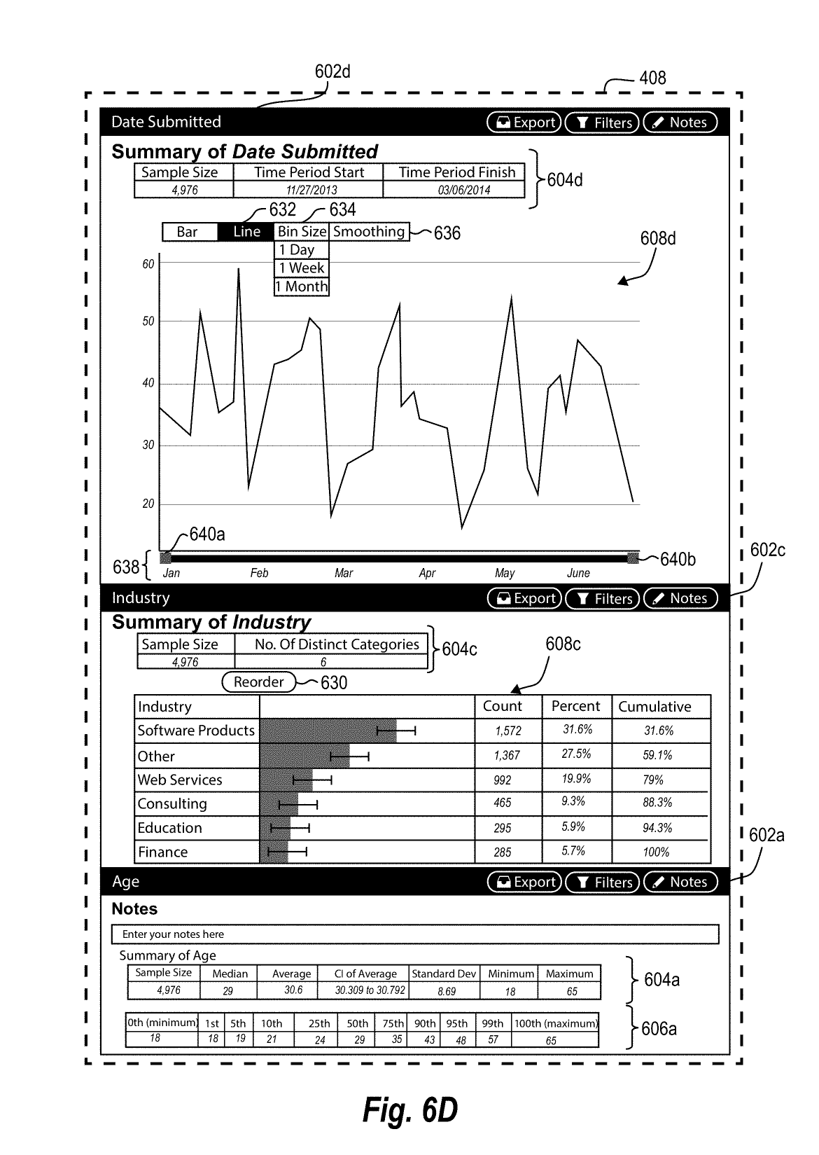

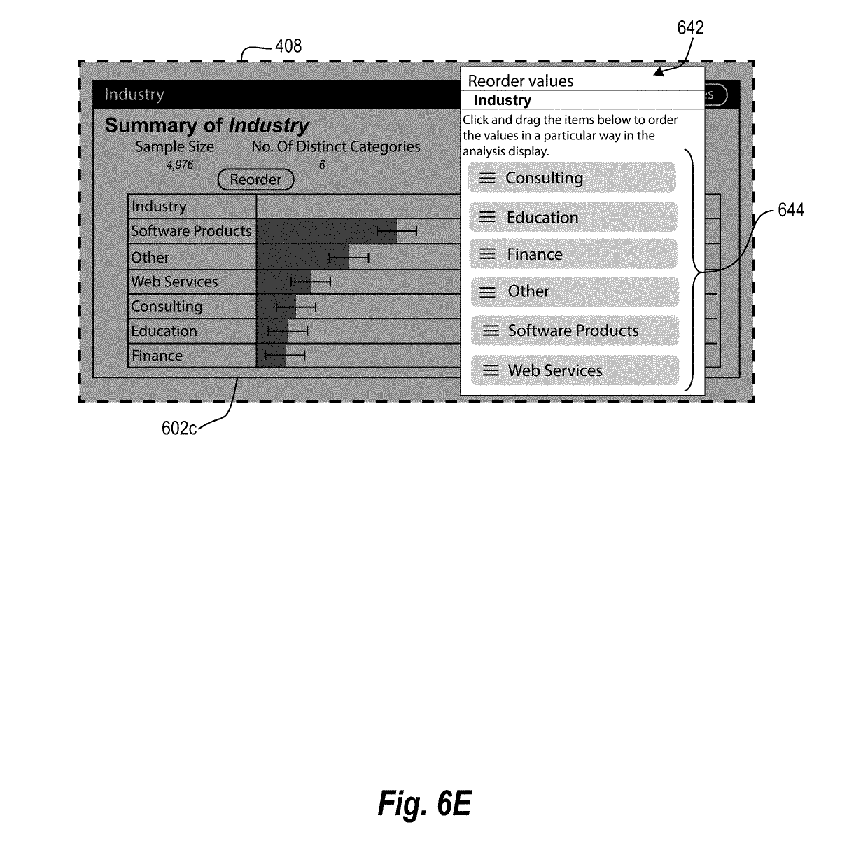

In addition to the toolbar 410, in one or more embodiments, the graphical user interface 402 includes a presentation menu 504 including selectable options associated with generating and presenting the survey information via the graphical user interface 402, illustrated in FIG. 5. In particular, as shown in FIG. 5, the survey analysis system 104 provides a number of selectable options that, when selected in conjunction with the variable tabs 406a-i, facilitate generation of one or more presentations associated with the datasets associated with the variable tabs 406a-i. For example, as will be described in further detail below in conjunction with FIGS. 6A-11B, the survey analysis system 104 generates a presentation associated with the survey information and provides the presentation within the workspace 408.

As shown in FIG. 5, the presentation menu 504 includes a plurality of selectable options associated with generating and presenting the survey information via the graphical user interface 402. For example, as shown in FIG. 5, the presentation menu 504 includes a describe button 506, a relate button 508, a switch-axis button 510, a regression button 512, a pivot table button 514, an import filter set button 516, a variable setting button 518, a data grid button 520, and a clean/create button 522. As shown in FIG. 5, the survey analysis system 104 provides each of the buttons 506-522 via the graphical user interface 402. In addition, in response to detecting a user selection of one of the buttons 506-522, the survey analysis system 104 performs a corresponding action. For example, as will be described in further detail below, the survey analysis system 104 provides features and functionality upon detecting a selection of each of the buttons 506-522 of the presentation menu 504.

In particular, as will be described in further detail below in connection with FIGS. 6A-10D, the survey analysis system 104 performs one or more statistical analyses of the survey information and generates cards that include data about the statistical analyses performed on the survey information. For example, as will be described in further detail below, the survey analysis system 104 generates one or more description cards in response to detecting a user selection of the description button 506 and provides the cards within the workspace 408. As another example, and as will be described in further detail below, the survey analysis system 104 generates one or more relationship cards in response to detecting a user selection of the relate button 508. In addition, the survey analysis system 104 can generate other cards including, for example, regression cards or pivot table cards.

As used herein, “cards” refer to a discrete data object associated with one or multiple datasets. For example, in one or more embodiments, a card refers to a data object including information about a selected dataset of collected survey information. In one or more embodiments, a card refers to a defined space within a workspace 408 including a presentation of data about a dataset including, for example, calculated values of a statistical result, a visualization of the statistical result, and a plain text description of the statistical result. As described herein, the survey analysis system 104 can generate different types of cards including, for example, a description card, a relationship card, a regression card, or a pivot table card. It will be understood, based on the disclosure herein, that a workspace 408 can include any number of cards, each associated with one or more respective datasets.

Moving to FIGS. 6A-6E, the survey analysis system 104 provides various features and functionality in association with detecting a user selection of the describe button 506 (shown in FIG. 5). For example, as shown in FIG. 6A, a user of the client device 401 can select the age tab 402a (corresponding to the age dataset of the survey information) and the describe button 506. In response to detecting the user selection of the age tab 402a and the describe button 506, the survey analysis system 104 generates an age description card 602a including information about the age dataset and provides the age description card 602a within the workspace 408.

As shown in FIG. 6A, the age description card 602a includes a summary 604a of the age dataset including calculated values of the age dataset. In addition, as shown in FIG. 6A, the age description card 602a includes a percentile chart 606a including percentile values (e.g., the value below which a certain percent of the dataset lies) for the age dataset. Moreover, as shown in FIG. 6A, the age description card 602a includes a graph 608a or other visualization of the age dataset.

As shown in FIG. 6A, the summary 604a includes calculated values of the dataset including a sample size (e.g., the number of datapoints with a value for the age variable), a median value, an average value, a confidence interval of the average (e.g., a margin of error around the average) in accordance with the selected statistics setting, a standard deviation (e.g., a measure of dispersion), a minimum value, and a maximum value. In one or more embodiments, the survey analysis system 104 determines and provides the particular fields of information within the summary 604a based on a data-type of the dataset. For example, in one or more embodiments, the survey analysis system 104 determines a data-type of the dataset and provides particular information about the dataset based on the determined data-type. In particular, as shown in FIG. 6A, the survey analysis system 104 provides the displayed fields of the summary 604a based on a determination that the age dataset includes numeric values. Alternatively, as will be described in further detail below in connection with FIG. 6D, the survey analysis system 104 can include other displayed fields for datasets having other different data-types.

As further shown, the percentile chart 606a includes percentile values within respective fields of the percentile chart 606a. The survey analysis system 104 can provide any number of percentile values ranging from 0^{th} percentile to the 100^{th} percentile. In addition, as shown in FIG. 6A, age description card 602a includes a selectable option to show/hide the percentile values thus enabling a user of the client device 401 to cause the survey analysis system 104 to collapse or expand the percentile chart 606a.

In addition, as shown in FIG. 6A, the age description card 602a includes a bar chart 608a of the age dataset. In particular, as shown in FIG. 6A, the bar chart 608a includes a chart with each bar representing a number of values for each age ranging from the minimum to maximum within the age dataset. As shown in FIG. 6A, the x-axis of the bar chart 608a refers to specific ages while the y-axis of the bar chart 608a refers to a count of values within the dataset corresponding to each age. As shown in FIG. 6A, the age description card 602a includes an option to change the y-axis from the count of datapoints of the dataset to a percentage of datapoints of the dataset for each age. For example, in response to detecting a user selection of the option to change the y-axis, the survey analysis system 104 can modify the y-axis from a count to a percentage.

As further shown in FIG. 6A, the age description card 602a includes a plurality of selectable options for modifying information displayed within the age description card 602a. For example, as shown in FIG. 6A, the age description card includes a toolbar or other space above the age description card including an export option 614a, a filter option 612a, and a notes option 614a. Upon detecting a user selection of any one of the selectable options 610a-614a, the survey analysis system 104 facilitates modification of the information displayed within the age description card 602a and/or exporting information displayed within the age description card to another platform.

For example, upon detecting a user selection of the export option 610a, the survey analysis system 104 exports the information provided within the age description card 602a from the server device 102 to one or more programs on the client device 401. For example, in one or more embodiments, upon detecting a selection of the export option 610a, the survey analysis system 104 exports the information of the age description card 602a to a data management application within a spreadsheet. In particular, in one or more embodiments, the survey analysis system 104 exports the data by causing the client device 401 to download the information of the age description card 602a within a table (or other format) thus enabling the client device 401 to display the age description information within a third-party application or other local application of the client device 401.

In another example, upon detecting a user selection of the filter option 612a, the survey analysis system 104 provides a plurality of filter controls to enable the user of the client device 401 to modify the information displayed within the age description card. For example, as shown in FIG. 6B, in response to detecting a user selection of the filter option 612a, the survey analysis system 104 provides a filter interface 616a. As shown in FIG. 6B, the filter interface 616a includes filter fields 620, an add filter button 622, a save filter button 624, a use saved filter button 626, and a filter operator button 627.

In particular, as shown in FIG. 6B, a user can interact with the filter fields 620 to narrow or otherwise modify a dataset associated with the age description card 602a. For example, as shown within the filter fields 620, the survey analysis system 104 can limit the description of the age dataset to include only those individuals having between 5 and 15 years of experience and whose age is between 40 and 50. As shown in FIG. 6B, the filter controls 620 include fields that enable a user to change filter variables, change the ranges of the selected filter variables, and further change an operator (e.g., and, or) by selecting the filter operator button 627.

As shown in FIG. 6B, the filter interface 616a further includes the add filter button 622, which facilitates filtering the age dataset based on one or more additional variables. For example, in response to detecting a user selection of the add filter button 622, the survey analysis system 104 provides filter fields for another variable including a range or subset of the variable. In addition, the survey analysis system 104 can further broaden or narrow the information displayed within the age description card 602a based on one or more user inputs modifying values of the filter fields for the added variable.

Thus, the survey analysis system 104 facilitates creation of a filter for modifying the presentation of the age description card 602a. As shown in FIG. 6B, the filter interface 616a further includes the save filter button 624 and the use saved filter button 626. In particular, in response to detecting selection of the save filter button 624, the survey analysis system 104 saves the filter defined by the filter fields 620 for use in filtering cards for other datasets. Alternatively, in response to detecting a selection of the use saved filter button 626, the survey analysis system 104 applies a previously defined filter to the corresponding card (e.g., the age description card 602a).

As shown in FIG. 6B, the survey analysis system 104 can apply the filter defined within the filter interface 616a to the age description card 602a. For example, in response to detecting population of the filter fields 620, the survey analysis system 104 can modify the displayed information within the age description card 602a. For example, in contrast to the age description card 602a shown in FIG. 6A, the modified (e.g., filtered) age description card 602a shown in FIG. 6B includes a smaller sample size, thus indicating fewer datapoints of the age dataset represented within the modified age description card. In addition, the survey analysis system 104 recalculates the values of the summary 604a and the values of the percentile chart 606a to reflect the filtered values indicated by the filter fields 620. Moreover, the bar chart 608a of the age values reflects the filtered age dataset.

In addition to facilitating presentation of a filtered dataset, the survey analysis system 104 further enables a user to compose a note for the age description card 602a. For example, as shown in FIG. 6C, and similar to FIG. 6A, the age description card 602a includes the summary 604a, the percentile chart 606a, and the bar chart 608a. As further shown in FIG. 6C, the age description card 602a includes a note field 628 within which the user can compose or add a note to the age description card 602a. For example, in response to detecting a user interaction with the note button 614a, the survey analysis system 104 provides the note field 628 and enables the user of the client device 401 to add a note to the age description card 602a.

Features and functionality described in connection with the age description card 602a can similarly apply to other cards added to the workspace 408. For example, as shown in FIG. 6D, the workspace 408 includes additional description cards added to the workspace 408. For example, as shown in FIG. 6D, the workspace 408 includes the age description card 602a including the summary 604a, percentile chart 606b, and other information included therein (as described above in connection with FIGS. 6A-6C). As further shown, the workspace 408 includes an industry description card 602c and a date submitted description card 602d. As shown in FIG. 6D the industry description card 602c includes information about the industry dataset and the date submitted description card 602d includes information about the date submitted dataset.

For example, as shown in FIG. 6D, the industry description card 602c includes a summary 604c of the industry dataset including a sample size of the dataset and a number of distinct categories contained within the dataset. In addition, the industry description card 602c includes a category chart 608c that provides a visualization of the values within the industry dataset. In particular, the category chart 608c includes a chart showing a number and percentage of datapoints represented by each of the categories within the industry dataset. Specifically, as shown in FIG. 6D, the category chart 608c includes a count and percentage of datapoints for each of the industries represented in the electronic survey including Software Products, Other, Web Services, Consulting, Education, and Finance/Banking.

As shown, the survey analysis system 104 orders the categories of the category chart 608c in descending order based on the number or percentage of datapoints within the industry dataset correspond to the respective categories. Alternatively, the survey analysis system 104 can order the categories of the category chart 608c in accordance with different criteria (e.g., in accordance with user input, ascending order, alphabetical order). For example, as shown in FIG. 6D, the industry description card 602c includes a reorder button 630. In response to detecting a selection of the reorder button, the survey analysis system 104 facilitates reordering the categories within the category chart 608c. Additional detail with regard to modifying the order of the categories will be described in further detail below in connection with FIG. 6E.

In addition, as shown in FIG. 6D, the date submitted subscription card 602d includes a summary 604d of the date submitted dataset including a sample size as well as a starting and finishing date corresponding to the first and last dates on which the survey information was collected. In addition, the date submitted description card 602d includes a date chart 608d including a graph showing a number of submissions of electronic survey information received on any given day, week, or month between the starting and finishing dates.

As further shown, the date submitted subscription card 602d includes a number of selectable options (e.g., buttons) that facilitate modification of the information displayed within the submitted description card 602d. For example, the date submitted subscription card 602d includes a bar/line button 632 that facilitates modifying the display of the date chart 608d from between a bar chart and a line graph (as shown in FIG. 6D). For example, in response to detecting a user selection of the bar/line button 632, the survey analysis system 104 toggles a display of the date chart 608d between a bar chart and a line graph.

In addition, as shown in FIG. 6D, the date submitted subscription card 602d includes a bin size button 634 that facilitates modifying a bin size of each represented value within the date chart 6081. For example, in response to detecting a selection of the bin size button 634, the survey analysis system 104 can provide a menu (e.g., dropdown menu) of options including a day, week, month, or interval of time. Upon detecting a selection of one of the intervals of time, the survey analysis system 104 modifies the date chart 608d to include more or fewer values along the date chart 608d. For example, where FIG. 6D provides a value for a number of survey submissions collected on each day between the starting and finishing dates of the electronic survey, in response to detecting a user selection of a week, the survey analysis system 104 would provide a date chart 608d including values representative of a number of survey submissions collected on each week between the starting and finishing dates of the electronic survey.

In addition, as shown in FIG. 6D, the date submitted subscription card 602d includes a range scrollbar 638 that enables a user to narrow or broaden the range of datapoints included within the date chart 608d. For example, the range scrollbar 638 includes a starting date icon 640a and a finishing date icon 640b at positions along the range scrollbar 638 corresponding to the starting date and finishing date of the electronic survey. In one or more embodiments, the survey analysis system 104 enables a user to modify the date chart 608d to include datapoints from the date submitted dataset corresponding only to the dates of the range scrollbar 638 between the starting date icon 640a and the finishing date icon 640b. Thus, a user can cause the survey analysis system 104 to widen or narrow the data displayed within the date chart 6081 by sliding the starting date icon 640a and/or finishing date icon 640b horizontally along the range scrollbar 638.

Thus, the survey analysis system 104 provides a display of survey information corresponding to one or multiple datasets of the survey information within the workspace 408. For example, as shown in FIG. 6D, the user can select multiple tabs corresponding to respective datasets and select the describe button 506 (shown in FIG. 5). In response, the survey analysis system 104 generates a description card for each selected tab. In one or more embodiments, the survey analysis system 104 provides one or more new cards in line with previously generated cards within the workspace 408. For example, as shown in FIG. 6D, upon detecting a selection of the industry tabs 406c and the date submitted tab 406l, the survey analysis system 104 generates new description cards 602c, 602d and provides the new cards 602c, 602d within the workspace 408 in line with the previously generated age description card 602a.

In one or more embodiments, the survey analysis system 104 creates a duplicate card or cards corresponding to the same variable within the workspace 408. For example, where the workspace 408 already includes an age description card 602a and detects a selection of the describe button 506 while the age tab 406a is again selected (or still selected), the survey analysis system 104 generates a new age description card for the age dataset. In particular, in one or more embodiments, the survey analysis system 104 replaces the age description card with a newly generated age description card (e.g., similar or identical to the previously generated age description) in response to detecting a selection of the described button 506 while the age tab 406a is selected. Alternatively, rather than generating a duplicate card, in one or more embodiments, the survey analysis system 104 deletes the previously generated card and generates a new card for each of the selected tabs.

In addition, as shown in FIG. 6D, the survey analysis system 104 causes different types of information to be displayed for different datasets based on or more factors. In particular, as shown in FIG. 6D, the cards displayed within the workspace 408 include different information notwithstanding the same command (e.g., the selection of the described button 506) detected in conjunction with the selection of the variable tabs. For example, as described above, the age description card 602a includes the summary 604a, the percentile chart 606a, and the bar chart 608a. In contrast, the industry description card 602c includes a summary 604c and the category chart 608c. Further, the date submitted description card 602d includes the summary 604d and the date chart 608d.

In one or more embodiments, the survey analysis system 104 determines the information to be displayed within each card in accordance with the data-type of the selected dataset. For example, the survey analysis system 104 may determine to provide the summary 604a including specific values, the percentile chart 606a including percentile values, and the bar chart 608a based on a determination that the age dataset includes numeric values. Alternatively, the survey analysis system 104 may determine to provide the specific values within the industry description card 602c and the date submitted description card 6021 based on a determination that the industry dataset includes categorical data and the date submitted dataset includes date data. In addition, the survey analysis system 104 may determine to display different information for each of the different types of data from the collected electronic survey information. Accordingly, the survey analysis system 104 recognizes the data type for a particular data set, and based on the data type, provide information, charts, summaries, reports, and/or options that suit the particular data type. Thus, a user that is inexperienced with formatting or analyzing data can view the data in a form that will make the particular data understandable and intuitive.

In one or more embodiments, the survey analysis system 104 enables a user to alter one or more aspects of the data presented within the respective cards of the workspace 408 without changing the data. For example, in one or more embodiments, the survey analysis system 104 causes axes of one or more graphs or charts to swap in response to detecting a user selection of the swap axis button 510, described above in connection with FIG. 5. For example, with respect to the age description card 602a, the survey analysis system 104 can cause the x-axis of the bar chart 608a corresponding to the age and the y-axis of the bar chart 608a corresponding to a count of datapoints to switch places. The survey analysis system 104 can similarly swap values for any other cards having charts or graphs therein based detecting a user selection of the swap button 510.

In addition, as mentioned above, one or more of the cards may include a reorder button that facilitates reordering one or more variables of a particular dataset from a default order based on user input. For example, as shown in FIG. 6D, the industry description card includes a reorder button 630. In response to detecting a user selection of the reorder button 630, the survey analysis system 104 can provide a reorder interface 642 as shown in FIG. 6E. In particular, as shown in FIG. 6E, the reorder interface 642 includes icons 644 representative of each variable within the industry dataset. In one or more embodiments, the survey analysis system 104 provides the reorder interface 642 via the graphical user interface 402, thus enabling a user of the client device 401 to interact with each of the icons 644 of the reorder interface 642.

In particular, the user may interact with the icons of the reorder interface 642 to change an order of the variables from a default order initially provided in response to generating and providing the industry description card 602c within the workspace 408. For example, where the survey analysis system 104 provides the variables in an order corresponding to a number of counts for each variable within the dataset, the user may wish to reorder the variable to place the “other” category last. In response, the survey analysis system 104 modifies the industry description card by reordering the variables in accordance with the user interactions with the icons 644 of the reorder interface 642.

As an alternative to reordering the variables from a default configuration based on a manual reordering of the variables, in one or more embodiments, the survey analysis system 104 reorders the variables based on a selected order criteria. For example, in one or more embodiments, the reorder interface 642 includes selectable order options corresponding to data-types. For example, a dataset of a categorical data-type may include selectable options to reorder the variables based on a number of datapoints as an alternative to ordering the variables based on alphabetical order (or visa versa).

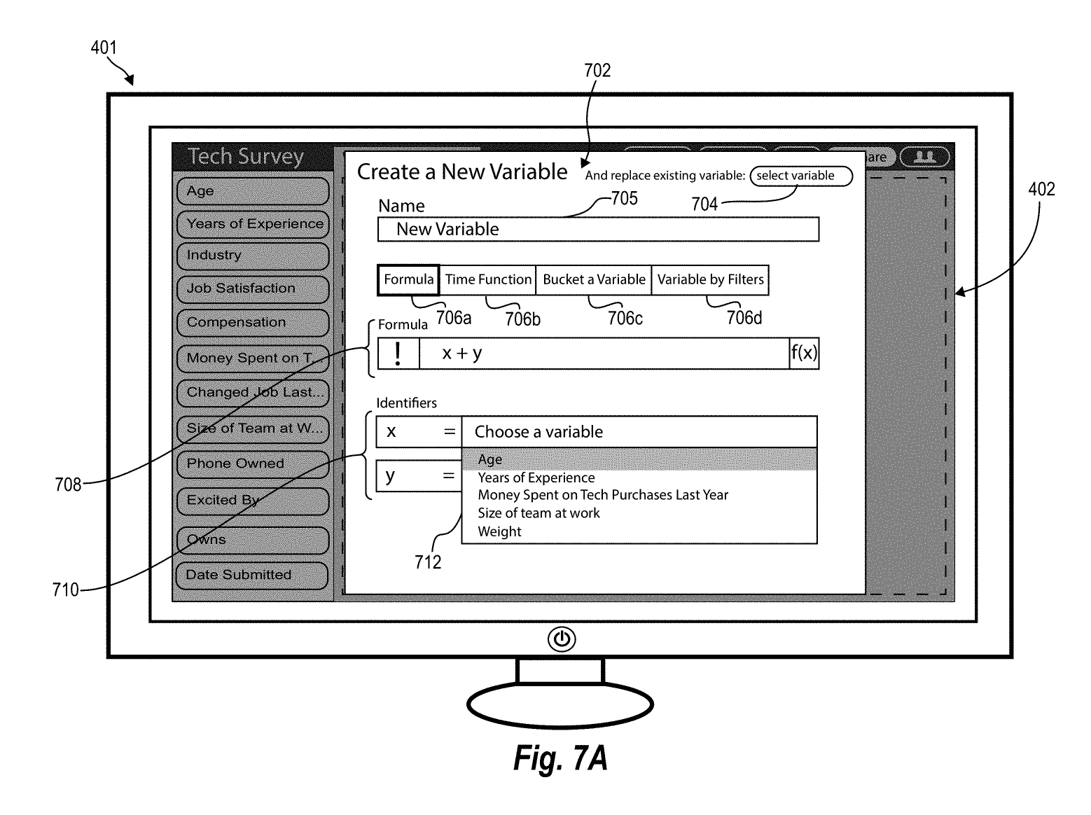

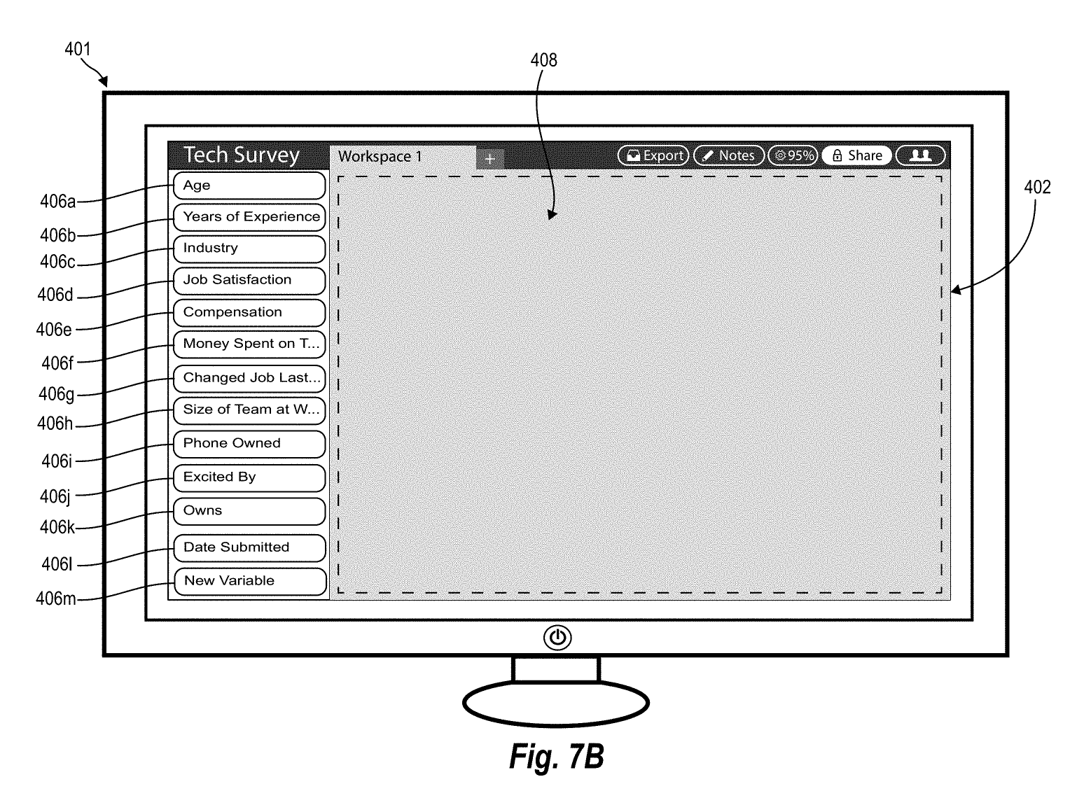

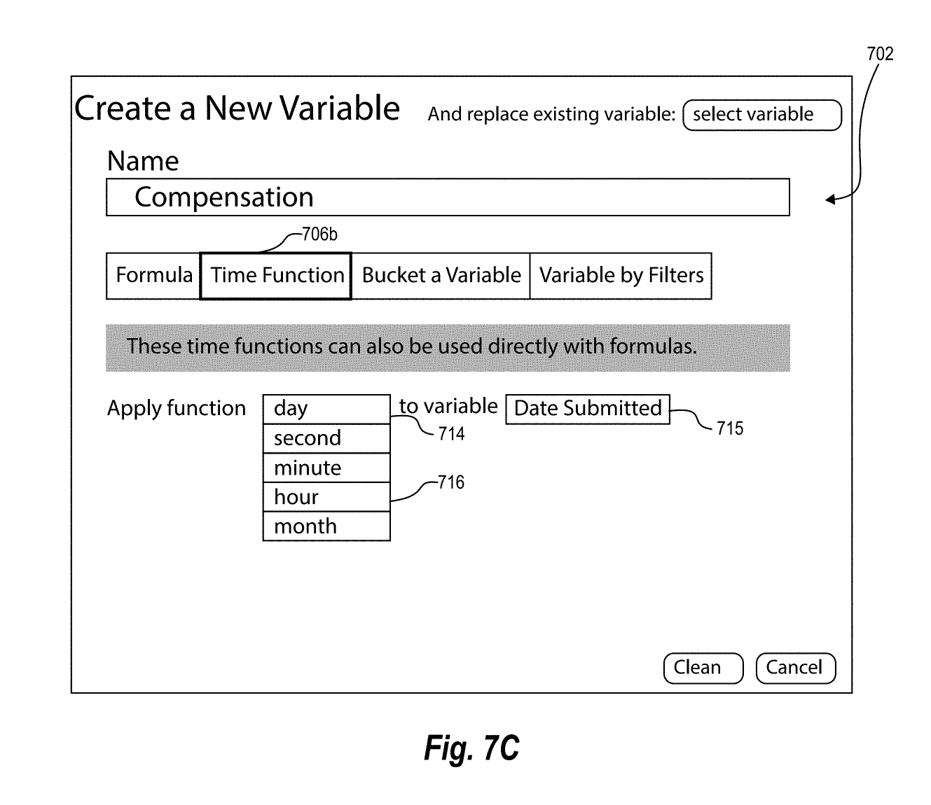

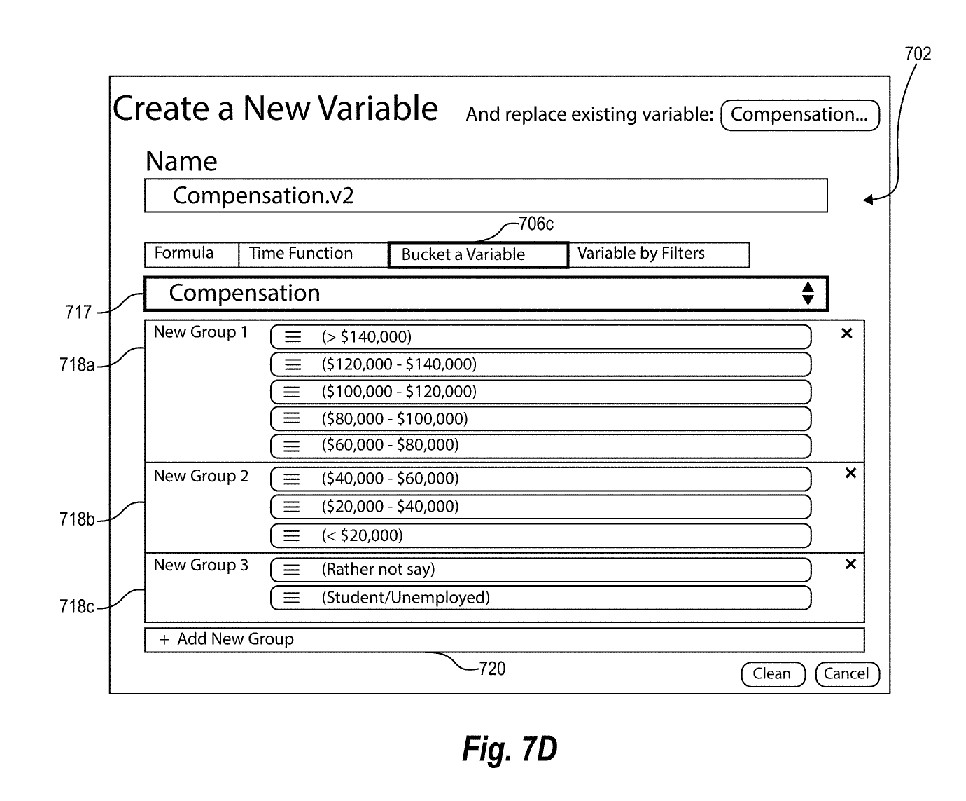

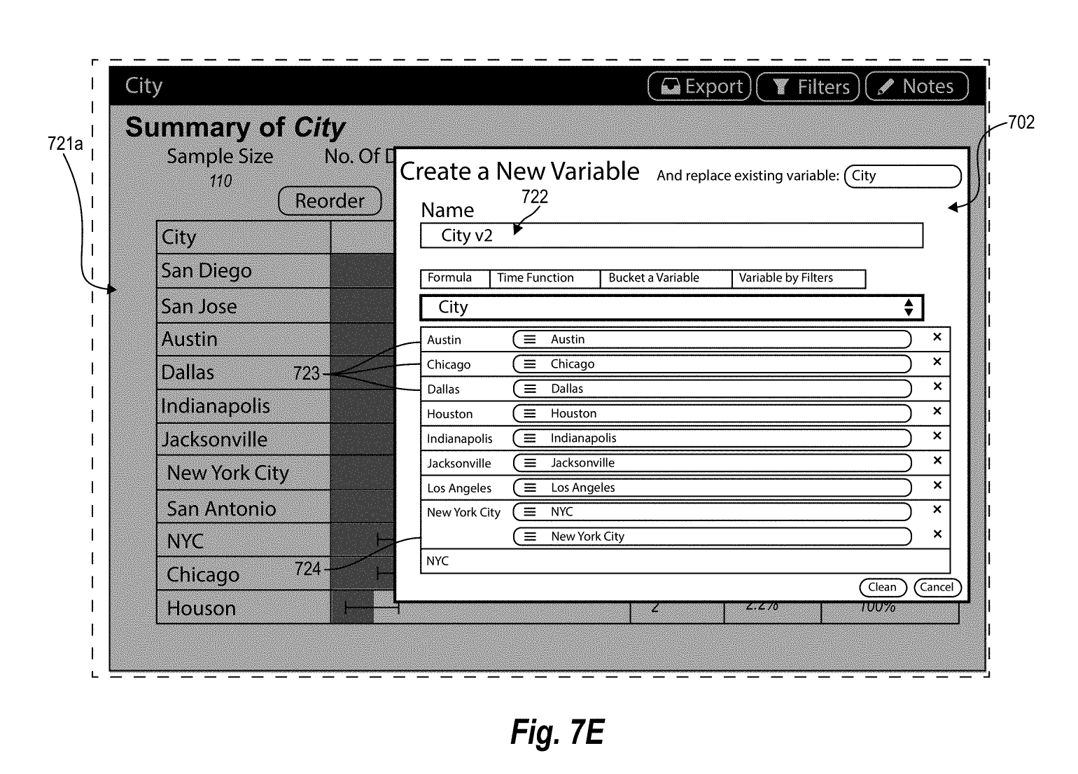

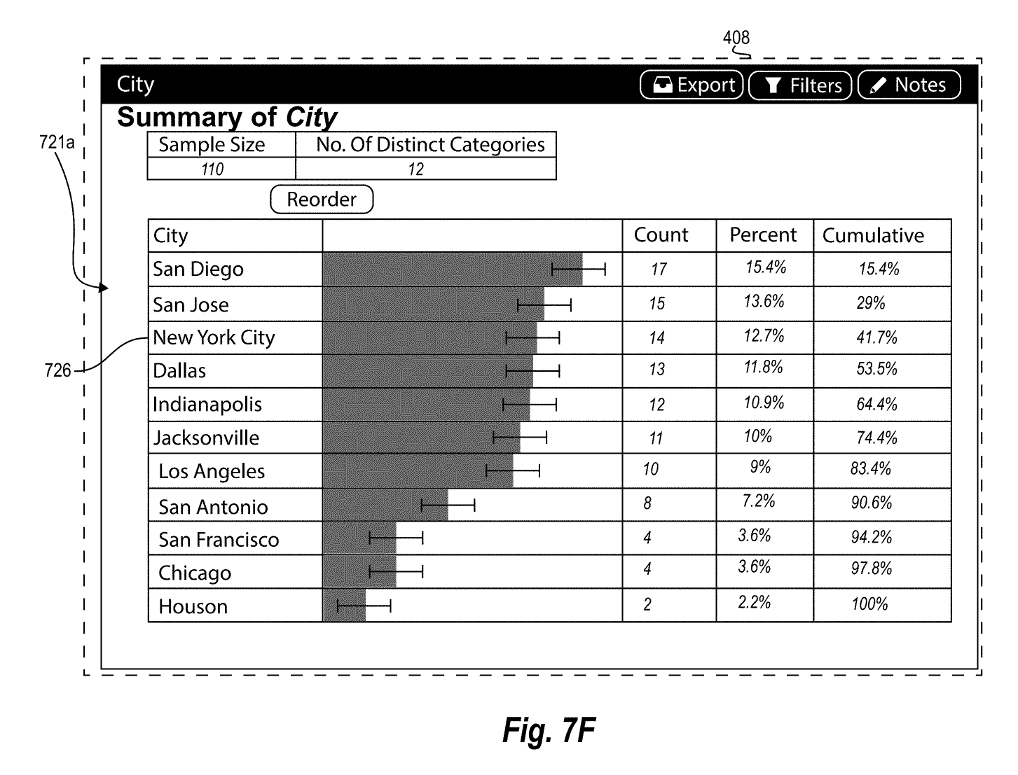

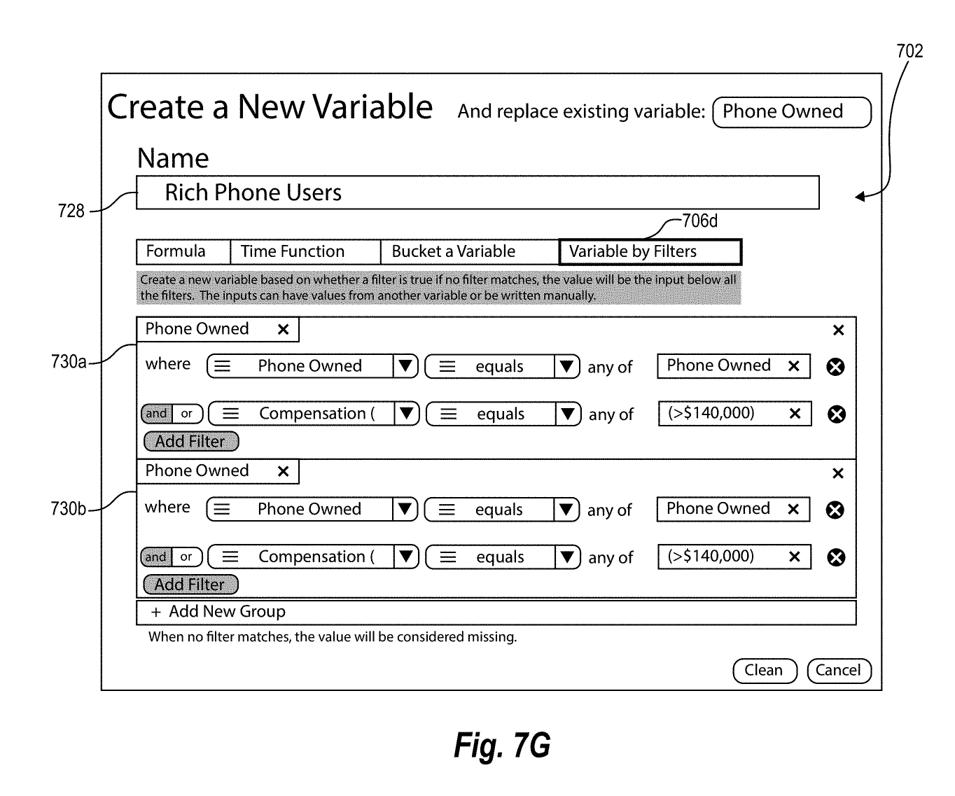

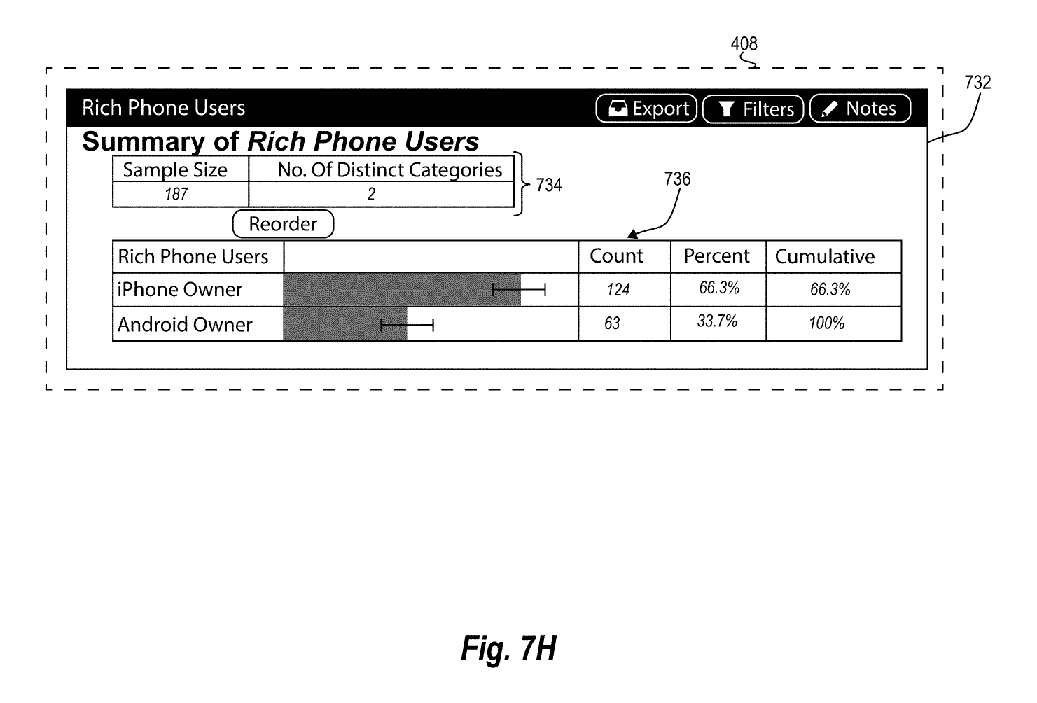

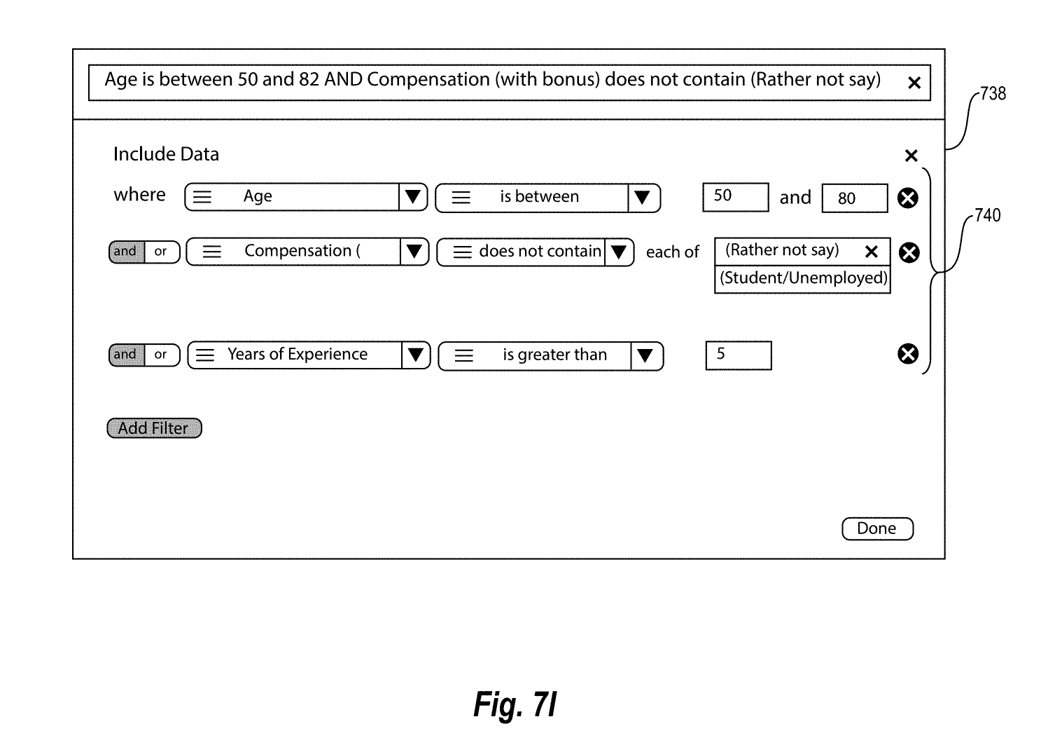

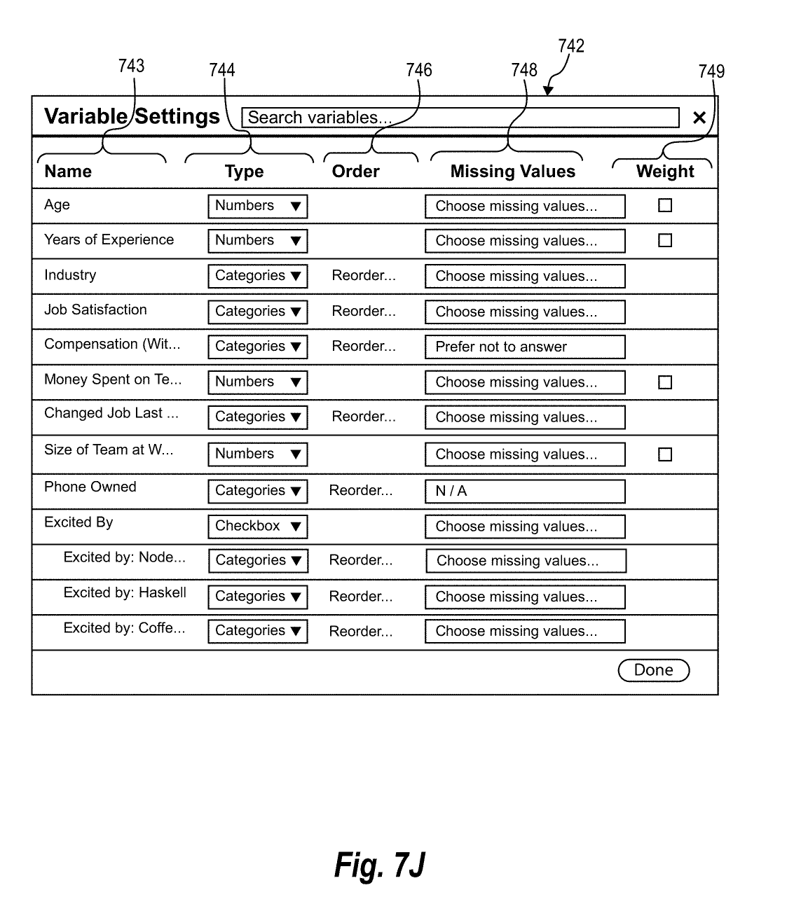

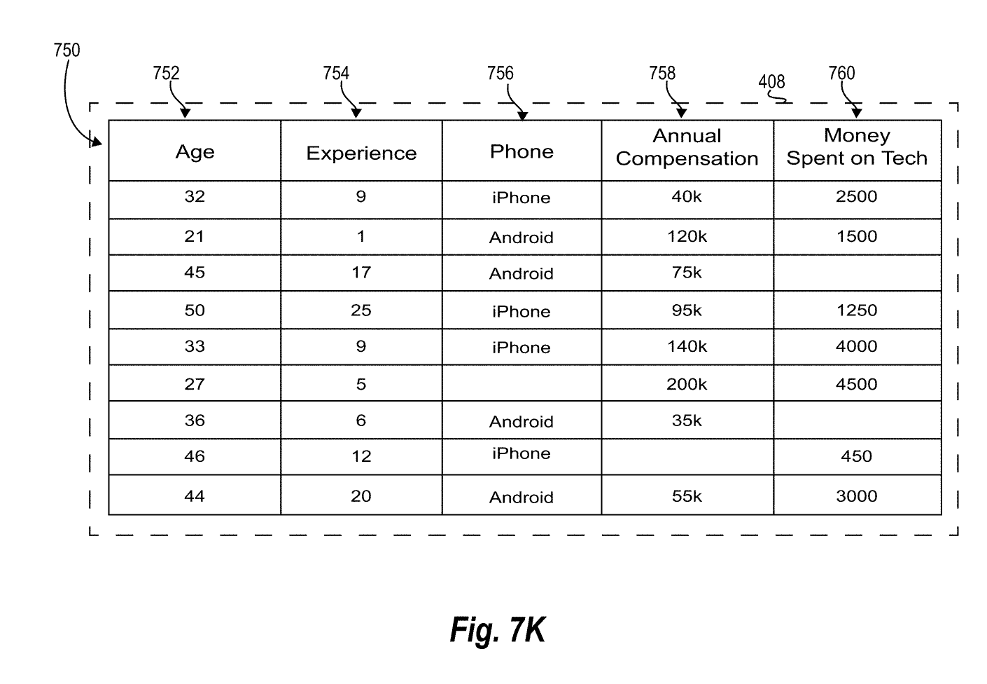

In addition to generating and presenting description cards that describe selected datasets of the survey information, the survey analysis system 104 can further facilitate creation of new datasets and/or modification of existing datasets from the survey information. In particular, in one or more embodiments, the survey analysis system 104 creates new datasets including data from existing datasets in addition to altering existing datasets in accordance with one or more user preferences. More specifically, in one or more embodiments, the survey analysis system 104 facilitates modifying the survey information in accordance with one or more user inputs. In this way, the survey analysis system 104 further prepares the survey information in accordance with one or more user inputs. Example features and functionality with regard to preparing the survey information for analysis by creating new datasets and/or modifying existing datasets of the survey information is described in further detail below in connection with FIGS. 7A-7K.

For example, as will be described in connection with FIG. 7A-7K, in one or more embodiments, the survey analysis system 104 provides one or more interfaces that facilitate modification of an existing dataset and/or creation of a new dataset. For example, as described above in connection with FIG. 5, the presentation menu 504 includes a clean/create button 522. In response to detecting a selection of the clean/create button 522, the survey analysis system 104 provides a new variable interface 702, as shown in FIG. 7A. As will be described in further detail below, the new variable interface 702 provides various menus including selectable options that enable a user of the client device 401 to modify existing datasets of the survey information and/or create new datasets from the survey information.

In one or more embodiments, an administrative user 112 may wish to prepare received survey information for further analysis by cleaning or otherwise fine-tuning received survey information to have a particular format and/or eliminate various informalities that could potentially disrupt analysis of the received survey information. For example, as will be described in further detail below, an administrative user 112 may wish to eliminate outliers, re-order variables, modify specific grouping of datasets, merge separate datasets that represent similar or identical information, create filtered datasets, or otherwise modify datasets of the survey information in preparation for effective analysis of the received survey information. As described by way of example in further detail below, the survey analysis system 104 provides features and functionality to modify existing datasets and/or create new datasets in accordance with selected options provided via one or more user interfaces.

As shown in FIG. 7A, the survey analysis system 104 provides the new variable interface 702 based on a user selection of the clean/create button 522 (shown in FIG. 5). As further shown in FIG. 7A, the new variable interface 702 includes a replace variable field 704 that enables the user of the client device 401 to specify an existing dataset to replace with a new variable. In addition, the new variable interface 702 includes a new variable field 705 that enables the user of the client device 401 to identify a new variable to create. Thus, the survey analysis system 104 facilitates replacement of a currently existing dataset and/or generation of a new dataset.

As further shown, the new variable interface 702 includes a number of tabs 706a-d corresponding to different options for creating a new dataset and/or modifying an existing dataset. For example, as shown in FIG. 7A, the new variable interface 702 includes a formula tab 706a, a time functions tab 706b, a bucket variable tab 706c, and a variable by filters tab 706d. As will be described in further detail below, each of the tabs correspond to a menu of options for modifying (e.g., cleaning) a dataset and/or generating a new variable from data contained within the survey information. For example, in response to detecting a user selection of one of the tabs 706a-d, the survey analysis system 104 provides a corresponding menu of selectable options that facilitate preparing the survey information for analysis by modifying the datasets and/or creating new datasets.

For instance, and to illustrate, in response to detecting a user selection of the formula tab 706a, the survey analysis system 104 provides a formula menu including a formula field 708 and variable fields 710. In particular, the formula field 708 includes a formula comprising one or more variables that define a new or modified dataset. In addition, the variable fields 710 define individual variables that make up the formula shown in the formula field 708.

As shown in FIG. 7A, the variables of the variable fields 710 can refer to datapoints from any of the defined datasets that make up the survey information. In particular, as shown in FIG. 7A, the survey analysis system 104 enables a user to select a specific dataset to define as one of the variables. For example, in response to detecting a selection of the x-value of the variable field, the survey analysis system 104 provides a dropdown menu including a number of the datasets having a data-type that qualifies for the x-value of the formula.

As shown in FIG. 7A, the list 712 of possible datasets for the x-value of the formula includes only a portion of the datasets of the survey information. In particular, the list 712 includes variables corresponding to possible datasets of the survey information having numeric values. In one or more embodiments, depending on the variables that define the formula, the survey analysis system 104 provides a listing of only those variables that correspond to datasets having a compatible data-type. As an example, where a formula includes a variable that requires a numeric value, the survey analysis system 104 may only provide a listing of subsets having a numeric or binary data-type while excluding datasets of categorical (and other non-numeric) data-types.

As mentioned above, the survey analysis system 104 can create a new dataset based on the formula within the formula field 708. In one or more embodiments, the survey analysis system 104 creates a new dataset based on the formula including the ‘x’ and ‘y’ values defined within the variable fields 710. As further shown in FIG. 7B, the survey analysis system 104 provides a new variable tab 406m to the variable menu 404. Alternatively, where the user selects an option to replace an existing dataset with the new or modified dataset, the survey analysis system 104 can remove or otherwise replace an existing tab of the variable menu 404 to correspond to the new or modified dataset. In one or more embodiments, the survey analysis system 104 provides an indicator or sub-tab that enables a user to retrieve data from the original dataset (e.g., rather than discarding the data from the original dataset).

As mentioned above, the new variable interface 702 includes a time functions tab 706b that facilitates preparing date-based data for analysis (shown in FIG. 7A). For example, as further illustrated in FIG. 7C, in response to detecting a selection of the time functions tab 706b, the survey analysis system 104 provides a time functions menu including one or more selectable options that facilitates modification of one or more datasets having date-based data. For example, where the date-submitted dataset refers to dates on which electronic information was received (e.g., dates on which respondents respondent to electronic survey questions), the survey analysis system 104 may provide selectable options that enable a user to modify one or more aspects of the date-based data of the date-submitted dataset. For example, as shown in FIG. 7C, the time function menu includes a time period field 714 referring to an increment of time (e.g., second, minute, hour, day, month) and a variable field 715 referring to a variable corresponding to a date-based dataset of the survey information.

In one or more embodiments, the survey analysis system 104 modifies the associated dataset to include data points based on the selected time interval. For example, where a default value refers to the day that the survey analysis system 104 receives a set of responses to the electronic survey, the original date-submitted dataset includes a value corresponding to a day of a timestamp. As another example, in response to detecting a change of the time period field 714 from the day interval to a month interval, the survey analysis system 104 generates a new dataset (or modifies the existing dataset) for the date-submitted variable that includes datapoints corresponding to a month that the survey analysis system 104 received the survey responses. Thus, the resulting dataset having the month time-interval would have fewer datapoints corresponding only to a given month that the survey analysis system 104 received electronic survey responses rather than including datapoints for each day on which the survey analysis system 104 received an electronic survey response.

As mentioned above, the new variable interface 702 includes a bucket variable tab 706c (shown in FIG. 7A) that facilitates grouping datapoints of a dataset into respective groups. For example, in response to detecting a user selection of the bucket variable tab 706c, the survey analysis system 104 provides a bucket variable menu including a variable field 717. In one or more embodiments, a user can select a variable to bucket (e.g., group datapoints of a dataset into one or more categories) by identifying a particular dataset within the variable field 717. For example, as shown in FIG. 7D, the variable field 717 includes an identification of the compensation dataset.

In addition, as shown in FIG. 7D, the bucket variable menu includes a number of groups 718a-c corresponding to grouping of compensation values. In particular, a user of the client device 401 may wish to group datapoints of the compensation dataset into specific groups. More specifically, where the compensation dataset includes ten possible datapoints, the user may wish to group the ten different datapoints into three distinct groups (or buckets). For example, as shown in FIG. 7D, the first group 718a includes each identified category (e.g., compensation range) of compensations ranging from $60,000 and up. As further shown, the second group 718b includes each compensation category below $60,000. In addition, the third group 718c includes categories of respondents who selected “Rather not say” and “Student/Unemployed.” As shown in FIG. 7D, the survey analysis system 104 further enables a user to select an “add group” icon 720 to generate a new group or bucket.

In one or more embodiments, the survey analysis system 104 enables a user to select one or more discrete categories and move the categories between the groups. For example, where the user wants to move one of the categories of datapoints from the first group 718a to the second group 718b, the user can simply select one of the icons representing a particular category and drag the icon from the first group 718a to the second group 718b. In response, the survey analysis system 104 changes an association of datapoints corresponding to the moved icon from the first group 718a to the second group 718b.

In addition to grouping the datasets into respective buckets, the bucket variable menu further enables a user of the client device 401 to re-order one or more of the variables as presented within the workspace 408. For example, in addition to enabling the user to select and move icons of the different categories between groups, the survey analysis system 104 further enables a user to re-order the variables within the same or different groups. For example, where extracting the raw data from the survey information initially places the variables out of order (e.g., in alphabetical rather than numeric order), the survey analysis system 104 may re-order the categories in accordance with user input placing the variables of the dataset in a different order than the default. Thus, where the user subsequently selects the describe button 502 described above in conjunction with the re-ordered dataset, the survey analysis system 104 may present information about the selected dataset in accordance with a modified order of the variables based on user interactions re-ordering the different categories.

As another example of re-ordering and/or grouping variables, FIG. 7E shows a graphical user interface in which a survey analysis system 104 modifies a dataset including datapoints of different cities. In particular, as shown in FIG. 7E, the graphical user interface 402 includes a city description card 721a including a summary and visualization of a dataset including different cities including, for example, San Diego, San Jose, Austin, Dallas, etc. As further shown, the survey analysis system 104 orders the listing cities in the chart within the city description card 721a by a count or percentage of the cities within the dataset.

As further shown in FIG. 7E, the listing of cities includes both “NYC” and “New York City.” While both of these datasets represent of the same city, the survey analysis system 104 may fail to recognize this similarity when collecting the survey information that includes this dataset. As a result, the survey analysis system 104 may treat “NYC” and “New York City” as different values within the same dataset. Accordingly, when generating the city description card 721a, the survey analysis system 104 provides separate datapoints for each of “NYC” and “New York City.”

In one or more embodiments, the survey analysis system 104 facilitates correction of incorrectly grouped datapoints using one or more bucketing or grouping featured described above. For example, as described above, a user may select the clean/create button 522 and the bucket variable tab 706c. In response, the survey analysis system 104 provides the bucket interface 722 including respective groups 723 containing one or more cities (e.g., represented by city icons). As shown in FIG. 7E, the user of the client device 401 can select the “NYC” and move the icon from the NYC category to the New York City category. As a result, the NYC category includes zero icons. Accordingly, the survey analysis system 104 can delete or remove an empty group.

In response to the re-grouping of icons into the New York City group 724, the survey analysis system 104 can replace any datapoints having the NYC category to the New York City category. In addition, as shown in FIG. 7F, the survey analysis system 104 modifies the city description card 721a by removing the NYC category and providing the New York City category within the visualization of the city dataset. In addition, as shown in FIG. 7F, the survey analysis system 104 re-orders the variables to include the modified New York City category 726 in accordance with the combined count of the NYC and New York City values of the original dataset.

As mentioned above, the new variable interface 702 includes a variable by filters tab 706d (shown in FIG. 7A) that facilitates replacing an existing dataset and/or creating a new dataset in accordance with one or more filters. For example, as shown in FIG. 7G, in response to detecting a selection of the variable by filters tab 706d, the survey analysis system 104 provides a variable filter interface including a new variable field 728 and one or more user-defined filters 730a-b.

For example, as shown in FIG. 7G, the survey analysis system 104 creates a “Rich Phone Users” filter to determine a proportion of respondents having a greater compensation than $140,000 that own an iPhone or Android phone. Accordingly, the user of the client device 401 can create a first user-defined filter 730a that includes those values of the phone owned dataset equal to “Android Owner” that also correspond to respondents that listed a compensation of greater than $140,000. In addition, the user of the client device 401 can create a second user-defined filter 730b that includes those values of the phone owned dataset equal to “iPhone Owner” that similarly correspond to respondents that listed a compensation of greater than $140,000.

As a result of the user defined filters 730a-b, the survey analysis system 104 creates a new dataset titled “Rich Phone Users” including a first set of datapoints corresponding to instances of the survey information where a respondent indicated that they own an Android phone and receive a compensation of more than $140,000/year. In addition, the new dataset includes a second set of datapoints corresponding to instances of the survey information where a respondent indicated that they own an iPhone and receive a compensation of more than $140,000/year.

After creating the new dataset for “Rich Phone Users,” the survey analysis system 104 facilitates presenting a description and/or visualization as described herein with regard to the new dataset. For example, as shown in FIG. 7H, in response to detecting a selection of the describe button 506 while the new variable tab 406m is selected, the survey analysis system 104 generates a rich phone user description card 732 including a summary 734 of the rich phone user dataset and a chart 736 showing a comparison between counts of respondents represented by the filtered survey information. In particular, as shown in FIG. 7H, the number of respondents to the electronic survey having an iPhone while earning $140,000 nearly doubles the number of respondents to the electronic survey having an Android phone while earning a similar amount.

In one or more embodiments, the survey analysis system 104 further facilitates generating a filtered dataset based on one or more filters applied to an existing dataset. For example, as shown in FIG. 7I, in response to detecting a user selection of the import filter sets button 516 described above in connection with FIG. 5, the survey analysis system 104 provides a filter interface 738 to be applied to the workspace 408 and/or one or more cards of the workspace 408. In particular, similar to one or more embodiments described above with regard to applying filters or otherwise modifying a presentation of data, the filter interface 738 includes a plurality of filter fields 740 that enable a user of the client device 401 to select limitations to apply to survey information.

For example, as shown in FIG. 7I, the survey analysis system 104 provides a filter interface 738 including filter fields 740 that define a new age dataset limited to a particular range of ages and further based on a number of limiting variables included within the filter fields 740. In particular, as shown in FIG. 7I, the filter fields 740 define a new age variable defined by a first age filter that limits the original age dataset to datapoints corresponding to ages between 50 and 82 (e.g., the maximum age of the age dataset). As further shown, the filter fields 740 exclude respondents that listed their compensation as “rather not say” and “student/unemployed.” Further, the filter fields 740 further limit the new age dataset to respondents having greater than five years of experience. As such, the new age variable includes datapoints from respondents between the ages of 50-82 having greater than five years of experience and excluding respondents whose compensation were listed as “rather not say” and “student/unemployed.”

As shown in FIG. 7I, a user may add or remove any number of the filters from the filter interface 738. Thus a user may narrow or broaden the range of survey information defined by the new variable. When the user has finished adding and/or modifying the filter fields 740, the survey analysis system 104 generates a new dataset including survey information defined by the filters.

In addition, in one or more embodiments, the survey analysis system 104 provides an interface that provides one or more options to modify, clean, filter, or otherwise prepare the survey information. In particular, in one or more embodiments, in response to detecting a user selection of the settings button 518 described above in connection with FIG. 5, the survey analysis system 104 provides the variable settings interface 742 shown in FIG. 7J. As shown in FIG. 7J, the variable settings interface 742 includes a chart of variables and corresponding information associated with each defined dataset of the survey information. In particular, as shown in FIG. 7J, each row associated with a variable in the first column corresponds to a respective dataset from the survey information.

For example, as shown in FIG. 7J, the variable settings interface 742 includes a chart of columns and rows including information about datasets of the survey information. For example, the variable settings interface 742 includes a first column 743 including variables of each dataset (e.g., corresponding to the tabs 406a-1). In particular, as shown in FIG. 7J, the first column 743 of variables corresponds to the variable tabs 406a-1 described above. In one or more embodiments, the first column 743 includes one or more new variables and/or modified variables generated in response to one or more user inputs described herein. Thus, in one or more embodiments, first column 743 includes a variable for all original datasets (e.g., prior to modification and/or creation of new datasets) in addition to any modified and/or new datasets. Accordingly, the chart shown in FIG. 7J includes a row for each respective dataset including all original datasets as well as any new and/or modified datasets.

As further shown, the variable settings interface 742 includes a second column 744 having identified data-types for each of the datasets. For example, as shown in FIG. 7J, the second column 744 includes an identification of each dataset as either numbers or categories. The second column 744 can include other data-types (e.g., binary, textual) for respective datasets. In addition, in one or more embodiments, the survey analysis system 104 enables a user to select a different data-type for a particular dataset. For example, in response to detecting a user selection of a data-type for a specific dataset, the survey analysis system 104 changes the data-type. After changing the data-type, the survey analysis system 104 may further perform one or more additional modifications described herein (e.g., bucketing categories, filtering datasets, etc.) in preparation for performing one or more statistical tests on the survey information.

As further shown in FIG. 7J, the variable settings interface 742 includes a third column 746 including a selectable reorder option for one or more datasets to reorder values of the dataset. In particular, as shown in FIG. 7J, the third column 746 includes a selectable reorder option for each of the variables corresponding to categorical datasets. Conversely, the third column 746 does not include selectable reorder options for the variables corresponding to the numerical datasets (and are therefore already ordered in accordance with their numeric values). In one or more embodiments, the variable settings interface 742 includes reorder options based on the data-type for the corresponding dataset.

In one or more embodiments, the survey analysis system 104 enables a user to manually reorder values of a dataset in response to detecting a selection of a selectable reorder option for a particular dataset. For example, in one or more embodiments, in response to detecting a selection of a selectable reorder option, the survey analysis system 104 presents a reorder interface including selectable icons for each value of the dataset (e.g., similar to the interface described above in connection with FIG. 7D). In addition, the survey analysis system 104 enables the user to select and manually reorder one or more of the values within the dataset. In this way, the survey analysis system 104 enables a user to reorder values of a particular variable based on any number of preferences (e.g., alphabetical, level of satisfaction).

In addition, as shown in FIG. 7J, the chart includes a fourth column 748 including one or more missing values. In particular, the missing value(s) indicate one or more values of a particular dataset that the survey analysis system 104 ignores when presenting and/or analyzing a particular dataset. For example, as shown in FIG. 7J, the compensation dataset ignores or otherwise discards “prefer not to answer” responses to the electronic survey. In addition, as shown in FIG. 7J, the phone owned dataset ignores or otherwise discards “N/A” responses. Thus, the survey analysis system 104 treats values indicated within the missing value fields as empty cells or zero values.

As further shown in FIG. 7J, the chart includes a fifth column 749 including one or more selectable weight options. In one or more embodiments, the survey analysis system 104 weights one or more datasets to avoid over- or under-sampling a population of respondents. For example, where the survey analysis system 104 determines that a population of respondents over-samples or under-samples the general population, the survey analysis system 104 enables the user to weight a particular variable to ensure that the survey information represents the population accurately. As shown in FIG. 7J, the survey analysis system 104 provides the weight selectable option for the numeric datasets and not for the categorical datasets. Accordingly, in one or more embodiments, the survey analysis system 104 provides the selectable weight variable based on a data-type of the corresponding dataset.

As described above, the survey analysis system 104 facilitates preparing the survey information for analysis in a variety of ways. For example, in one or more embodiments, the survey analysis system 104 prepares the survey information upon receiving responses to the electronic survey questions. In addition, as described above in connection with FIGS. 7A-7J, the survey analysis system 104 receives any number of user inputs to modify existing datasets and/or create new datasets including discrete portions of the survey information in a modified format better prepared for analysis.

In one or more embodiments, the survey analysis system 104 modifies the survey information stored on the server device 102. As an example, with regard to the survey information table 302 described above in connection with FIG. 3, in one or more embodiments, the survey analysis system 104 modifies the cells within the survey information table 302 in response to various user inputs to generate a modified (or cleaned-up) survey information table 750 including modified values. In particular, as shown in FIG. 7K, the survey analysis system 104 generates a modified survey information table 750 including one or more removed values, one or more modified values, and further including metadata (e.g., new or modified metadata) that identifies data-types of respective datasets.

For example, as shown in FIG. 7K, the modified survey information table 750 includes a first column 752 including an age dataset of numerical values representative of ages of the respondents. As shown in FIG. 7K, and similar to the survey information table 302 shown in FIG. 3, the first column 752 remains largely unaltered from the numeric values shown in the corresponding column of the survey information table 302.

While not shown in FIG. 7K, in one or more embodiments, the survey analysis system 104 generates one or more additional age columns representative of a filtered or modified age dataset. For example, where the user of the client device 401 changes a data-type, implements a filter, or otherwise modifies the age dataset, the survey analysis system 104 may generate a new column within the modified survey information table 750 including any and all datapoints of the modified or filtered dataset. In addition, the survey analysis system 104 can add any number of columns corresponding to any new or modified datasets. In addition, in one or more embodiments, the survey analysis system 104 removes one or more columns for replacement of a new or modified dataset.

As further shown in FIG. 7K, the modified survey information table 750 includes a second column 754 including a modified years of experience dataset. For example, in contrast to the corresponding column of the survey information table 302 shown in FIG. 3, the modified survey information table 750 includes a modified experience dataset in which one or more values have been modified and where the values have been re-categorized as a numerical data-type. In particular, where the second column 304b of the survey information table 302 includes one or more textual responses (e.g., “12 years”), the survey analysis system 104 has modified one or more datapoints of the experience dataset to produce a dataset of exclusively numeric values. For example, in one or more embodiments, the survey analysis system 104 cleans the experience dataset by removing any non-numeric values from the survey information table. Alternatively, in one or more embodiments, the survey analysis system 104 extracts the numeric information (e.g., automatically or in response to user input described herein) to produce the modified experience dataset shown in FIG. 7K.

As further shown in FIG. 7K, the modified survey information table 750 includes a third column 756 including a modified phone owned dataset. For example, in contrast to the corresponding column of the survey information table 302 shown in FIG. 3, the modified survey information table 750 includes a modified phone owned dataset in which “N/A” values have been removed. In particular, in response to detecting a modification of one or more variable settings (e.g., one or more missing values as shown in FIG. 7J), the survey analysis system 104 removes all “N/A” datapoints and any other specified values that the user of the client device 401 desires to remove from the phone owned dataset in preparation for analysis. Thus, as shown in FIG. 7K, the modified survey information table includes one or more empty cells in place of one or more “N/A” values (or other designated missing values).

In addition, in one or more embodiments, the survey analysis system 104 re-categorizes the phone owned dataset in response to modifying the phone owned dataset to include only two values (e.g., iPhone or Android). For example, in response to removing, ignoring, or otherwise discarding all values other than iPhone and Android, the survey analysis system 104 may re-categorize the phone owned dataset as a binary data-type by adding metadata or otherwise assigning the binary data-type to the phone owned dataset. In one or more embodiments, the survey analysis system 104 re-categorizes the dataset by generating and associating metadata to the phone owned dataset. In addition, in one or more embodiments, the survey analysis system 104 generates and appends a new column of the modified survey information table 750 including a new binary data-type phone owned dataset.

As further shown in FIG. 7K, the modified survey information table 750 includes a fourth column 758 including a modified compensation dataset. For example, in contrast to the corresponding column of the survey information table 302 shown in FIG. 3, the modified survey information table 750 includes a modified compensation dataset in which any answers outside of one or more specified categories have been removed. For example, as shown in FIG. 7K, in contrast to the corresponding column of the survey information table 302, the fourth column 758 includes categories of compensation values excluding “prefer not to answer” values included within the original compensation dataset. In one or more embodiments, the survey analysis system 104 excludes the “prefer not to answer” values from the compensation dataset based on one or more designated missing values as shown in the variable settings interface 742 described above in connection with FIG. 7J. In one or more embodiments, the survey analysis system 104 excludes other values specified in the variable settings interface 742.

As also illustrated in FIG. 7K, the modified survey information table 750 includes a fifth column 760 including a modified money spent on tech purchases dataset. For example, in contrast to the corresponding column of the survey information table 302 shown in FIG. 3, the modified survey information table 750 includes a modified money spent on tech purchases dataset in which “Don't Know” answer have been removed. As such, the modified survey information table 750 includes a modified money spent on tech purchases dataset including one or more empty cells.

Thus, as described above, in one or more embodiments, the survey analysis system 104 prepares the survey information for analysis by modifying respective datasets and/or adding additional datasets as described herein. In one or more embodiments, the survey analysis system 104 modifies the respective datasets based on received user input to create one or more filters, re-ordering variables, bucketing variables, removing specific values, re-categorizing data-types, and/or performing other operations with respect to the survey information in accordance with received user inputs. In addition, in one or more embodiments, the survey analysis system 104 adds one or more new datasets or replacement datasets for one or more original datasets of the survey information.

In addition, in one or more embodiments, as an alternative to preparing the survey information for analysis in accordance with one or more user inputs (e.g., as described in connection with FIGS. 7A-7J), the survey analysis system 104 can modify existing datasets and/or generate one or more new datasets upon initially receiving the survey information in accordance with one or more learned preferences. For instance, in one or more embodiments, the survey analysis system 104 cleans or otherwise prepares one or more datasets for analysis based on learned behavior. As a first example, where a user routinely removes “N/A” values from the phone owned dataset, the survey analysis system 104 may automatically remove “N/A” values from similar datasets in the future. As another example, where the user re-designates the experience dataset from categorical (or textual) to numeric via number extraction and/or removing non-numeric values, the survey analysis system 104 may automatically extract numerical data and/or designate similar datasets as numeric in the future. Thus, even where the survey analysis system 104 prepares a portion of the survey information for analysis in accordance with user input, in one or more embodiments, the survey analysis system 104 may automatically prepare (e.g., without receiving user input with respect to subsequently received survey information) subsequently received survey information in accordance with previously received user inputs.

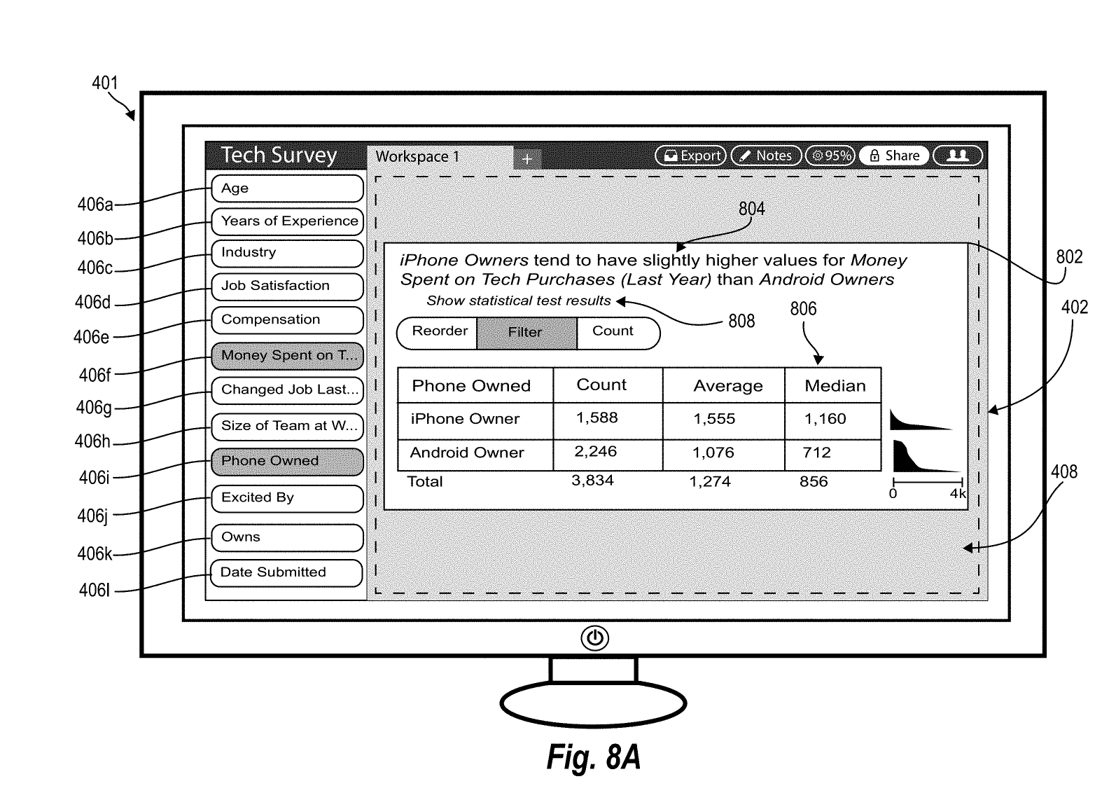

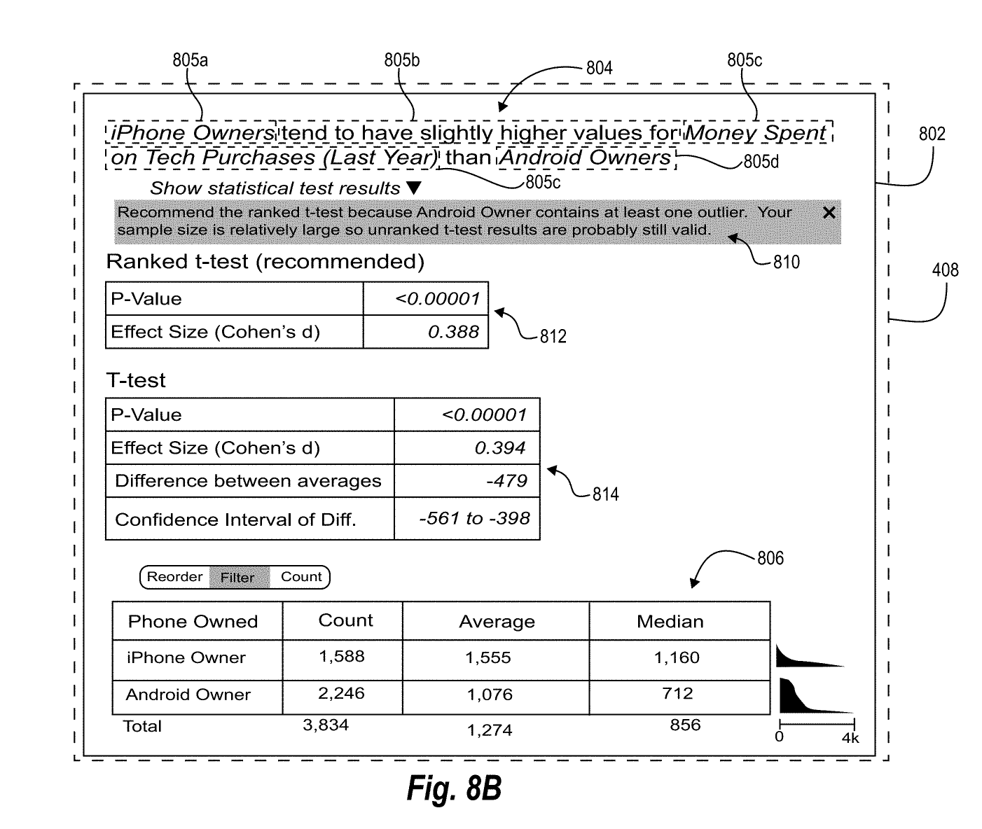

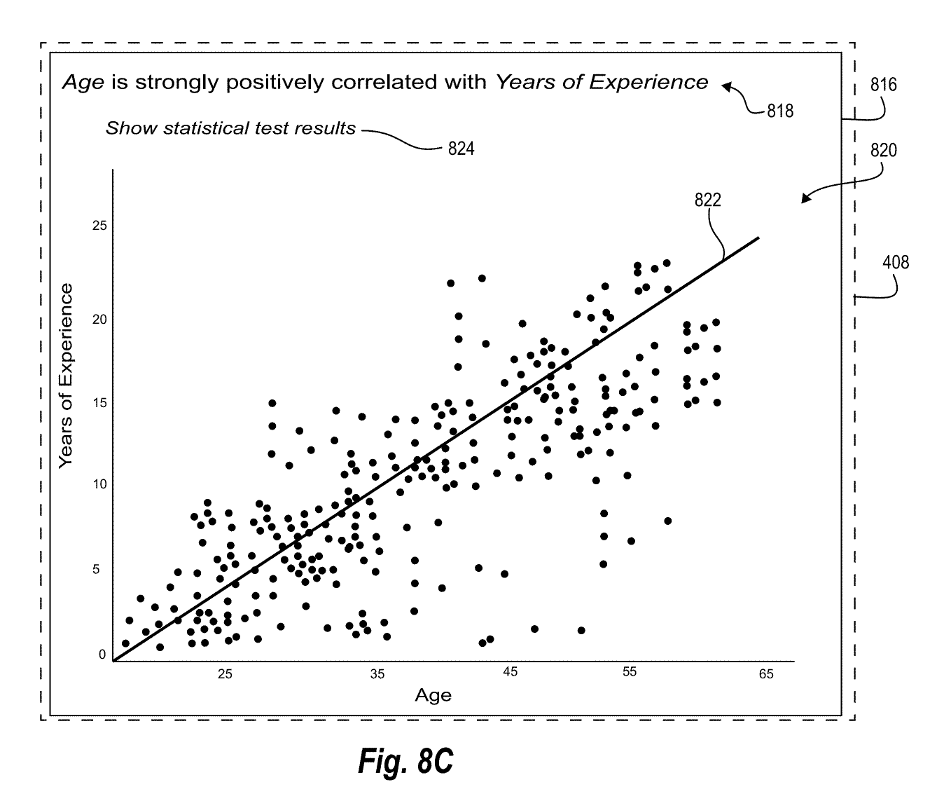

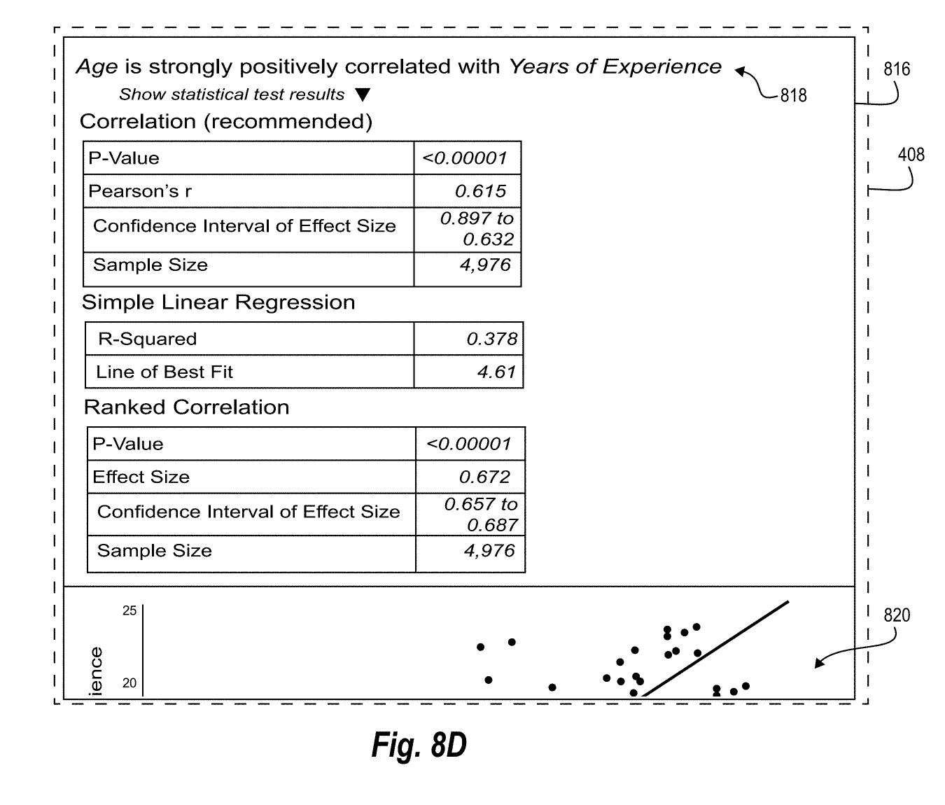

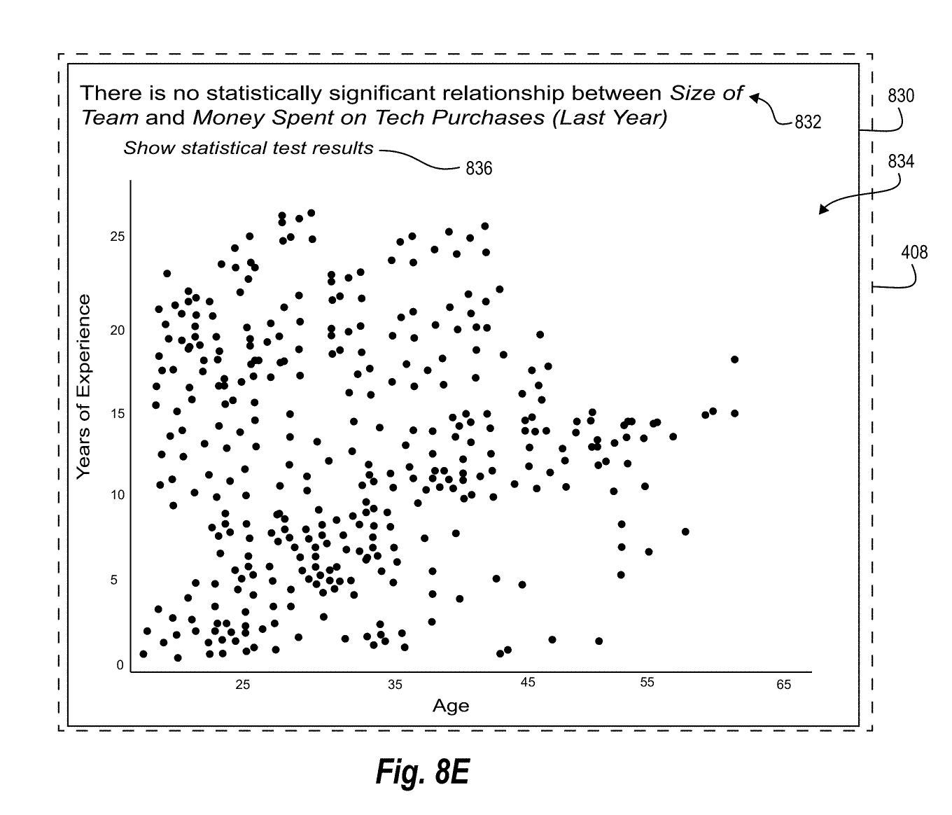

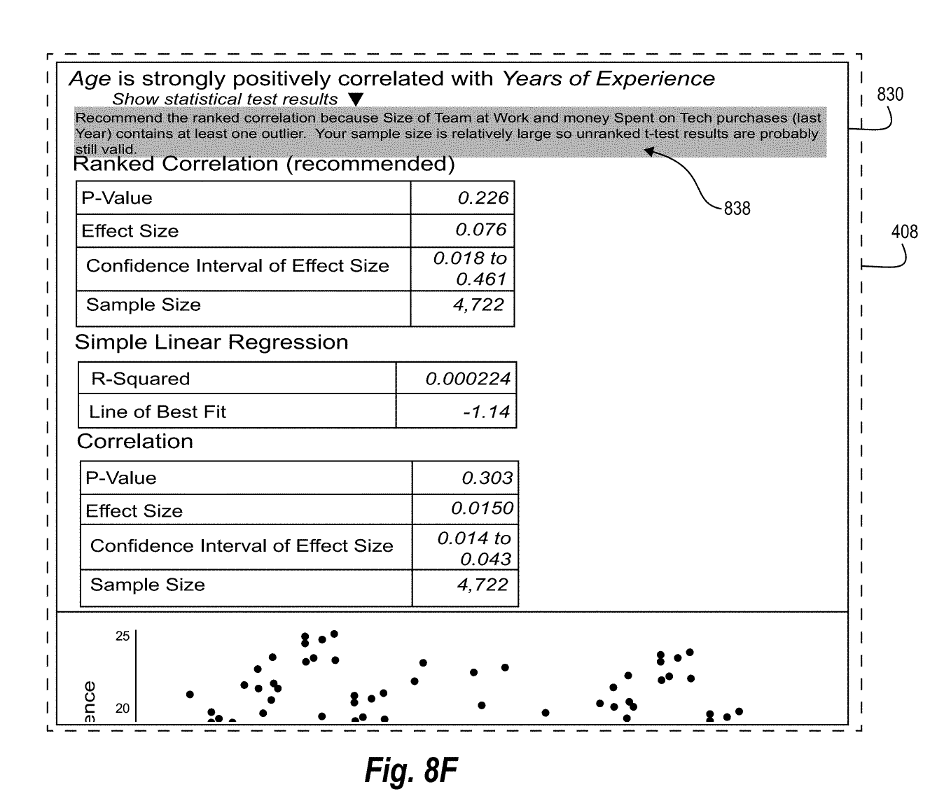

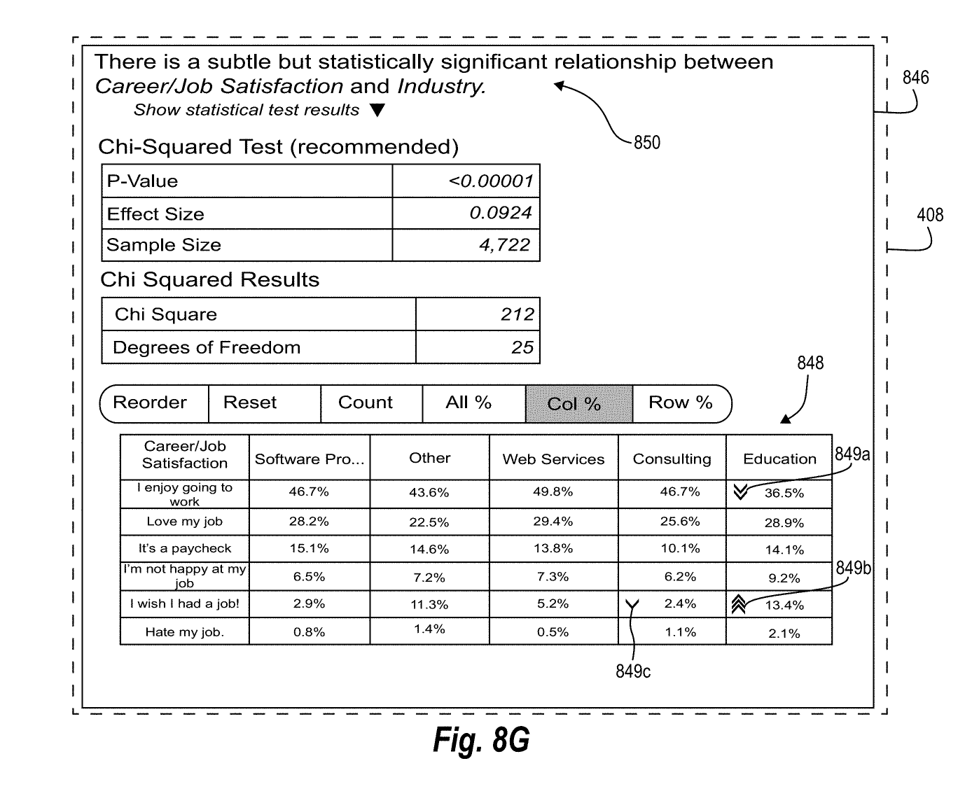

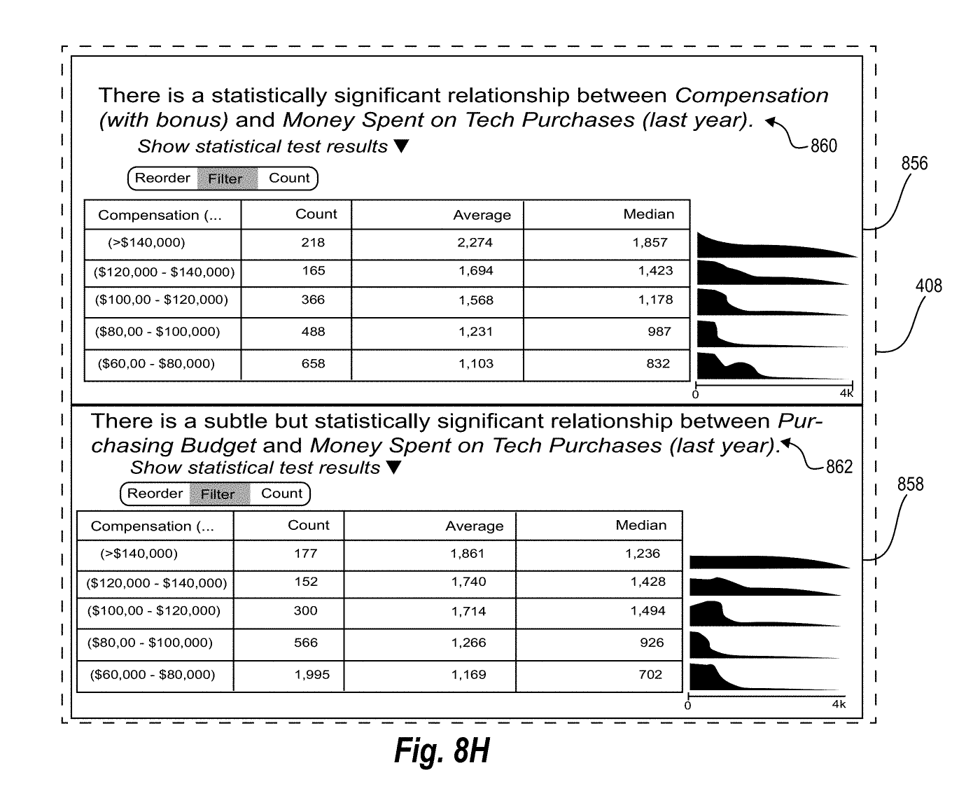

In addition to preparing the survey information for analysis, in one or more embodiments, the survey analysis system 104 further performs one or more statistical tests on the survey information (e.g., the modified or otherwise prepared survey information) to determine a statistical result of the survey information. As mentioned above, in one or more embodiments, the survey analysis system 104 performs a statistical test on one or more discrete portions (e.g., datasets) of the survey information to draw a conclusion from the survey information. For example, as will be described in further detail below in connection with FIGS. 8A-11B, the survey analysis system 104 can perform one or more statistical tests on one or multiple datasets of the survey information to determine a statistical result.

In addition, as will be described in further detail below in connection with FIGS. 8A-11B, the survey analysis system generates a plain text description of the statistical test and provides a presentation of statistical results of the statistical test including the plain text description via the client device 401. In particular, as will be discussed by way of example with regard to FIGS. 8A-11B, the survey analysis system 104 can generate a presentation one or more statistical results within the workspace 408 including the plain text description of the statistical result in addition to information about the statistical test(s) performed on the survey information to obtain the statistical result.

For example, FIG. 8A shows an example graphical user interface 402 provided by a client device 401 including features described above in connection with FIGS. 4A-7K. In particular, as shown in FIG. 8A, the graphical user interface 402 includes tabs 406a-1 corresponding to discrete datasets of the survey information. In addition, as shown in FIG. 8A, the graphical user interface 402 includes a presentation menu 504 including various selectable options that cause the survey analysis system 104 to present various information within the workspace 408. Furthermore, as shown in FIG. 8A, the graphical user interface 402 includes a workspace 408 having any number of cards therein. As shown in FIG. 8A, the workspace 408 includes a variable relationship card 802 within the workspace 408.

In particular, as shown in FIG. 8A, the variable relationship card 802 includes a relationship summary 804 between two selected variables. For instance, the relationship summary 804 includes a plain text description of the relationship between two selected variables (e.g., corresponding to selected tabs 406a-1) including a description of the correlation between the two selected variables, as shown in FIG. 8A. Further detail with regard to generating the plain text description is described in further detail below in connection with FIG. 8B. As further shown, the variable relationship card 802 includes a visualization of the relationship between the two selected variables. In particular, the variable relationship card 802 includes a relationship chart 806 including a visualization of the relationship.

In one or more embodiments, the survey analysis system 104 performs a statistical test and generates the card based on a selection of one or more tabs 406a-1 and a user selection of the relate button 508 (shown in FIG. 5). For example, as shown in FIG. 8A, a user of the client device 401 selects the phone owned tab 406i and the money spent on tech purchases tab 406f As further shown, the user identifies the phone owned variable as the key variable (e.g., key variable) to be compared with the money spent on tech purchases variable (e.g., secondary variable). Once selected, the user may cause the survey analysis system 104 to perform a statistical test on the selected datasets by selecting the relate button 508. In response, the survey analysis system 104 performs a statistical test to determine a statistical result of the relationship and generates the variable relationship card 802. In addition, as shown in FIG. 8A, the survey analysis system 104 provides the variable relationship card 802 within the workspace 408.

As further shown in FIG. 8A, the variable relationship card 802 includes a show results option 808 to show expanded results of the statistical test. For example, where the user of the client device 401 desires to see further explanation about the statistical test and the determined statistical result (e.g., beyond the plain text description), the survey analysis system 104 facilitates providing further detail to explain one or more statistical tests performed with respect to the selected datasets used to determine the statistical result. In particular, in one or more embodiments, in response to detecting a selection of the see results option 808 shown in FIG. 8A, the survey analysis system 104 provides the expanded variable relationship card 802 shown in FIG. 8B including further explanation about the statistical test performed on the selected datasets of the survey information.

In particular, as shown in FIG. 8B, the expanded variable relationship card 802 includes the relationship summary 804 that includes the plain text description of the determined statistical result as well as the chart 806 that visualizes or otherwise summarizes the statistical result of the statistical test. In addition, as shown in FIG. 8B, the expanded variable relationship card 802 includes a test explanation 810 including an identification of one or more statistical tests 812 performed on the selected datasets. For example, as shown in FIG. 8B, the test explanation 810 indicates that the survey analysis system 104 recommends the ranked t-test because the Android Owner dataset contains at least one outlier (e.g., the Android Owned dataset includes one or more datapoints that fall more than a predetermined distance from a designated quartile value). As further shown, the text explanation 810 indicates that the sample size is relatively large, which indicates that results of the unranked t-test are probably valid.

In addition, as shown in FIG. 8B, the expanded variable relationship card 802 includes ranked t-test values 812 as well as unranked t-test values 814. For example, as shown in FIG. 8B, the survey analysis system 104 provides P-values (e.g., a measure of statistical significance), an effect size (e.g., a value indicative of whether a relationship is meaningful, regardless of an amount of data). In addition, as shown in FIG. 8B, the survey analysis system 104 provides a difference between averages of the compared datasets and a confidence interval (e.g., a margin of error around the difference between the groups reflective of un-certainty about the true value of the differences between the averages).

In one or more embodiments, prior to performing the statistical test on the identified datasets, the survey analysis system 104 determines one or more statistical tests to perform. In particular, in one or more embodiments, the survey analysis system 104 selects a statistical test from a plurality of statistical tests based on one or more characteristics of the dataset. For example, the survey analysis system 104 may select one or more statistical tests to perform based on one or a combination of data-types of the selected datasets, a number of datapoints of the selected datasets, one or more identified outliers from one or both of the selected datasets, a calculated distribution of one or both of the selected datasets, a number of values within one or both of the selected datasets, a sample size of respondents, a user-selected confidence level, and/or one or more user-specific preferences. In addition, in one or more embodiments, the survey analysis system 104 selects multiple statistical tests to perform with respect to two or more selected datasets.

To illustrate, FIGS. 8A-8B show a variable relationship card 802 including a presentation of a statistical test between a phone owned (the key variable) dataset and money spent on tech purchases (secondary variable) dataset. As particularly shown in FIG. 8B, the survey analysis system 104 performs a ranked T-test and an unranked T-test. In one or more embodiments, the survey analysis system 104 selects the ranked and un-ranked T-test based on characteristics of the phone owned and money spent on tech purchases datasets. For example, the survey analysis system 104 may identify the T-tests based on an identification that a key variable (phone owned) includes only two categorical values while the secondary variable (Money Spent on Tech Purchases) includes numerical or categorical-type data (e.g., categorical ranges of numeric values). Additionally or as an alternative, the survey analysis system 104 can identify the ranked T-test and/or unranked T-test based on one or more identified outliers from one or both of the datasets in addition to a sample size of respondents who provided the survey information. Additional examples of identifying statistical tests to perform are described in further detail below in connection with FIGS. 8C-8H.

In addition, as mentioned above, the variable relationship card 802 includes a summary 804 of the analysis including a plain text description of the statistical result. For example, as shown in FIGS. 8A-8B, the summary 804 of the statistical test includes a plain text description that reads: “iPhone Owner tends to have slightly higher values for Money Spent on Tech Purchases than Android Owner.” Thus, the survey analysis system 104 provides a plain text description of the relationship between the selected key variable and secondary variable based on the outcome of the statistical result.

The survey analysis system 104 generates the plain text description of the statistical result in a variety of ways. For example, in one or more embodiments, the survey analysis system 104 generates the plain text description by populating fields of a plain text template. For example, as shown in FIG. 8B, the survey analysis system 104 identifies a plain text template including fields 805a-d to populate in generating the plain text description. In particular, as shown in FIG. 8B, the survey analysis system 104 populates a first field 805a with a first value (“iPhone”) of the key dataset (phone owned dataset). In addition, the survey analysis system 104 populates a second field 805b with a correlation description (“tends to have slightly higher values for”) that describes a calculated relationship between the identified datasets. Further, the survey analysis system 104 populates a third field 805c with the variable name of the secondary dataset (Money Spent on Tech Purchases). Finally, the survey analysis system 104 inserts a fourth field 805d with a second value (“Android Owners”) of the key dataset.

In one or more embodiments, the survey analysis system 104 identifies a template based on the data-types of the selected datasets. Additionally or alternatively, in one or more embodiments, the survey analysis system 104 identifies a template based on the identified statistical tests performed on the selected datasets. Thus, the survey analysis system 104 may determine a different combination of fields based on characteristics (e.g., data-type, sample size, identified outliers, etc.) of the analyzed datasets.

In one or more embodiments, the survey analysis system 104 selects a specific template having a particular sentence structure based on the types of data analyzed. For example, as shown in FIGS. 8A-8B, the survey analysis system 104 identifies a plain text template having the sentence structure of the relationship summary 804 based on an identification of the key variable (corresponding to the phone owned dataset) including categorical (or binary) values and the secondary variable (corresponding to the Money Spent on Tech Purchases dataset) including categorical values.

In addition, in one or more embodiments, the survey analysis system 104 selects a template having specific fields based on the data-types of the selected datasets and the statistical tests performed as part of the statistical test. For example, as shown in FIGS. 8A-8B, the survey analysis system 104 identifies the plain text template including fields 805a-d based on the data-types of the identified datasets as well as the determination to perform the ranked T-test and/or unranked T-test.

Further, in one or more embodiments, the survey analysis system 104 identifies specific words to include within respective fields of the plain text template based on values of the statistical result. For example, in one or more embodiments, the survey analysis system 104 populates each respective field of the plain text template based on calculated values of identified statistical tests. For instance, the survey analysis system 104 may insert terms such as “very strong correlation,” “strong collection,” “weak correlation,” “very weak correlation,” or “no correlation” into a respective field of the plain text template based on a calculated value descriptive of the strength of correlation between two selected datasets. In one or more embodiments, the values correspond to specific values, combinations of values, and/or ranges of values calculated when analyzing the selected datasets.

Thus, the survey analysis system 104 can construct the plain text description of the statistical result(s) based on data-types of the selected datasets as well values of the statistical tests performed to obtain the statistical result(s). In addition, as mentioned above, the plain text description can include a particular sentence structure and specific terms based on the data-types of the selected datasets in addition to the statistical results obtained by performing the identified statistical test. By way of example, additional instances of plain text descriptions based on selected data-sets and calculated results of statistical tests are described below in connection with FIGS. 8C-8H.

For example, FIGS. 8C-8D show another example variable relationship card 816 including a presentation of statistical results of a statistical test including a comparison between the years of experience dataset and the age dataset. In particular, in response to detecting a user selection of the years of experience tab 406b (the key variable) and a user selection of the age tab 406a (the secondary variable), the survey analysis system 104 identifies one or more statistical tests to perform and performs a statistical test of the selected datasets to obtain a statistical result. Similar to one or more embodiments described above, the survey analysis system 104 identifies the specific statistical tests as well content shown within the variable relationship card 816 based on data-types of the identified datasets as well as the statistical tests applied to the datasets. For example, in one or more embodiments, the survey analysis system 104 determines to perform a correlation test, simple linear regression test, and/or a ranked correlation test based on a determination that the identified datasets include numeric values.

In addition, as shown in FIGS. 8C-8D, the variable relationship card 816 includes a relationship summary 818 of the statistical results of the identified statistical test. As shown in FIGS. 8C-8D, the relationship summary 818 includes a plain text description of the statistical result(s) that reads “Age is strongly positively correlated with years of experience.” In one or more embodiments, the survey analysis system 104 generates the plain text description based on identified data-types of the analyzed datasets in addition to values obtained by performing the statistical test. In addition, similar to one or more embodiments described above, the survey analysis system 104 may determine a specific sentence structure and terms to use within the plain text description based on the data-types of the selected datasets and the values obtained form the statistical test. Further, in one or more embodiments, the survey analysis system 104 generates the plain text description by populating values of a plain text template.

Similar to one or more embodiments described above, the variable relationship card 816 includes a show results option 824 to facilitate providing an expanded view of the variable relationship card 816. In particular, in response to detecting a user selection of the show results option 824, the survey analysis system 104 expands the variable relationship card 816 to include a description of one or more statistical tests performed on the selected datasets as well as values obtained by performing the identified statistical tests. Similar to one or more embodiments described herein, the survey analysis system 104 determines the statistical tests based on the data-types and other characteristics of the selected datasets.

For example, as shown in FIG. 8D, the survey analysis system 104 performs a relationship analysis on the years of experience dataset and the age dataset that includes a correlation test (e.g., a test for whether values for a first variable get larger, smaller, or stay the same as values for a second variable get larger), simple linear regression test (a test for predicting a linear regression for a single variable in relation to another variable), and a ranked correlation test (a test for whether values for a variable get larger, smaller, or stay the same and which accounts for a nonlinear relationship between values for the variables). Similar to one or more embodiments described herein, the survey analysis system 104 identifies the correlation test, linear regression test, and ranked correlation test based on the data-types of the datasets. In addition, in one or more embodiments, the survey analysis system 104 identifies the different test based on other identified characteristics of the datasets. In addition, as shown in FIG. 8D, the survey analysis system 104 calculates specific values (e.g., P-value, effect size, confidence interval, sample size, R-Squared value, Line of Best Fit approximation, etc.) while performing the identified statistical tests.

As further shown in FIGS. 8C-8D, in addition to the relationship summary 818 and calculated values from the identified statistical tests, the variable relationship card 816 further includes a visualization of the relationship between the two datasets including a graph 820 and a trend line 822. In one or more embodiments, the survey analysis system 104 generates the graph 820 by simply plotting the related values on an x-y axis based on values of the two datasets. For example, as shown in FIGS. 8C-8D, the survey analysis system 104 generates the graph 820 by plotting the numeric values from the years of experience dataset along the y-axis in relation to the numeric values from the age dataset along the x-axis.

In one or more embodiments, the survey analysis system 104 determines the visualization based on the data-types of the selected datasets. For example, as shown in FIGS. 8C-8D, the survey analysis system 104 may determine to plot the values on the graph 820 including the x and y axes based on a determination that the data-types of the selected datasets both include numeric values. Alternatively, where one or both of the datasets include non-numeric (e.g., categorical) values, the survey analysis system 104 may instead provide a bar chart, graph, or other visualization of the analyzed data.

In addition, as shown in FIGS. 8C-8D, the graph 820 includes a trend line 822 showing a linear relationship between values of the identified datasets. For example, as shown by the trend line 822 (and as similarly described by the plain text description), the age is strongly positively correlated with the years of experience. In one or more embodiments, the survey analysis system 104 provides the trend line 822 based on a determined correlation between the selected datasets. Alternatively, where the correlation is weak or non-existent (e.g., below a predetermined threshold test value), the survey analysis system 104 may provide the graph 820 without the trend line 822.

As another example, FIGS. 8E-8F show another example variable relationship card 830 including a presentation of statistical results obtained from performing a statistical test with respect to the money spent on tech purchases dataset and the size of team at work dataset. In particular, in response to detecting a user selection of the money spent on tech purchases tab 406f (the key variable) and the size of team at work tab 406h (the secondary variable), the survey analysis system 104 identifies one or more statistical tests to perform and performs a statistical test of the selected datasets to obtain a statistical result. Similar to one or more embodiments described above, the survey analysis system 104 identifies the types of statistical tests as well as content shown within the variable relationship card 830 based on data-types of the identified datasets as well as the statistical tests performed.

In addition, as shown in FIGS. 8E-8F, the variable relationship card 830 includes a relationship summary 832 including a plain text description of a statistical result obtained from performing the statistical test. In particular, as shown in FIGS. 8E-8F, the relationship summary 832 includes a plain text description that reads: “There is no statistically significant relationship between size of team ant work and money spent on tech purchases last year. Similar to one or more embodiments described herein, the survey analysis system 104 may identify a plain text template including a sentence structure based on the data-types of the datasets in addition to values obtained via the statistical test.

It will be understood that while the statistical results shown in FIGS. 8E-8F are similarly based on a comparison of datasets as described above in connection with FIGS. 8C-8D. Nonetheless, as shown in FIGS. 8E-8F, the plain text description includes a different sentence structure and different values as the plain text description described in connection with FIGS. 8C-8D. As such, while the survey analysis system 104 may primarily determine a sentence structure and terms to include within different fields of a plain text template, in one or more embodiments, the survey analysis system 104 further considers a strength of correlation and specific calculated values of the statistical test performed on the selected datasets. For example, the survey analysis system 104 may identify a different plain text template having different fields and/or a different sentence structure for an analysis of datasets of similar data-types based on different values obtained during the course of performing the statistical tests on the selected datasets.

Further, as shown in FIG. 8E-8F, the variable relationship card 830 includes a visualization of the statistical result(s) of the statistical test including a graph 834. Similar to the graph 820 described above in connection with FIGS. 8C-8D, the graph 834 shown in FIGS. 8E-8F include plotted values from the money spent on tech purchases dataset along the y-axis in relation to plotted values from the size of team at work dataset along the x-axis. In contrast to the graph 820 shown in FIGS. 8C-8D, however, the graph 834 does not include a trend line. For example, in one or more embodiments, the survey analysis system 104 excludes the trend line based on a determination that no correlation exists (or that the correlation falls below a threshold value) between the two selected datasets.

As further shown, the variable relationship card 830 includes a show results option 836. Upon detecting a selection of the show results option 836, the survey analysis system 104 provides an expanded variable relationship card 830 shown in FIG. 8F including an identification of any number of statistical tests 838 performed in addition to calculated values for each of the statistical tests. Similar to the statistical tests described above in connection with FIGS. 8C-8D, the survey analysis system 104 similarly performs a ranked correlation test, correlation test, and simple linear regression test based on identifying that both the selected datasets include numeric values.

As yet another example, FIG. 8G shows another example variable relationship card 846 including a presentation of statistical results obtained from performing a statistical test with respect to the job satisfaction tab 406d (the key variable) and the industry tab 406c (the secondary variable. In particular, similar to one or more embodiments described herein, the survey analysis system 104 identifies one or more statistical tests based on data-types of the selected datasets (e.g., both categorical data-types) in addition to one or more characteristics of the identified datasets.

For example, as shown in FIG. 8G and as shown within the variable relationship card 846, the survey analysis system 104 identifies a Chi-Squared Test (e.g., test to determine whether two variables are statistically related such that there is a tendency for certain variables to coincide with values from the other variable). In one or more embodiments, the survey analysis system 104 determines to use the Chi-Squared test based on an identification that the datasets each include categorical data. In addition, because the Chi-Squared test provides reliable results where a dataset includes a sample size of more than 10,000 results, the survey analysis system 104 may further determine to use the Chi-Squared test based on a number of datapoints within the identified datasets. As shown in FIG. 8G, the variable relationship card 846 includes values any number of values associated with performing the Chi-Squared test. In addition, the variable relationship card includes numerical results of performing the Chi-Squared test.

Further, as shown in FIG. 8G, the variable relationship card 846 includes a visualization of the described analysis including a chart 848. As shown in FIG. 8G, the chart 848 includes a value from the dataset for the key variable (e.g., values from the job satisfaction dataset) plotted against values from the dataset for the secondary variable (e.g., values from the industry dataset). In one or more embodiments, the survey analysis system 104 provides the chart 848 as opposed to a graph or other type of visualization based on the data-types of the analyzed datasets.

In addition, as shown in FIG. 8G, the variable relationship card 846 includes a relationship summary 850 including a plain text description of the statistical results obtained from performing the statistical test of the selected datasets. In particular, as shown in FIG. 8G, the relationship summary 850 includes a plain text description that reads: “There is subtle but statistically significant relationship between Job Satisfaction and Industry.” Similar to one or more embodiments described herein, the survey analysis system 104 generates the plain text description including a particular sentence structure and terms based on the data-types of the selected datasets in addition to the values obtained from performing the statistical test.

As further shown, the variable relationship card 846 includes one or more adjusted residual indicators 849a-c that indicate one or more fields of the chart 848 having values statistically significantly above or below expectations. For example, in one or more embodiments, the survey analysis system 104 uses adjusted residuals to assess whether an individual cell has a value statistically significantly above or below expectations. In particular, the survey analysis system 104 determines, using an adjusted residual test, whether a cell has higher or lower values than expected if there were no relationship between the two variables.

By way of example, as shown in FIG. 8G, the survey analysis system 104 identifies that respondents from the education industry respond significantly less frequently than other industries that they “enjoy going to work” while those respondents from the education industry respond significantly higher than other industries with “I wish I had a job!” As further shown, fewer respondents from the consulting industry responded with “I wish I had a job!” than respondents from other industries. As shown in FIG. 8G, the survey analysis system 104 can indicate a degree of variance from the expected value with one or multiple arrow icons. For instance, in one or more embodiments, the survey analysis system 104 indicates a p-value of less than or equal to 0.05 with one arrow, a p-value of less than or equal to 0.01 with two arrows, and a p-value of less than or equal to 0.001 with three arrows.

In addition, as shown in FIG. 8H, the workspace 408 includes multiple relationship description cards 856-858. For example, as shown in FIG. 8H, the workspace 408 includes a first relationship description card 856 and a second relationship description card 868 within the workspace 408. As further shown, the first relationship description card 856 includes a relationship summary 860 including a plain text description of a statistical result obtained from performing a statistical test of a combination of selected datasets (e.g., compensation dataset and money spent on tech purchases dataset). In addition, the second relationship description card 858 includes a relationship summary 862 including a plain text description of a statistical result obtained from performing a statistical test of a different combination of selected datasets (e.g., purchasing budget dataset and money spent on tech purchases dataset).

In one or more embodiments, the survey analysis system 104 generates the relationship description cards 856-858 and appends the relationship description cards 856-858 above or below an already existing card (e.g., description card, relationship card) within the workspace 408. Alternatively, in one or more embodiments, the survey analysis system 104 generates the relationship description cards 856-858 and provides the relationship description cards 856-858 in-line with each other within the workspace 408. The survey analysis system 104 may generate any number of cards based on a number of variable tabs selected.

For example, as indicated in FIG. 8H, the survey analysis system 104 receives or otherwise detects a selection of each of the variable tabs 406a-l. In particular, as shown in FIG. 8H, the survey analysis system 104 detects a selection of the money spent on tech purchases tab 406f as a key variable and further detects a selection of each of the remaining variable tabs 406a-e, g-l as secondary variable. In addition, in response to detecting a user selection of the relate button 508 in conjunction with the selected tabs 406a-l, the survey analysis system 104 performs a statistical test between the dataset for the selected key variable and each of the datasets for the selected key variables. As shown in FIG. 8H, the survey analysis system 104 generates a relationship description card for each of the pairs of datasets including a presentation of statistical results obtained from performing a respective statistical test for each selected dataset pair.

In one or more embodiments, the survey analysis system 104 performs a statistical test for a dataset for the key variable (e.g., money spent on tech purchases) and each secondary variable. As such, where the survey analysis system 104 detects a selection of a single key variable and ten secondary variables, the survey analysis system 104 performs ten different statistical tests (or ten combinations of one or more statistical tests) based on characteristics between the key variable and respective secondary variables. For example, the survey analysis system 104 would perform a first statistical test on the money spent on tech purchases dataset and the age dataset to obtain a first statistical result. In addition, the survey analysis system 104 would perform a second statistical test on the money spent on tech purchases dataset and the years of experience dataset to obtain a second statistical result. The survey analysis system 104 would similarly perform a separate statistical test on the money spent on tech purchases and each of the datasets corresponding to the secondary variables.

In performing each of the tests, the survey analysis system 104 would identify specific statistical tests to perform on the respective datasets (e.g., based on data-types, dataset characteristics, etc.) In addition, the survey analysis system 104 would generate a relationship summary including a plain text description of each of the statistical results. For example, the survey analysis system 104 would generate a plain text description for each dataset pair based on data-types of the datasets in addition to calculated values obtained by performing identified statistical tests. Moreover, in one or more embodiments, the survey analysis system 104 generates a separate relationship card including a presentation of content that describes that explains, visualizes, or otherwise describes the statistical result for each statistical test.

In one or more embodiments, the survey analysis system 104 provides the relationship cards in accordance with one or more characteristics. For example, in one or more embodiments, the survey analysis system 104 orders the relationship cards in order of a strength of correlation. As such, the survey analysis system 104 orders the relationship cards within the workspace 408 based on a measurement of importance in accordance with the statistical results. For example, the survey analysis system 104 may place the relationship cards having a high correlation value at the top of the workspace 408 while placing the relationship cards having a low or non-existent correlation at the bottom of the workspace 408.

In one or more embodiments, the survey analysis system 104 orders the generated relationship cards within the workspace 408 based on a combination of different characteristics. For example, in one or more embodiments, the survey analysis system 104 orders the relationship cards within the workspace 408 based on a combination of significance and effect size of the different statistical results. Alternatively, in one or more embodiments, the survey analysis system 104 orders the relationship cards within the workspace 408 based on an original order of the variables (e.g., within the variable tag menu 404).

In one or more embodiments, the survey analysis system 104 orders the relationship cards within the workspace 408 based on a priority of different characteristics. For example, in one or more embodiments, the survey analysis system 104 first groups one or more of the relationship cards based on a type of analysis (e.g., based on one or more statistical tests) performed to achieve the statistical results. For instance, the survey analysis system 104 may generate a first grouping of relationship cards in which the survey analysis system 104 performed an ANOVA test (e.g., a collection of statistical models used to analyze the differences among group means and associated variations between the groups) to obtain the statistical result. As another example, the survey analysis system 104 may generate a second grouping of relationship cards in which the survey analysis system 104 performed a T-test. Thus, the survey analysis system 104 may generate any number of groups of relationship cards and provide the relationship cards based on specific groupings.

In addition to organizing the relationship cards by groups, the survey analysis system 104 may further order the relationship cards within each group based on an effect size of the statistical results within the group. In this way, the survey analysis system 104 avoids simply ordering the relationship cards by an effect size that may mean something different depending on the type of analysis performed. For example, because an ANOVA test generally has a different effect size from a T-test, simply grouping the relationship cards by effect size without consideration of the type of analysis performed may cause the survey analysis system 104 to provide the relationship cards in a non-intuitive fashion. As such, the survey analysis system 104 provides an intuitive organization of the relationship cards in accordance with a combination of characteristics of the statistical tests and the statistical results.

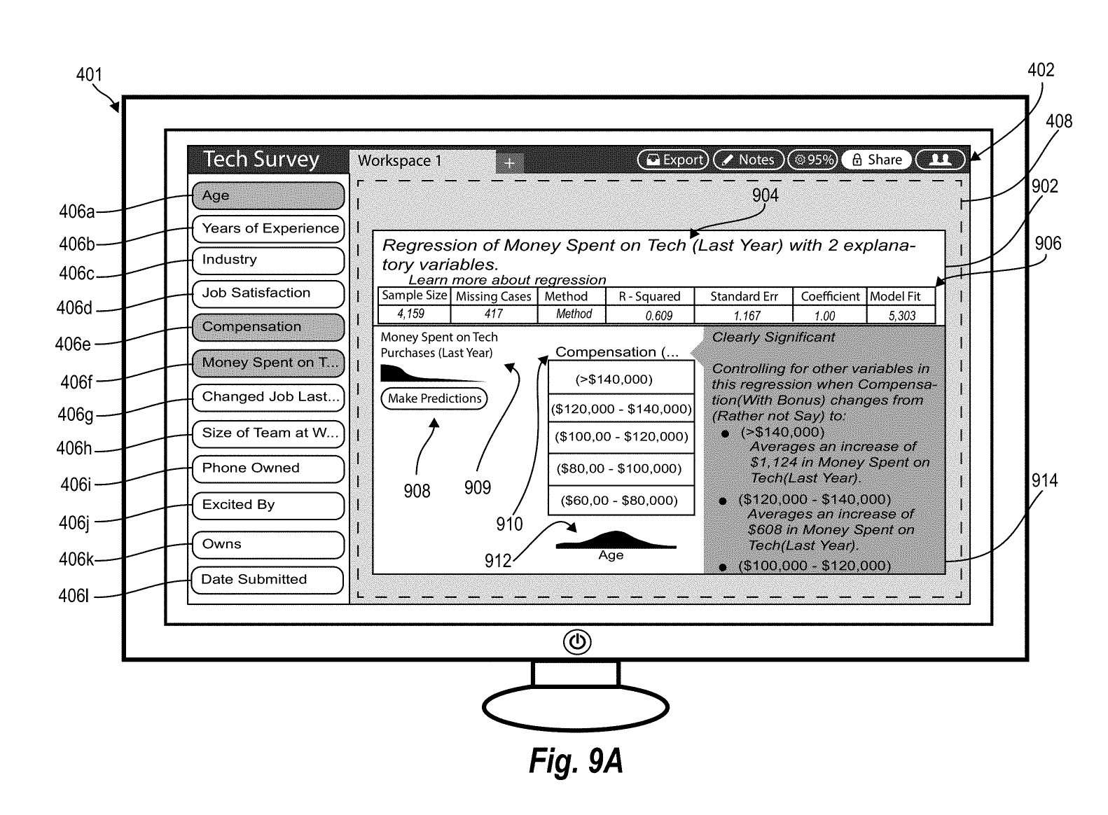

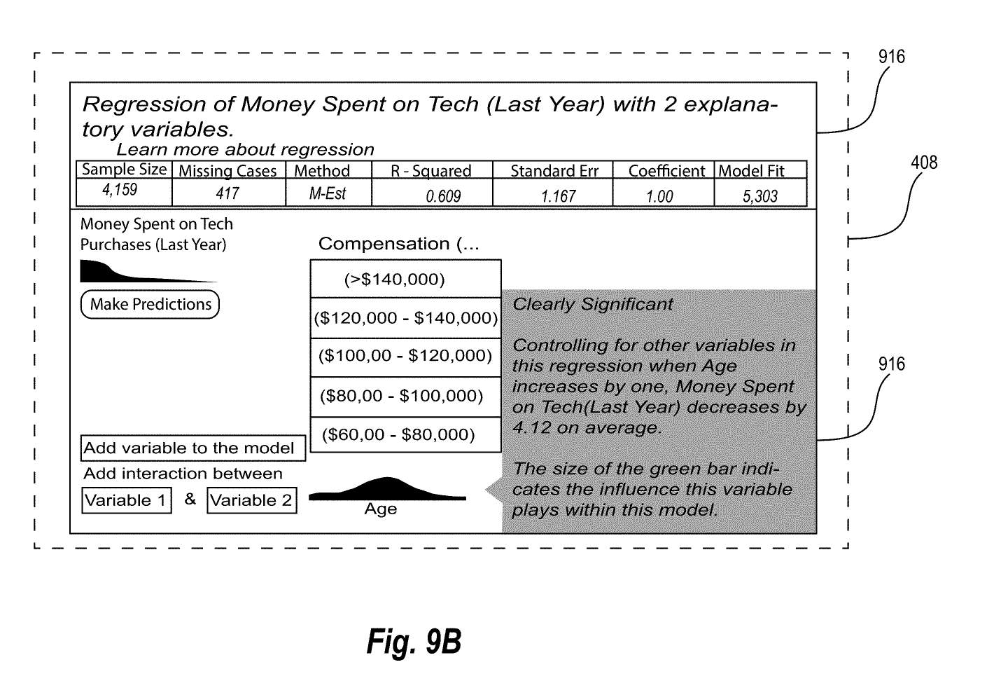

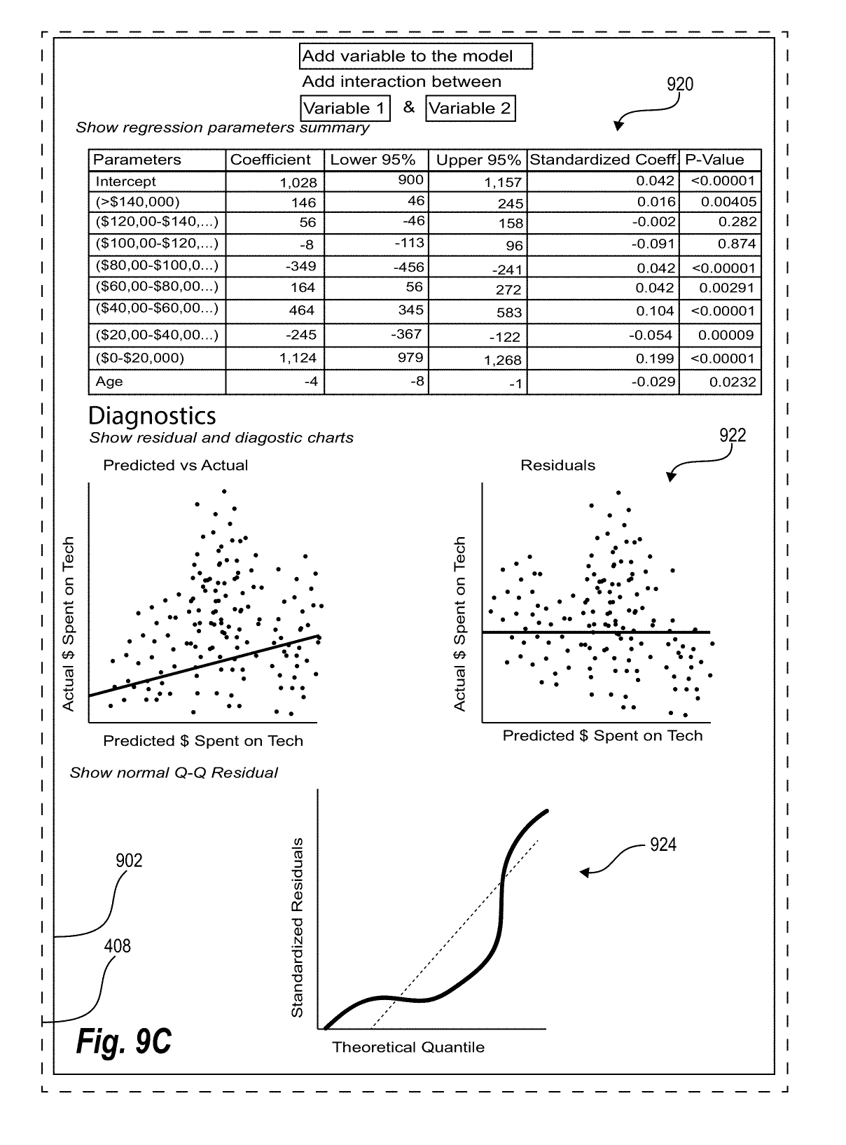

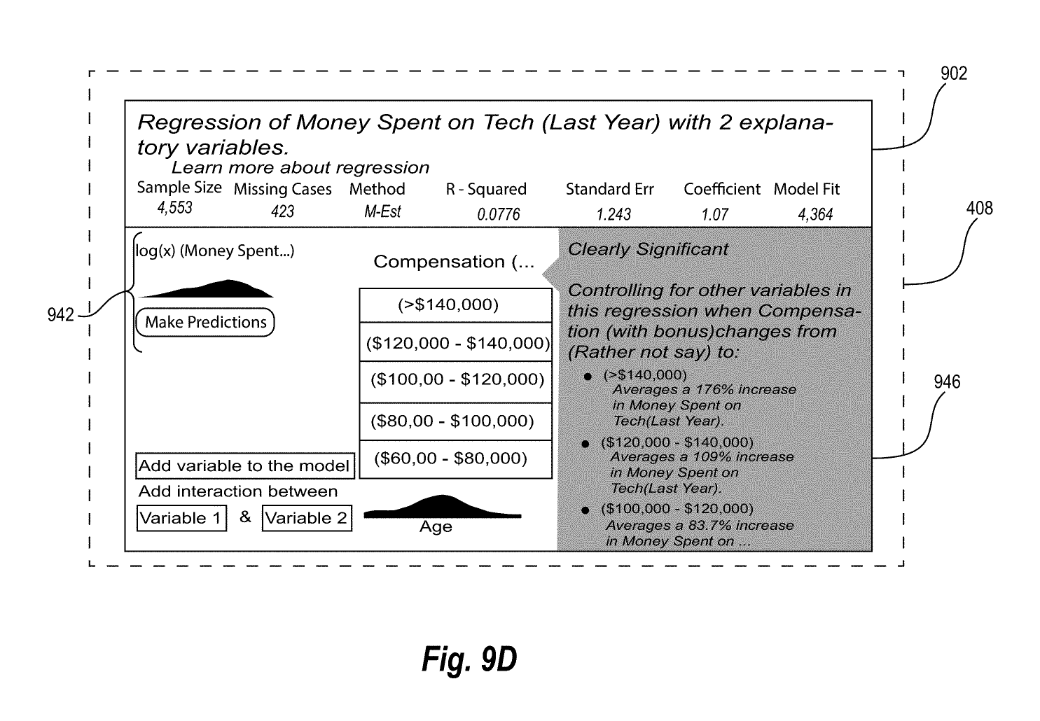

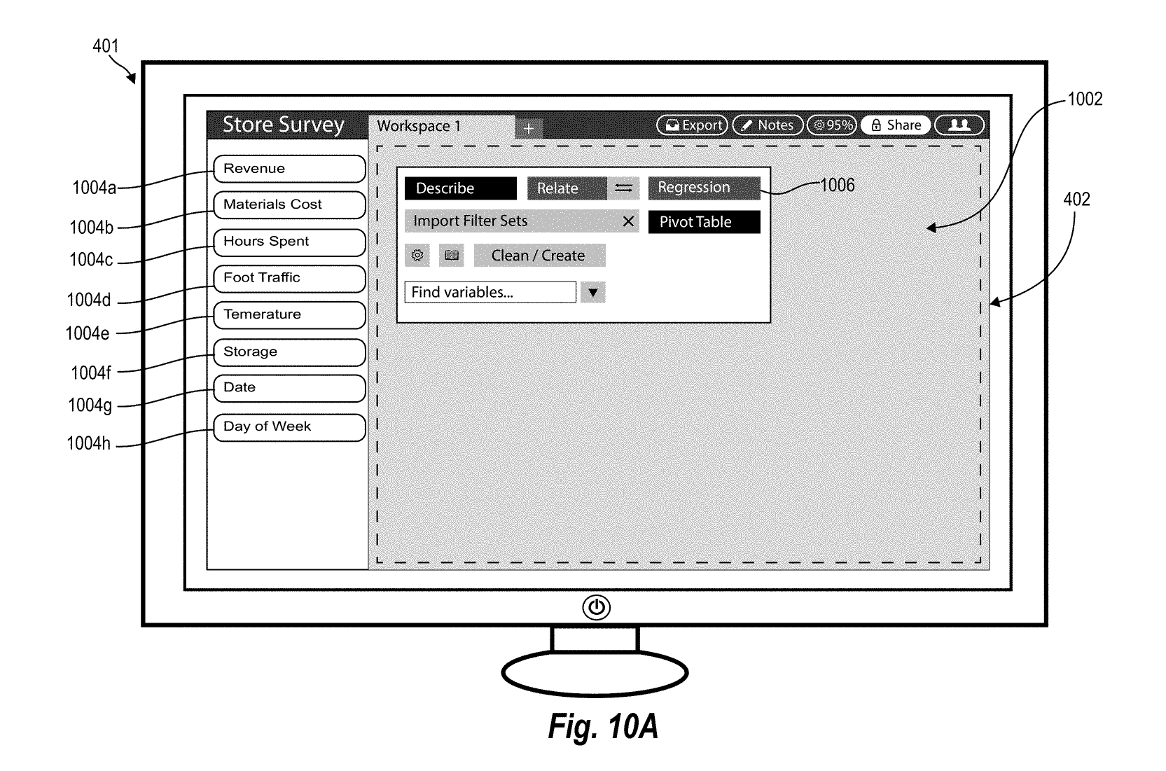

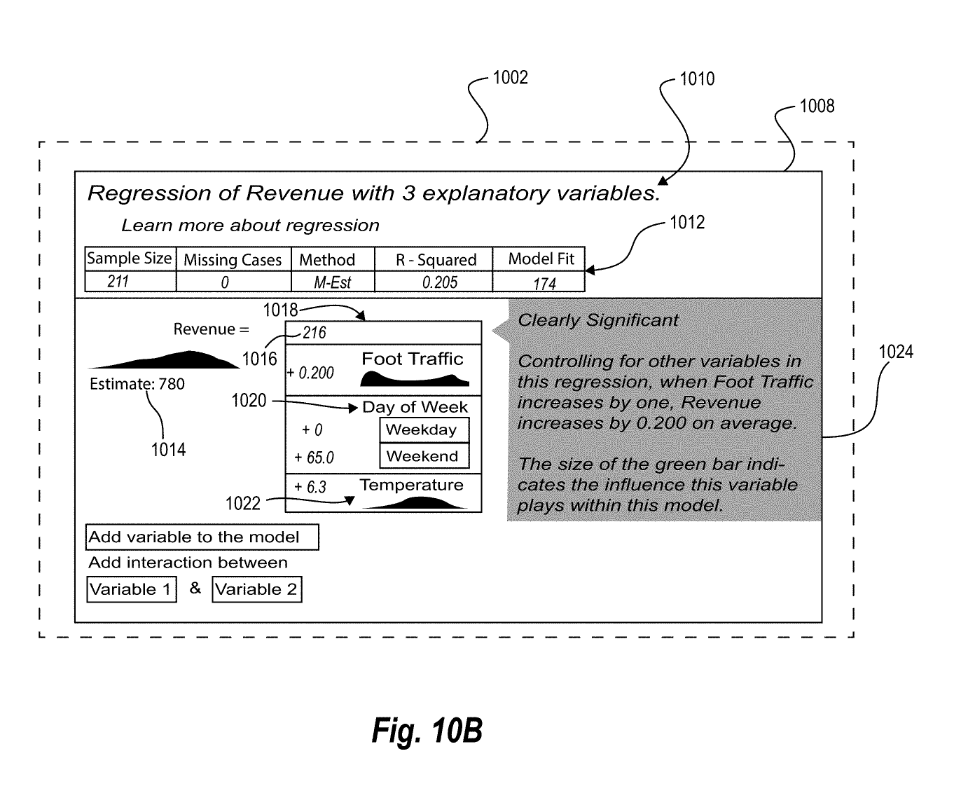

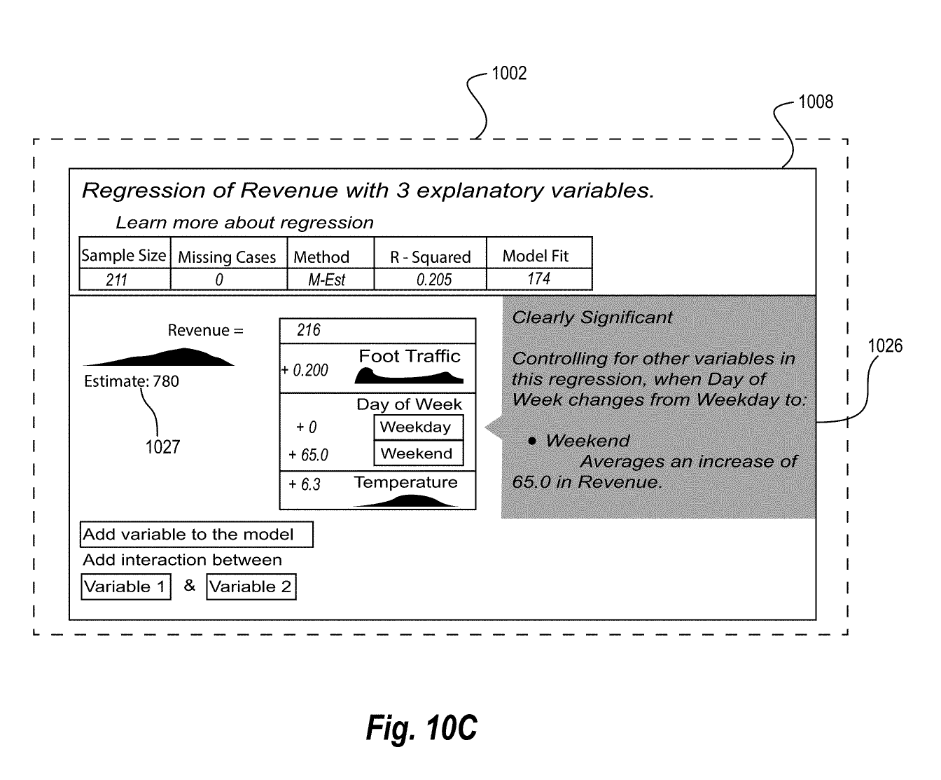

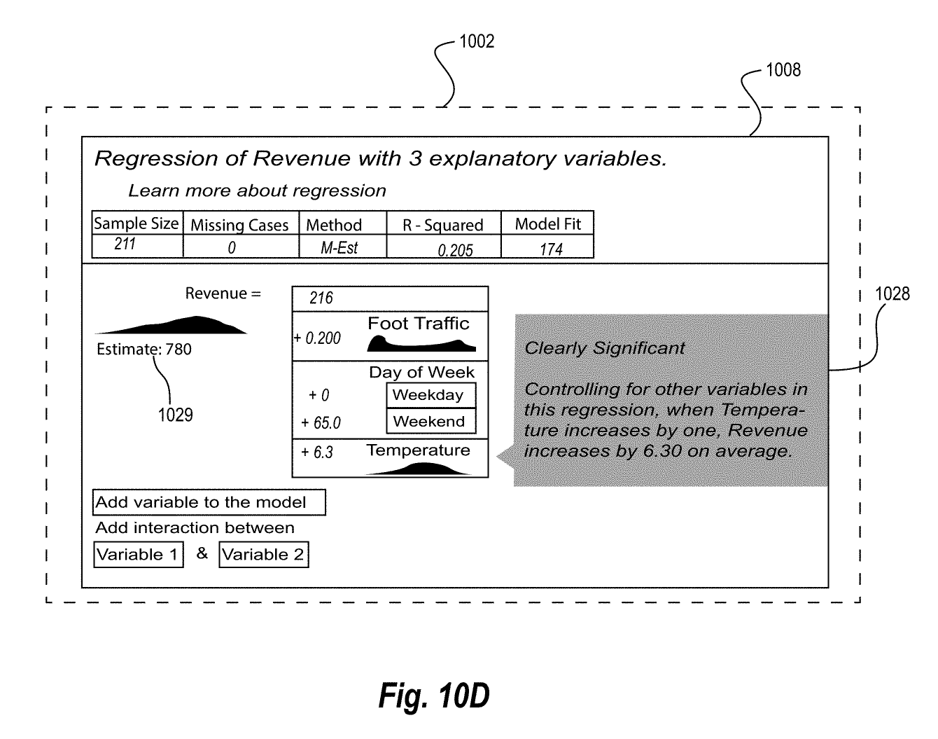

As another example of performing a statistical test and providing a presentation including statistical results, in one or more embodiments, the survey analysis system 104 performs a regression analysis on two or more selected datasets and provides a presentation of the statistical results within the workspace 408. For example, as described in FIGS. 9A-10D, the survey analysis system 104 enables a user to select a key variable and one or multiple secondary variables and, in response to detecting a selection of the regression button 512 described above in connection with FIG. 5, generates one or more regression cards including content that visualizes or otherwise describes statistical results of a regression analysis.

For example, FIG. 9A shows a regression card 902 including a regression summary 904 and a chart of regression values 906. In particular, as shown in FIG. 9A, the regression description card 902 includes a regression summary 904 including a summary of what is described within the regression description card (e.g., “Regression of Money Spent on Tech Purchases with 2 explanatory variables). In addition, the chart 906 of regression values includes calculated values such as a sample size, a number of missing cases, or a method used (e.g., M-estimation where the selected datasets include an identified number of outliers, ordinary least squares to be sensitive to violations in the datasets, ridge regression to help deal with high variance or data that suffers from multicollinearity) based on data-types and/or characteristics of the datasets. In addition, the chart 906 of regression values further includes an R-Squared value, a standard error, a coefficient of variation, and a model fit. In one or more embodiments, the survey analysis system 104 generates the chart 906 of regression values based on data-types of selected datasets in addition to one or more other characteristics of the datasets.

As further shown, the regression card 902 includes a make predictions button 908 for generating a new dataset that predicts money spent on tech purchases based on regression equation generated for the selected variables. In particular, as shown in FIG. 9A, the survey analysis system 104 generates a regression equation for predicting a value for money spent on tech purchases based on a compensation value and an age value. More specifically, as shown in FIG. 9A, the survey analysis system 104 generates a regression equation including a predicted money spent on tech purchases value 909 based on values attributable to a particular compensation range and a particular age.

For example, as shown in FIG. 9A, the regression card 902 includes compensation values 910 in association with a plurality of plain text descriptions 914 for the different ranges of compensation. In particular, the regression values 910 include a listing of each range of compensation datapoints within the compensation dataset. In addition, the plurality of plain text descriptions 914 include an overall plain text description of whether the compensation value is significant in addition to a plain text description for each compensation value in predicting how much money a given respondent will spend on tech purchases. As an example, and as shown in FIG. 9A, the plurality of plain text descriptions 914 includes a first plain text description for compensation values that exceed $140,000 that reads “Controlling for other variables in this regression, when Compensation changes from (Rather not say) to (>$140,000) an increase of 1,124 in Money Spent on Tech Purchases” thus indicating that those respondents that earn greater than $140,000 tend to spend substantially more money on tech purchases than those that listed “Rather Not Say.” In addition, the plurality of plain text descriptions 914 similarly indicate that respondents spend more on tech purchases based on an increased salary. As such, a user may easily understand the significance between compensation and money spent on tech purchases.

In addition, as shown in FIG. 9B, the regression card 902 includes age values 912 in association with a plain text description 916 the describes a statistical result obtained from analyzing a relationship between the money spent on tech purchases dataset and the age dataset. In particular, as shown in FIG. 9B, the plain text description 916 reads “Clearly Significant—Controlling for other variables in this regression, when age increases by one, money spent on tech purchases decreases by 4.12 on average” thus indicating that, when controlling for other variables in the regression, money spent on tech purchases decreases as a given respondent gets older.

In this way, the survey analysis system 104 provides a more detailed description of one or more statistical results based on multiple datasets. In particular, where a general relationship analysis between age and money spent on tech purchases may show that the amount of money spent on tech purchases increases with age, performing a regression analysis including stronger correlating variables (e.g., compensation v. money spent on tech purchases) may provide an accurate picture of how multiple datasets relate to each other.

Moving onto FIG. 9C, the regression card 902 further includes a description of parameters and diagnostics used to perform the regression analysis and in generating the plain text descriptions. For example, as shown in FIG. (C, the regression card 902 includes a regression and parameters summary 920 including each of the parameters used in performing the regression analysis and associated values. As further shown in FIG. 9C, the regression card 902 includes prediction graphs 922 including a predicted vs. actual plot including predicted values vs. actual values of the money spent on tech purchases dataset. The prediction graphs 922 further includes a residual plot including predicted values for the money spent on tech purchases variable vs. standardized residuals. As further shown in FIG. 9C, the regression card 902 includes a normal Q-Q chart 924 including a plot of theoretical values plotted against the standardized residuals. Similar to one or more embodiments described herein the regression card 902 includes different charts and/or visualizations of the regression based on data-types of the selected datasets in addition to calculated values from the regression analysis.

Proceeding onto FIG. 9D, the regression card 902 shows transformed values of the regression analysis in accordance with one or more embodiments described herein. For example, as shown in FIG. 9D, the regression card 902 includes a transformation field 942 including an option to transform the money spent on tech purchases variable. In particular, as shown in FIG. 9C, transformation field 942 includes an option to change the money spent on tech purchases variable from a linear numeric value to a logarithmic value. In this way, the survey analysis system 104 provides the user with a modified presentation of the statistical result.

For example, as shown in FIG. 9D, based on the transformation of the regression analysis, the regression card includes modified statistical results (e.g., numerical results) in addition to a modified plain text description of the statistical results. For example, in contrast to the plain text description of the statistical results described above in connection with FIG. 9A, the regression card 902 includes modified plain text descriptions 946, 948 based on the regression analysis of the transformed input datasets.

For example, as shown in FIG. 9D, the regression card 902 includes a first plurality of transformed plain text descriptions 946 corresponding to the regression values 910 for each of the compensation datapoints within the compensation dataset. For instance, as shown in FIG. 9D, the plurality of transformed plain text descriptions 946 includes an indication of whether the compensation variable is a significant variable to the key variable (money spent on tech purchases) as well as an identified percentage increase or decrease for each value with each incremental value of the compensation dataset. In contrast to the plurality of text descriptions 914 shown in FIG. 9A, the plurality of transformed plain text descriptions 924 include a plain text description that describes the statistical result in terms of percentages based on the user selection of the logarithmic input value. In one or more embodiments, the survey analysis system 104 may determine to include a numerical, percentage, or other type of description within the plain text description of the statistical result(s) based on the selected transformation of the input value(s).

Similar to the plurality of transformed plain text descriptions 946 for the compensation variable, the regression card 902 similarly includes a transformed plain text description 948 for the age variable. As shown in FIG. 9D, the plain text description 948 includes an identification that the age variable is not significant to the key variable as well as an identified percentage increase or decrease when the age variable changes. Similar to the plurality of transformed plain text descriptions 948 for the compensation variable, the plain text description 948 for the age variable similarly expresses the relationship with the key variable in terms of a percentage.

FIGS. 10A-10D provide an additional example of a regression card generated based on a selection of datasets from a collection of survey information. For example, as shown in FIG. 10A, the graphical user interface 402 of the client device 401 includes a workspace 1002 and variable tabs 1004a-h corresponding to datasets of received survey information. In particular, as shown in FIG. 10A, the variable tabs 1004a-h include a revenue tab 1004a, a materials cost tab 1004b, an hours spent tab 1004c, a foot traffic tab 1004d, a temperature tab 1004e, a signage tab 1004f, a date tab 1004g, and a day of the week tab 1004h. Similar to one or more embodiments described herein each of the tabs 1004a-h correspond to a respective dataset including responses to electronic survey questions. As further shown, the graphical user interface 402 includes a regression button 1006.

As further shown in FIG. 10A, the graphical user interface 402 shows selected tabs including the revenue tab 1004a, the foot traffic tab 1004d, the temperature tab 1004e, and the day of the week tab 1004h. As further shown, the revenue variable has been designated as a key variable with the foot traffic, temperature, and day of the week variables being designated as secondary variable. In one or more embodiments, the survey analysis system 104 performs a regression analysis on datasets for the selected variables (e.g., on the dataset of the key variable in view of the datasets for the secondary variables).

For example, in response to detecting a selection of one or more of the variable tabs 1004a-h in conjunction with the regression button 1006, the survey analysis system 104 performs a regression analysis on the datasets of the survey information corresponding to the selected variables. In particular, as shown in FIG. 10B, the survey analysis system 104 generates a regression card 1008. As shown in FIG. 10B, the regression card 1008 includes a summary of the regression analysis result 1010 including an identification of the key variable (revenue variable) and secondary variables (foot traffic variable, temperature variable, day of the week variable). In addition, the regression card 1008 includes a summary chart 1012 showing values such as the sample size, missing cases, the analysis method (e.g., M-estimation), the effect size, and one or more additional values associated with one or more selected statistical tests. Similar to one or more embodiments described herein, the summary and summary graph may include respective fields and values based on the data-types of the selected datasets in addition to calculated values calculated as a result of performing one or more statistical tests.

As further shown in FIG. 10B, the regression card 1008 includes a regression equation (e.g., estimation equation) including a revenue estimate 1014 (e.g., corresponding to the key variable) and additional values 1016-1022. In particular, the regression equation includes a first normalized value 1016 that predicts a revenue value controlling for a zero value (or non-value) for each of the secondary variables. For example, as shown in FIG. 10B, the survey analysis system 104 may predict a minimum revenue of 216 based on the normalized value 1016. As further shown, the regression equation includes a foot traffic correlation value 1018 including a predicted increase in revenue for each additional unit of foot traffic (e.g., one person). As further shown, the regression equation includes a day of the week correlation value including a predicted increase in revenue based on whether the revenue is estimated on a weekday or weekend. As further shown, the regression equation includes a temperature correlation value including a predicted increase in revenue for each increase in unit of temperature (e.g., one degree Fahrenheit).

In addition, in one or more embodiments, the regression card 1008 includes one or more plain text descriptions for each of the secondary variables. For example, as shown in FIG. 10B, the regression card 1008 includes a first plain text description 1024 for the foot traffic variable. In particular, as shown in FIG. 10B, the first plain text description 1024 indicates that the foot traffic variable is “clearly significant” to the revenue value and indicates that “controlling for other variables in this regression, when foot traffic increases by one, revenue increases by 0.200 on average.”

As shown in FIG. 10C, the regression card 1008 includes a second plain text description 1026 for the day of the week variable. In particular, as shown in FIG. 10C, the second plain text description 1026 indicates that the day of the week variable is “clearly significant” to the revenue value. The second plain text description 1026 further indicates “controlling for other variables in this regression, when day of the week changes from weekday to weekend, revenue averages an increase of 65.0.”

As shown in FIG. 10D, the regression card 1008 includes a third plain text description 1028 for the temperature variable. In particular, as shown in FIG. 10D, the third plain text description 1028 indicates that the temperature variable is “clearly significant” to the revenue value. In addition, the third plain text description 1028 indicates “controlling for other variables in this regression, when temperature increases by one, revenue increases by 6.30 on average.”

In one or more embodiments, the survey analysis system 104 provides the first plain text description 1024, second plain text description 1026, and/or third plain text description 1028 based on a user selection of a respective field. For example, in one or more embodiments, the survey analysis system 104 causes the regression card 1008 to include one of the plain text descriptions 1024-1028 based on a presently selected variable (or field within the regression equation). For example, in one or more embodiments, in response to detecting a user selection of the day of the week field, the survey analysis system 104 causes the regression card 1008 to display the second plain text description 1026 as shown in FIG. 10C instead of the first plain text description 1024 as shown in FIG. 10B. Alternatively, in one or more embodiments, the survey analysis system 104 causes the regression card 1008 to include one or more of the plain text descriptions 1024-1028 simultaneously.

In addition, as shown in FIGS. 10C-10D, the regression card 1008 includes an updated revenue estimate based one or more modified values of the variables that make up the regression equation. For example, as shown in FIG. 10C, the regression card 1008 includes a first updated revenue estimation 1027 based on a detected modification of the day of the week variable (e.g., from weekday to weekend). In addition, as shown in FIG. 10D, the regression card 1008 includes a second updated revenue estimation 1029 based on a detected modification of the temperature variable.

In this way, the survey analysis system 104 enables a user to interact with the regression card 1008 to generate an estimated revenue based on different secondary variable values. For example, a user can interact with the regression card 1008 to modify what the revenue will equal based on specific values for the foot traffic variable, the day of the week variable, and temperature variable. In this way, the survey analysis system 104 enables a user to predict a value based on the regression analysis result displayed within the regression card.

In addition, as mentioned above, the survey analysis system 104 provides any number of plain text description to better assist the user in understanding the relationship between the secondary variables and the primary variable. In this way, the survey analysis system 104 may easily understand how changing the values will influence the statistical result. In addition, this enables the user to understand which variables strongly correlate to other variables, thus enabling the user to effectively plan for future results.

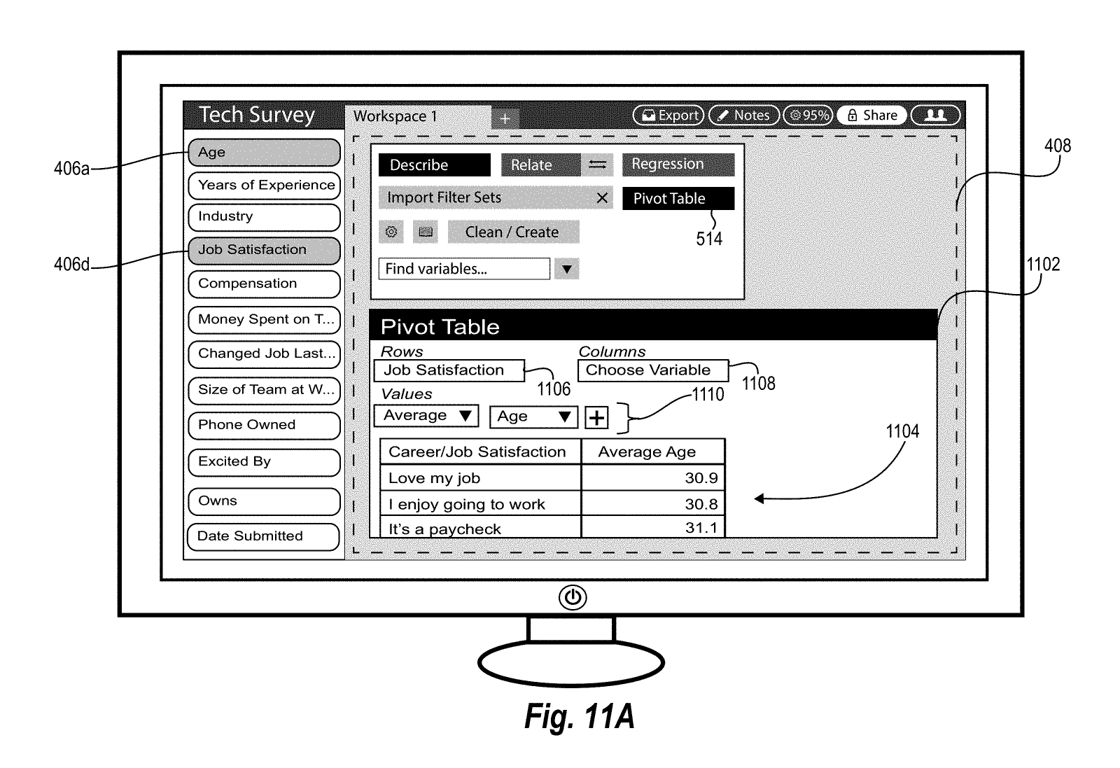

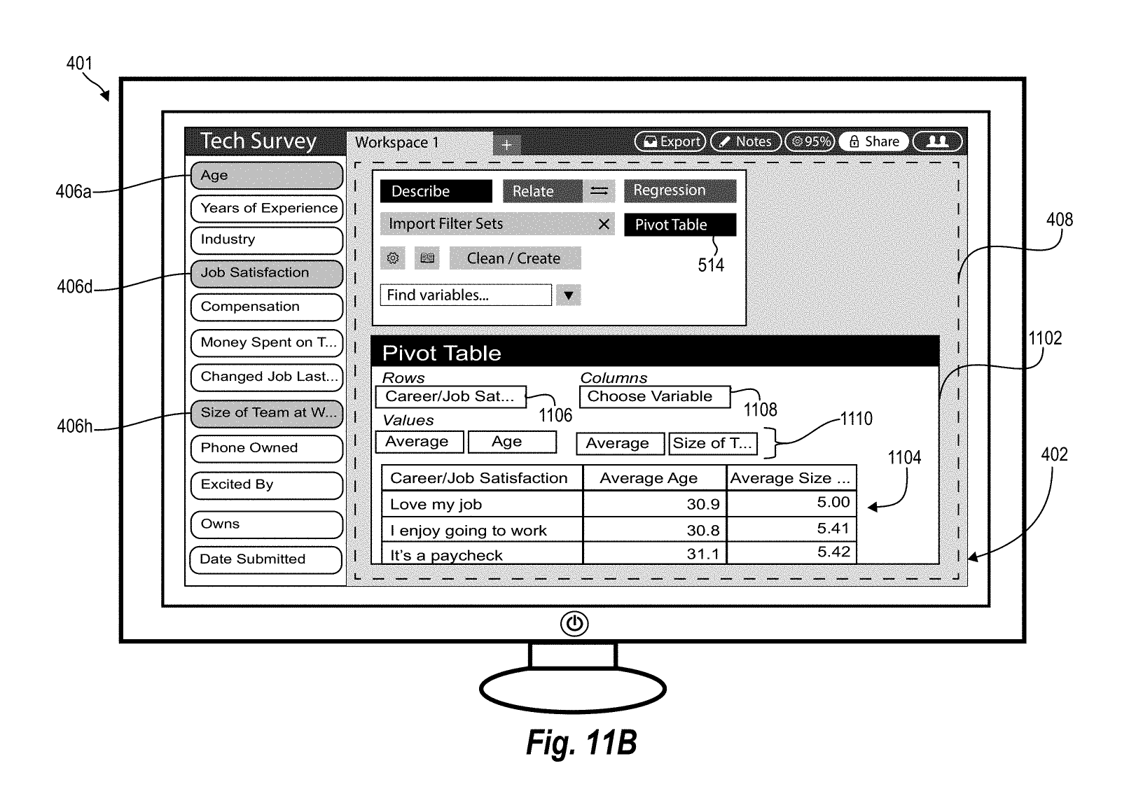

In addition to performing a regression analysis and providing a presentation of the analysis results, the survey analysis system 104 can provide yet another visualization of statistical results in the form of pivot tables. For example, as shown in FIG. 11A, the survey analysis system 104 generates a pivot table card 1102 including a pivot table graph 1104. As shown in FIG. 11A, the pivot table graph 1104 includes rows and columns based on selected variables corresponding to specific datasets. In particular, as shown in FIG. 11A, the pivot table card 1102 includes a row field 1106, a column field 1108, and a value field 1110.

In one or more embodiments, the survey analysis system 104 enables a user to modify the pivot table graph 1104 in accordance with selected variables for each of the columns, rows, and values. To illustrate FIG. 11A shows a single variable (job satisfaction) selected for the row value and a corresponding average age value. In response, the survey analysis system 104 generates the pivot table graph 1103 including rows for each of the datapoints of the job satisfaction variable and an average age within the survey information for each of the respondents to indicated the corresponding job satisfaction value. In one or more embodiments, the survey analysis system 104 can add additional rows or columns to see corresponding values for different combinations of responses from the survey information.

FIG. 11B shows another example in which the pivot table graph 1104 includes an additional value. For example, in response to detecting a user input adding another value (Average size of team at work), the survey analysis system 104 pivot table graph 1104 to include an additional value. Thus, as shown in FIG. 11B, the pivot table graph 1104 includes a corresponding average age and average size of team at work for the respondents to the electronic survey that selected each of the corresponding job satisfaction variables. As shown in FIG. 11B, the survey analysis system 104 can update the pivot table graph 1104 to include additional values in accordance with the modified fields 1106-1110 within the header of the pivot table card 1102. Alternatively, in one or more embodiments, the survey analysis system 104 generates a new pivot table card based on modified values to the different fields 1106-1110.

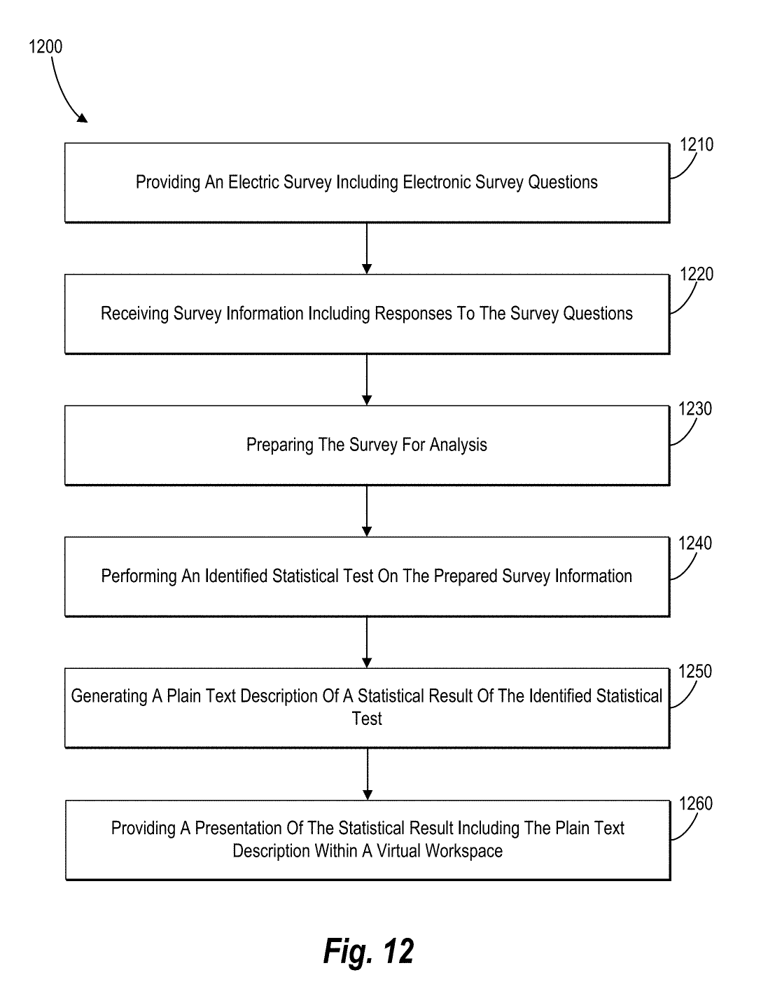

FIGS. 1-11B, the corresponding text, and the example, provide a number of different systems, devices, and processes for analyzing survey information and providing a presentation of one or more statistical results. In addition to the foregoing, embodiments disclosed herein also can be described in terms of flowcharts comprising acts and steps in a method for accomplishing a particular result. For example, FIG. 12 illustrates a flowchart of an exemplary method in accordance with one or more embodiments disclosed herein. The method described in relation to FIG. 12 can be performed with less or more steps/acts or the steps/acts can be performed in differing orders. Additionally, the steps/acts described herein can be repeated or performed in parallel with one another or in parallel with different instances of the same or similar steps/acts.

FIG. 12 illustrates a flowchart of an example method 1200 for analyzing survey information and providing a presentation of one or more statistical results of the analyzed survey information. While FIG. 12 illustrates example acts according to one embodiment, other embodiments may omit, add to, reorder, and/or modify any of the acts shown in FIG. 12. One or more acts shown in FIG. 12 may be performed by any of the components illustrated in the environment 100 shown in FIG. 1. For example, one or more acts of the method 1200 may be performed by the server device 102, administrator client device 110, and one or more respondent devices 106a-n.

As shown in FIG. 12, the method 1200 includes an act 1210 of providing an electronic survey including electronic survey information. For example, in one or more embodiments, the act 1210 includes providing, to a plurality of respondent client devices, an electronic survey including electronic survey questions. As further shown, the method 1200 includes an act 1220 of receiving survey information including responses to the survey questions. For example, in one or more embodiments, the act 1220 includes receiving, from the plurality of respondent client devices, survey information including responses to the survey questions and information associated with users of the plurality of respondent client devices.

As further shown in FIG. 12, the method 1200 includes an act 1230 of preparing the survey information for analysis. For example, in one or more embodiments, the act 1230 includes preparing, by at least one processor, the survey information for analysis where preparing the survey information for analysis includes identifying a statistical test (or multiple statistical tests) from a plurality of statistical tests.

In one or more embodiments, preparing the survey information for analysis includes organizing the received survey information into a plurality of discrete portions (e.g., datasets) corresponding to respective electronic survey questions. In one or more embodiments, preparing the survey information for analysis includes identifying a data-type for each of the plurality of discrete portions. In one or more embodiments, identifying the data-type includes designating a discrete portion as a corresponding data-type based on a received user input. In addition, in one or more embodiments, preparing the survey information for analysis includes modifying one or more datapoints of the plurality of discrete portions based on the identified data-type.

As mentioned above, in one or more embodiments, preparing the survey information for analysis involves identifying a statistical test from a plurality of statistical tests. For example, in one or more embodiments, the method 1200 includes receiving a selection of a discrete portion (e.g., from a plurality of discrete portions) of the survey information and determining a statistical test to perform on the selected discrete portion. In one or more embodiments, identifying the statistical test involves determining the statistical test from a plurality of statistical tests based on an identified data-type of the selected discrete portion of the survey information.

In one or more embodiments, the method 1200 includes receiving a user selection of two or more of a plurality of discrete portions of the survey information. In one or more embodiments, receiving the user selection of the multiple discrete portions includes receiving a first user selection of a primary variable (e.g., a variable tab) associated with a first discrete portion of the plurality of discrete portions. In addition, in one or more embodiments, receiving the user selection of the multiple discrete portions includes receiving a second user selection of a plurality of secondary variables associated with a plurality of additional discrete portions of the plurality of discrete portions of the survey information. In one or more embodiments, preparing the survey information includes identifying one or more statistical tests to perform on the first discrete portion of the survey information and each of the additional discrete portions.

As further shown in FIG. 12, the method 1200 includes an act 1240 of performing an identified statistical test on the prepared survey information. For example, in one or more embodiments, the act 1240 includes performing, by at least one processor, the identified statistical test (or plurality of statistical tests) on the prepared survey information to determine a statistical result. In one or more embodiments, performing the statistical test(s) includes performing one or more statistical tests to determine a relationship between a first discrete portion of the survey information and each of a plurality of additional discrete portions of the survey information. In one or more embodiments, performing the statistical test(s) includes performing a different combination of one or more statistical tests to determine a relationship between the first discrete portion of the survey information and each of the plurality of additional discrete portions of the survey information based on data-types of the first discrete portion of survey information and each of the plurality of additional discrete portions of the survey information.

As further shown in FIG. 12, the method 1200 includes an act 1250 of generating a plain text description of a statistical result of the identified statistical test. In one or more embodiments, generating the plain text description includes identifying a plain text template associated with the identified statistical test where the plain text template includes a plurality of text fields. In addition, in one or more embodiments, generating the plain text description includes populating the plurality of text fields with terms from a plurality of possible terms for each of the plurality of text fields based on the determined statistical result. In one or more embodiments, the terms of the plain text description include descriptive terms of the determined statistical result.

As further shown in FIG. 12, the method 1200 includes an act 1260 of providing a presentation of the statistical result including the plain text description within a virtual workspace. For example, in one or more embodiments, the act 1260 includes providing, to an administrator client device, a presentation of the statistical result(s) within a virtual workspace where the presentation of the statistical result includes the plain text description of the statistical result and a visualization of the statistical result. In one or more embodiments, providing the presentation of the statistical result includes identifying a type of visualization based on the identified statistical test. In addition, in one or more embodiments, identifying the type of visualization is based on the determined statistical result.

As mentioned above, in one or more embodiments, the method 1200 includes performing a plurality of statistical tests on selected discrete portions of the survey information and providing a presentation of statistical results via a virtual workspace. In one or more embodiments, performing the plurality of statistical tests includes determining a correlation strength between the first discrete portion of the survey information and each of the plurality of additional discrete portions of the survey information. In addition, in one or more embodiments, providing the presentation of the one or more statistical results includes ordering the one or more statistical results within the virtual workspace based on the determined correlation strength between the first discrete portion of the survey information and each of the plurality of additional discrete portions of the survey information. In one or more embodiments, providing the presentation further includes identifying groupings of the one or more statistical results based on the identified plurality of statistical tests and further ordering the one or more statistical results within the virtual workspace further comprises ordering the one or more statistical results within the virtual workspace based on the determined correlation strength within each of the identified groupings.

As another example, in one or more embodiments, the method 1200 includes receiving a user selection of a primary variable associated with a first discrete portion of the survey information and further receiving a user selection of a plurality of secondary variables associated with a plurality of additional discrete portions of the survey information. In one or more embodiments, performing the identified statistical text includes performing a regression test on the first discrete portion and the plurality of additional discrete portions of the survey information to determine the statistical result, the statistical result including a prediction equation for the primary variable based on potential values of the secondary variables.

In addition, in one or more embodiments, generating the plain text description of the statistical result includes generating a plurality of plain text descriptions for the statistical result where the plurality of plain text descriptions include a plain text description describing a relationship between the first discrete portion of the survey information and each of the additional discrete portions of the survey information. In addition, in one or more embodiments, providing the presentation of the statistical result includes providing, within the presentation of the statistical result, the plurality of plain text descriptions for the statistical result in conjunction with a visualization of the prediction equation for the primary variable based on potential values of the secondary variables.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 13 illustrates a block diagram of exemplary computing device 1300 that may be configured to perform one or more of the processes described above. One will appreciate that one or more computing devices such as the computing device 1300 may implement the server device 102 and/or other devices described above in connection with FIG. 1. As shown by FIG. 13, the computing device 1300 can comprise a processor 1302, a memory 1304, a storage device 1306, an I/O interface 1308, and a communication interface 1310, which may be communicatively coupled by way of a communication infrastructure 1312. While an exemplary computing device 1300 is shown in FIG. 13, the components illustrated in FIG. 13 are not intended to be limiting. Additional or alternative components may be used in other embodiments. Furthermore, in certain embodiments, the computing device 1300 can include fewer components than those shown in FIG. 13. Components of the computing device 1300 shown in FIG. 13 will now be described in additional detail.

In one or more embodiments, the processor 1302 includes hardware for executing instructions, such as those making up a computer program. As an example and not by way of limitation, to execute instructions, the processor 1302 may retrieve (or fetch) the instructions from an internal register, an internal cache, the memory 1304, or the storage device 1306 and decode and execute them. In one or more embodiments, the processor 1302 may include one or more internal caches for data, instructions, or addresses. As an example and not by way of limitation, the processor 1302 may include one or more instruction caches, one or more data caches, and one or more translation lookaside buffers (TLBs). Instructions in the instruction caches may be copies of instructions in the memory 1304 or the storage 1306.

The memory 1304 may be used for storing data, metadata, and programs for execution by the processor(s). The memory 1304 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1304 may be internal or distributed memory.

The storage device 1306 includes storage for storing data or instructions. As an example and not by way of limitation, storage device 1306 can comprise a non-transitory storage medium described above. The storage device 1306 may include a hard disk drive (HDD), a floppy disk drive, flash memory, an optical disc, a magneto-optical disc, magnetic tape, or a Universal Serial Bus (USB) drive or a combination of two or more of these. The storage device 1306 may include removable or non-removable (or fixed) media, where appropriate. The storage device 1306 may be internal or external to the computing device 1300. In one or more embodiments, the storage device 1306 is non-volatile, solid-state memory. In other embodiments, the storage device 1306 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 1308 allows a user to provide input to, receive output from, and otherwise transfer data to and receive data from computing device 1300. The I/O interface 1308 may include a mouse, a keypad or a keyboard, a touch screen, a camera, an optical scanner, network interface, modem, other known I/O devices or a combination of such I/O interfaces. The I/O interface 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1308 is configured to provide graphical data to a display for presentation to a user. The graphical data may be representative of one or more graphical user interfaces and/or any other graphical content as may serve a particular implementation.

The communication interface 1310 can include hardware, software, or both. In any event, the communication interface 1310 can provide one or more interfaces for communication (such as, for example, packet-based communication) between the computing device 1300 and one or more other computing devices or networks. As an example and not by way of limitation, the communication interface 1310 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 1310 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 1310 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 1310 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 1312 may include hardware, software, or both that couples components of the computing device 1300 to each other. As an example and not by way of limitation, the communication infrastructure 1312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 14 illustrates an example network environment 1400 of a survey analysis environment 100. Network environment 1400 includes a client device 1406, and a server device 1402 connected to each other by a network 1404. Although FIG. 14 illustrates a particular arrangement of client system 1406, server device 1402, and network 1404, this disclosure contemplates any suitable arrangement of client device 1406, server device 1402, and network 1404. As an example and not by way of limitation, two or more of client device 1406, and server device 1402 may be connected to each other directly, bypassing network 1404. As another example, two or more of client device 1406 and server device 1402 may be physically or logically co-located with each other in whole, or in part. Moreover, although FIG. 14 illustrates a particular number of client devices 1406, survey devices 1402, and networks 1404, this disclosure contemplates any suitable number of client devices 1406, survey devices 1402, and networks 1404. As an example and not by way of limitation, network environment 1400 may include multiple client devices 1406, survey devices 1402, and networks 1404.

This disclosure contemplates any suitable network 1404. As an example and not by way of limitation, one or more portions of network 1404 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 1404 may include one or more networks 1404.

Links may connect client device 1406, and server device 1402 to communication network 1404 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1400. One or more first links may differ in one or more respects from one or more second links.

In particular embodiments, client device 1406 may be an electronic device including hardware, software, or embedded logic components or a combination of two or more such components and capable of carrying out the appropriate functionalities implemented or supported by client device 1406. As an example and not by way of limitation, a client device 1406 may include any of the computing devices discussed above in relation to FIG. 8. A client device 1406 may enable a network user at client device 1406 to access network 1404. A client device 1406 may enable its user to communicate with other users at other client systems 1406.

In particular embodiments, client device 1406 may include a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at client device 1406 may enter a Uniform Resource Locator (URL) or other address directing the web browser to a particular server (such as server, or a server associated with a third-party system), and the web browser may generate a Hyper Text Transfer Protocol (HTTP) request and communicate the HTTP request to server. The server may accept the HTTP request and communicate to client device 1406 one or more Hyper Text Markup Language (HTML) files responsive to the HTTP request. Client device 1406 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, server device 1402 may include a variety of servers, sub-systems, programs, modules, logs, and data stores. In particular embodiments, server device 1402 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Server device 1402 may also include suitable components such as network interfaces, security mechanisms, load balancers, failover servers, management-and-network-operations consoles, other suitable components, or any suitable combination thereof.

In particular embodiments, server device 1402 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method comprising:
providing, to a plurality of respondent client devices, an electronic survey comprising electronic survey questions;
receiving, from the plurality of respondent client devices, survey information comprising responses to the survey questions and information associated with users of the plurality of respondent client devices;
preparing the survey information for analysis based on identifying a statistical test from a plurality of statistical tests;
performing, by at least one processor, the identified statistical test on the prepared survey information to determine a statistical result; and
providing, to an administrator client device, a presentation of the statistical result within a virtual workspace.

2. The method of claim 1, wherein preparing the survey information for analysis comprises organizing the received survey information into a plurality of discrete portions corresponding to respective electronic survey questions.

3. The method of claim 2, wherein preparing the survey information for analysis further comprises identifying a data-type for each of the plurality of discrete portions.

4. The method of claim 3, wherein identifying the data-type comprises designating a discrete portion as a corresponding data-type based on a received user input.

5. The method of claim 3, wherein preparing the survey information for analysis further comprises modifying one or more datapoints of the plurality of discrete portions based on the identified data-type.

6. The method of claim 2, further comprising:
receiving a selection of a discrete portion from the plurality of discrete portions of the survey information; and
wherein identifying the statistical test from the plurality of statistical tests comprises determining a statistical test to perform on the selected discrete portion of the survey information based on an identified data-type of the selected discrete portion of the survey information.

7. The method of claim 1, further comprising:
generating a plain text description of the statistical result; and
wherein the presentation of the statistical result comprises the plain text description of the statistical result and a visualization of the statistical result.

8. The method of claim 7, wherein generating the plain text description comprises:
identifying a plain text template associated with the identified statistical test, the plain text template comprising a plurality of text fields;
populating the plurality of text fields with terms from a plurality of possible terms for each of the plurality of text fields based on the determined statistical result.

9. The method of claim 8, wherein the terms comprise descriptive terms of the determined statistical result.

10. The method of claim 1, further comprising identifying a type of visualization based on the identified statistical test, wherein identifying the type of visualization is further based on the determined statistical result.

11. A method comprising:
providing, to a plurality of respondent client devices, an electronic survey comprising electronic survey questions;
receiving, from the plurality of respondent client devices, survey information comprising responses to the survey questions and information associated with users of the plurality of respondent devices;
preparing the survey information for analysis based on identifying a plurality of statistical tests to perform on a plurality of discrete portions of the survey information;
performing, by the at least one processor, the identified plurality of statistical tests on one or more discrete portions of the survey information to determine one or more statistical results; and
providing, to an administrator client device, a presentation of the one or more statistical results within a virtual workspace.

12. The method of claim 11, further comprising receiving a user selection of two or more of the plurality of discrete portions of the survey information.

13. The method of claim 12, wherein receiving the user selection of the two or more of the plurality of discrete portions of the survey information comprises:
receiving a user selection of a primary variable associated with a first discrete portion of the plurality of discrete portions of the survey information; and
receiving a user selection of a plurality of secondary variables associated with a plurality of additional discrete portions of the plurality of discrete portions of the survey information.

14. The method of claim 13, wherein performing the plurality of statistical tests on the plurality of discrete portions of the survey information comprises performing one or more statistical tests to determine a relationship between the first discrete portion of the survey information and each of the plurality of additional discrete portions of the survey information.

15. The method of claim 13, wherein performing the statistical tests comprises performing a different combination of one or more statistical tests to determine a relationship between the first discrete portion of the survey information and each of the plurality of additional discrete portions of the survey information based on data-types of the first discrete portion of survey information and each of the plurality of additional discrete portions of the survey information.

16. The method of claim 13, wherein:
performing the plurality of statistical tests comprises determining a correlation strength between the first discrete portion of the survey information and each of the plurality of additional discrete portions of the survey information; and
providing the presentation of the one or more statistical results comprises ordering the one or more statistical results within the virtual workspace based on the determined correlation strength between the first discrete portion of the survey information and each of the plurality of additional discrete portions of the survey information.

17. The method of claim 16, wherein providing the presentation of the one or more statistical results further comprises:
identifying groupings of the one or more statistical results based on the identified plurality of statistical tests; and
ordering the one or more statistical results within the virtual workspace further comprises ordering the one or more statistical results within the virtual workspace based on the determined correlation strength within each of the identified groupings.

18. A system comprising:
at least one processor;
a non-transitory computer readable storage medium storing instructions thereon that, when executed by the at least one processor, cause the system to:
provide, to a plurality of respondent client devices, an electronic survey comprising electronic survey questions;
receive, from the plurality of respondent client devices, survey information comprising responses to the survey questions and information associated with users of the plurality of respondent client devices;
prepare the survey information for analysis based on identifying a statistical test from a plurality of statistical tests;
perform the identified statistical test on the prepared survey information to determine a statistical result; and
provide, to an administrator client device, a presentation of the statistical result within a virtual workspace.

19. The system of claim 18, wherein the non-transitory computer readable storage medium further comprises instructions that, when executed by the at least one processor, cause the system to:
receive a user selection of a primary variable associated with a first discrete portion of the survey information;
receive a user selection of a plurality of secondary variables associated with a plurality of additional discrete portions of the survey information; and
wherein performing the identified statistical test comprises performing a regression test on the first discrete portion and the plurality of additional discrete portions of the survey information to determine the statistical result, the statistical result comprising a prediction equation for the primary variable based on potential values of the secondary variables.

20. The system of claim 19, further comprising:
generating a plurality of plain text descriptions for the statistical result, the plurality of plain text descriptions comprising a plain text description describing a relationship between the first discrete portion of the survey information and each of the additional discrete portions of the survey information; and
wherein providing the presentation of the statistical result comprising providing the plurality of plain text descriptions for the statistical result.
